(19) United States
(12) Patent Application Publication
(10) Pub. No.: US 2009/0303413 A1
(43) Pub. Date: Dec. 10, 2009

(54) OPTICAL SHEET PACKAGED BODY, OPTICAL SHEET UNIT, LIGHTING DEVICE, AND DISPLAY UNIT

(75) Inventors: Eiji Ohta, Miyagi (JP); Toru Abiko, Miyagi (JP); Yasuyuki Kudo, Miyagi (JP); Hirokazu Odagiri, Miyagi (JP); Satoshi Sato, Miyagi (JP); Andrew Chakchung Yu, Miyagi (JP); Hiroshi Hayashi, Miyagi (JP); Yoshiyuki Maekawa, Hokkaido (JP); Masayasu Kakinuma, Miyagi (JP); Taro Omura, Miyagi (JP); Taku Ishimori, Miyagi (JP); Shigehiro Yamakita, Miyagi (JP); Yoshihiro Fujimaki, Miyagi (JP); Mitsunari Hoshi, Miyagi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/296,847

(22) PCT Filed: Feb. 13, 2008
(86) PCT No.: PCT/JP2008/052308

§ 371 Date: Oct. 10, 2008

(30) Foreign Application Priority Data
Feb. 13, 2007 (JP) 2007-032768
Jun. 28, 2007 (JP) 2007-171042

(51) Int. Cl. G02F 1/13357; F21V 15/00; F21V 11/00; F21V 21/00

(52) U.S. Cl. 349/62; 362/362; 362/257; 362/249.01

(57) ABSTRACT

An optical sheet packaged body in which a wrinkle is not generated is provided. The optical sheet packaged body includes a laminated body in which a plurality of optical sheets such as a light source image segmentation sheet, a diffusion plate, a diffusion sheet, and a luminance enhancement film are layered, and a flexible film that wraps around the laminated body and has one or a plurality of openings to expose at least part of an outer edge of the diffusion plate. An exposed portion exposed from at least one of the openings of the diffusion plate is provided with a shape (supported portion) for positioning to a chassis (bottom chassis and middle chassis) supporting the optical sheet packaged body.

### BACKGROUND

In recent years, Cathode Ray Tubes (CRT) that were a mainstream of display units in the past have been replaced with liquid crystal display units, since the liquid crystal display units have advantages such as the low electrical power consumption and the space-saving feature, and the low cost and the like. There are several types of the liquid crystal display units when categorized by, for example, illumination methods in displaying images. As a representative example, a transmissive display unit that displays images by utilizing a surface emitting light source arranged behind a liquid crystal display panel is cited.

In such a transmissive display unit, it is especially important to increase the display luminance, uniform the display luminance in the display screen, and widen the view angle in order to increase the commercial value of the display unit. Thus, between the surface emitting light source and the liquid crystal display panel, for example, various optical sheets such as a light source image segmentation sheet, a diffusion plate, a diffusion sheet, a luminance enhancement film, and a polarization split sheet are arranged (see, Japanese Unexamined Patent Application Publication No. 2006-78737 and Japanese Unexamined Patent Application Publication No. 9-506985

In some cases, to reduce the thickness of the display unit, each optical sheet arranged between the surface emitting light source and the liquid crystal display panel is closely contacted with each other. However, the thermal expansion coefficient of each optical sheet is different from each other. Thus, when the surface emitting light source is turned on and heat is generated from the surface emitting light source, each optical sheet is heated by the heat from the surface emitting light source, and is thermally expanded at a stretch amount different from each other. In addition, when the surface emitting light source is turned off and the heat is not supplied from the surface emitting light source, each optical sheet is cooled and thermally shrunk at a shrinkage amount different from each other. As a result, in a thin optical sheet, a ring-like wrinkle is generated. In the case where the wrinkle is generated in the optical sheet as above, there is an issue that light contrasting is generated according to the wrinkle distribution in light passing through the optical sheet, and display luminance in the display screen becomes non-uniform.

Thus, in the past, in the case where the surface emitting light source is arranged so that the light emitting face of the surface emitting light source is arranged almost vertically in the display unit, a plurality of pins are provided in the upper part of a chassis surrounding the side faces of each optical sheet, a hole is provided in a position corresponding to these pins out of the upper end portion of each optical sheet, the pin of the chassis is hooked to the hole of each optical sheet, each optical sheet is hung by its own weight, and thereby a clearance is provided between each optical sheet.

However, in the case where each optical sheet is hooked with the use of the pin, when the size of each optical sheet is large, part of each optical sheet is contacted in some cases. As a result, in the optical sheets being contacted with each other, movement in the in-plane direction is limited by the pin of the chassis and the contact portion. Thus, in the case where stretch and shrinkage are repeated according to light-on and light-off of the surface emitting light source, a ring-like wrinkle may be generated.

Consequently, a method in which all optical sheets are wrapped collectively with a transparent flexible film and are integrated has been proposed. According to the method, contact to limit the movement in the in-plane direction of each optical sheet is not generated, and thus generation of a wrinkle is able to be prevented. Further, since each optical sheet is integrated, handling is easier than in a case of using single optical sheets, and dust is less likely to enter into between each optical sheet. Further, in general, a protective film is attached to each optical sheet in order to prevent damage during transport and the like, and thus the protective film needs to be peeled off each time when each optical sheet is incorporated into the chassis. However, in the case where each optical sheet is integrated, such a protective film is not necessary in the first place. Thus, in the case where the integrated body composed of each optical sheet (optical sheet packaged body) is incorporated into the chassis, it is not necessary to peel off the protective film. As a result, there is an environmental merit that discarding the protective film is eliminated.

As described above, the optical sheet packaged body has various advantages. However, in the case where the optical sheet packaged body is hooked with the use of a pin as before, the flexible film may be damaged due to vibration during transportation or the like. Therefore, it is conceivable that the optical sheet packaged body is fixed by being sandwiched between chassis from the lamination direction. In this case, the movement in the in-plane direction of each optical sheet in the optical sheet packaged body is limited, and thus there is a possibility of generating a ring-like wrinkle.

### SUMMARY

The present application relates to an optical sheet packaged body in which a support plate and a plurality of optical sheets are wrapped with a flexible film, an optical sheet unit including the same, a lighting device including the same, a display unit including the same, and a lighting device including an optical device packaged body in which one or two or more optical devices are wrapped with a packaging member.

It is an object of the present application to provide an optical sheet packaged body in which a wrinkle is not generated, an optical sheet unit including the same, a lighting device including the same, and a display unit including the same.

In an embodiment, an optical sheet packaged body includes a laminated body in which a rectangular support plate having a top face, a bottom face, and side faces and one or a plurality of optical sheets are layered, and a flexible film wrapping around the laminated body and having one or a plurality of openings to expose at least part of an outer edge of the support plate.

In an embodiment, in the optical sheet packaged body, the part of the outer edge of the support plate wrapped with the flexible film together with the one or the plurality of optical sheets is exposed from the one or the plurality of openings provided in the flexible film. Thereby, when the laminated body is positioned to a chassis, it is possible that only the support plate of the laminated body is supported by the chassis and the one or the plurality of optical sheets are supported by the flexible film.

In an embodiment, a first optical sheet unit includes the foregoing optical sheet packaged body and the chassis that supports the foregoing optical sheet packaged body. The foregoing chassis has a supporting portion that supports the foregoing optical sheet packaged body correspondingly to an exposed portion that is exposed from at least one of the openings of the support plate.

In an embodiment, in the first optical sheet unit, the supporting portion that supports the foregoing optical sheet packaged body is provided correspondingly to the exposed portion that is exposed from at least one of the openings of the support plate wrapped with the flexible film together with the one or the plurality of optical sheets. Thereby, it is possible that only the support plate of the laminated body is supported by the supporting portion of the chassis, and each optical sheet is supported by the flexible film.

In an embodiment, a second optical sheet unit includes an optical sheet packaged body and a chassis supporting the optical sheet packaged body. In this case, the optical sheet packaged body has a laminated body in which a rectangular support plate having a top face, a bottom face, and side faces and one or a plurality of optical sheets are layered, and a flexible film wrapping around the laminated body. Further, the chassis has a supporting portion that sandwiches the flexible film from a lamination direction of the laminated body and has surface characteristics to easily slide in a direction in which the film is orthogonal to the lamination direction of the laminated body in a portion contacted with the flexible film.

In an embodiment, in the second optical sheet unit, the chassis is provided with the supporting portion that sandwiches the flexible film from the lamination direction of the laminated body and has the surface characteristics to easily slide in the direction in which the film is orthogonal to the lamination direction of the laminated body in the portion contacted with the flexible film. Thereby, the support plate and the one or the plurality of optical sheets in the laminated body is able to be individually stretched and shrunk in the lamination in-plane direction.

In an embodiment, a lighting device includes an optical sheet packaged body, a light source emitting light toward the optical sheet packaged body, and a chassis supporting the light source and the optical sheet packaged body. In this case, the optical sheet packaged body includes a laminated body in which a rectangular support plate having a top face, a bottom face, and side faces and one or a plurality of optical sheets are layered, and a flexible film wrapping around the laminated body and having one or a plurality of openings to expose at least part of an outer edge of the support plate. The chassis has a supporting portion supporting the optical sheet packaged body correspondingly to an exposed portion that is exposed from at least one of the openings of the support plate.

In an embodiment, in the lighting device, the supporting portion supporting the optical sheet packaged body is provided correspondingly to the exposed portion that is exposed from at least of the openings out of the support plate wrapped with the flexible film together with the one or the plurality of optical sheets. Thereby, it is possible that only the support plate of the laminated body is supported by the supporting portion of the chassis and the one or the plurality of optical sheets are supported by the flexible film.

In an embodiment, a display unit includes a panel driven based on an image signal, a light source emitting light for illuminating the panel, an optical sheet packaged body provided between the panel and the light source, and a chassis that supports the panel, the light source, and the optical sheet packaged body. The optical sheet packaged body includes a laminated body in which a rectangular support plate having a top face, a bottom face, and side faces and one or a plurality of optical sheets are layered, and a flexible film wrapping around the laminated body and having one or a plurality of openings to expose at least part of an outer edge of the support plate. The chassis has a supporting portion supporting the optical sheet packaged body correspondingly to an exposed portion that is exposed from at least one of the openings of the support plate.

In an embodiment, in the display unit, the supporting portion that supports the optical sheet packaged body is provided correspondingly to the exposed portion that is exposed from at least one of the openings of the support plate wrapped with the flexible film together with the one or the plurality of optical sheets. Thereby, it is possible that only the support plate out of the laminated body is supported by the supporting portion of the chassis and the one or the plurality of optical sheets are supported by the flexible film.

In an embodiment, according to the optical sheet packaged body the part of the outer edge of the support plate wrapped with the flexible film together with the one or the plurality of optical sheets is exposed from the one or the plurality of openings provided in the flexible film. Thus, when the laminated body is positioned to the chassis, it is possible that only the support plate of the laminated body is supported by the chassis, and the one or the plurality of optical sheets are supported by the flexible film. Thereby, the support plate and the one or the plurality of optical sheets in the laminated body is able to be individually stretched and shrunk in the lamination in-plane direction, and thus there is no possibility of generating a wrinkle.

In an embodiment, according to the first optical sheet unit, the lighting device, and the display unit, the supporting portion supporting the optical sheet packaged body is provided correspondingly to the exposed portion that is exposed from at least one of the openings of the support plate wrapped with the flexible film together with the one or the plurality of optical sheets. Thus, it is possible that only the support plate of the laminated body is supported by the supporting portion of the chassis and the one or the plurality of optical sheets are supported by the flexible film. Thereby, the support plate and the one or the plurality of optical sheets in the laminated body is able to be individually stretched and shrunk in the lamination in-plane direction, and thus there is no possibility of generating a wrinkle.

In an embodiment, according to the second optical sheet unit, the chassis is provided with the supporting portion that sandwiches the flexible film from the lamination direction of the laminated body and has the surface characteristics to easily slide in the direction in which the film is orthogonal to the lamination direction of the laminated body in the portion contacted with the flexible film. Thus, the support plate and the one or the plurality of optical sheets in the laminated body is able to be individually stretched and shrunk in the lamination in-plane direction. As a result, there is no possibility of generating a wrinkle.

Additional features and advantages are described herein, and will be apparent from, the following Detailed Description and the figures.

### BRIEF DESCRIPTION OF THE FIGURES

FIG. 1 A plan view showing an example of a top face structure of an optical sheet packaged body according to a first embodiment.

FIG. 2 A cross sectional structure view taken along A-A of the optical sheet packaged body of FIG. 1.

FIG. 3 A perspective view showing an enlarged exposed portion of FIG. 2.

FIG. 4 A perspective view showing a modified example of the exposed portion of FIG. 3.

FIG. 5 A perspective view showing another modified example of the expose portion of FIG. 3.

FIG. 6 A perspective view showing still another modified example of the exposed portion of FIG. 3.

FIG. 7 A perspective view showing still another modified example of the exposed portion of FIG. 3.

FIG. 8 A perspective view showing still another modified example of the exposed portion of FIG. 3.

FIG. 9 A perspective view showing still another modified example of the exposed portion of FIG. 3.

FIG. 10 A perspective view showing still another modified example of the exposed portion of FIG. 3.

FIG. 11 A perspective view showing still another modified example of the exposed portion of FIG. 3.

FIG. 12 A perspective view showing still another modified example of the exposed portion of FIG. 3.

FIG. 13 A perspective view showing still another modified example of the exposed portion of FIG. 3.

FIG. 14 A perspective view showing still another modified example of the exposed portion of FIG. 3.

FIG. 15 A plan view showing a modified example of the optical sheet packaged body of FIG. 1.

FIG. 16 A plan view showing another modified example of the optical sheet packaged body of FIG. 1.

FIG. 17 A plan view showing still another modified example of the optical sheet packaged body of FIG. 1.

FIG. 18 A plan view showing still another modified example of the optical sheet packaged body of FIG. 1.

FIG. 19 A plan view showing still another modified example of the optical sheet packaged body of FIG. 1.

FIG. 20 A plan view showing still another modified example of the optical sheet packaged body of FIG. 1.

FIG. 21 A plan view showing still another modified example of the optical sheet packaged body of FIG. 1.

FIG. 22 A plan view showing an example of a top face structure of an optical sheet packaged body according to a second embodiment.

FIG. 23 A perspective view showing an enlarged exposed portion of FIG. 22.

FIG. 24 A perspective view showing a modified example of the exposed portion of FIG. 22.

FIG. 25 A perspective view showing another modified example of the exposed portion of FIG. 22.

FIG. 26 A perspective view showing still another modified example of the exposed portion of FIG. 22.

FIG. 271A perspective view showing still another modified example of the exposed portion of FIG. 22.

FIG. 28 A perspective view showing still another modified example of the exposed portion of FIG. 22.

FIG. 29 A perspective view showing still another modified example of the exposed portion of FIG. 22.

FIG. 30 A perspective view showing still another modified example of the exposed portion of FIG. 22.

FIG. 31 A perspective view showing still another modified example of the exposed portion of FIG. 22.

FIG. 32 A perspective view showing still another modified example of the exposed portion of FIG. 22.

FIG. 33 A perspective view showing still another modified example of the exposed portion of FIG. 22.

FIG. 34 A plan view showing a modified example of the optical sheet packaged body of FIG. 22.

FIG. 35 A plan view showing another modified example of the optical sheet packaged body of FIG. 22.

FIG. 36 A plan view showing still another modified example of the optical sheet packaged body of FIG. 22.

FIG. 37 A plan view showing still another modified example of the optical sheet packaged body of FIG. 22.

FIG. 38 A plan view showing still another modified example of the optical sheet packaged body of FIG. 22.

FIG. 39 A plan view showing an example of a top face structure of an optical sheet packaged body according to a third embodiment.

FIG. 40 A perspective view showing an enlarged exposed portion of FIG. 39.

FIG. 41 A perspective view showing a modified example of the exposed portion of FIG. 39.

FIG. 42 A perspective view showing another modified example of the exposed portion of FIG. 39.

FIG. 43 A perspective view showing still another modified example of the exposed portion of FIG. 39.

FIG. 44 A perspective view showing still another modified example of the exposed portion of FIG. 39.

FIG. 45 A perspective view showing still another modified example of the exposed portion of FIG. 39.

FIG. 46 A cross sectional configuration view of a display unit according to a fourth embodiment.

FIG. 47 A perspective view for explaining an example of a support state between an exposed portion and a supporting portion of FIG. 46.

FIG. 48 A perspective view for explaining another example of the support state between the exposed portion and the supporting portion of FIG. 46.

FIG. 49 A perspective view for explaining still another example of the support state between the exposed portion and the supporting portion of FIG. 46.

FIG. 50 A perspective view for explaining still another example of the support state between the exposed portion and the supporting portion of FIG. 46.

FIG. 51 A perspective view for explaining still another example of the support state between the exposed portion and the supporting portion of FIG. 46.

FIG. 52 A perspective view for explaining still another example of the support state between the exposed portion and the supporting portion of FIG. 46.

FIG. 53 A perspective view for explaining still another example of the support state between the exposed portion and the supporting portion of FIG. 46.

FIG. 54 A perspective view for explaining still another example of the support state between the exposed portion and the supporting portion of FIG. 46.

FIG. 55 A perspective view for explaining still another example of the support state between the exposed portion and the supporting portion of FIG. 46.

FIG. 56 A perspective view for explaining still another example of the support state between the exposed portion and the supporting portion of FIG. 46.

FIG. 57 A perspective view for explaining still another example of the support state between the exposed portion and the supporting portion of FIG. 46.

FIG. 58 A perspective view for explaining still another example of the support state between the exposed portion and the supporting portion of FIG. 46.

FIG. 59 A perspective view for explaining still another example of the support state between the exposed portion and the supporting portion of FIG. 46.

FIG. 60 Perspective views for explaining still another example of the support state between the exposed portion and the supporting portion of FIG. 46.

FIG. 61 Perspective views for explaining still another example of the support state between the exposed portion and the supporting portion of FIG. 46.

FIG. 62 Perspective views for explaining still another example of the support state between the exposed portion and the supporting portion of FIG. 46.

FIG. 63 A perspective view for explaining still another example of the support state between the exposed portion and the supporting portion of FIG. 46.

FIG. 64 A perspective view for explaining still another example of the support state between the exposed portion and the supporting portion of FIG. 46.

FIG. 65 A perspective view for explaining still another example of the support state between the exposed portion and the supporting portion of FIG. 46.

FIG. 66 A perspective view for explaining still another example of the support state between the exposed portion and the supporting portion of FIG. 46.

FIG. 67 A perspective view for explaining still another example of the support state between the exposed portion and the supporting portion of FIG. 46.

FIG. 68 A perspective view for explaining still another example of the support state between the exposed portion and the supporting portion of FIG. 46.

FIG. 69 A perspective view for explaining still another example of the support state between the exposed portion and the supporting portion of FIG. 46.

FIG. 70 A perspective view for explaining still another example of the support state between the exposed portion and the supporting portion of FIG. 46.

FIG. 71 A perspective view for explaining still another example of the support state between the exposed portion and the supporting portion of FIG. 46.

FIG. 72 A cross sectional configuration view of a display unit according to a fifth embodiment.

FIG. 73 A cross sectional configuration view for explaining an example of a method of inserting the optical sheet packaged body of FIG. 72 into a slot.

FIG. 74 A cross sectional configuration view for explaining another example of the method of inserting the optical sheet packaged body of FIG. 72.

FIG. 75 A cross sectional configuration view for explaining still another example of the method of inserting the optical sheet packaged body of FIG. 72 into a slot.

FIG. 76 A cross sectional configuration view for explaining still another example of the method of inserting the optical sheet packaged body of FIG. 72 into a slot.

FIG. 77 A cross sectional configuration view for explaining still another example of the method of inserting the optical sheet packaged body of FIG. 72 into a slot.

FIG. 78 A cross sectional configuration view for explaining still another example of the method of inserting the optical sheet packaged body of FIG. 72 into a slot.

FIG. 79 A cross sectional configuration view for explaining still another example of the method of inserting the optical sheet packaged body of FIG. 72 into a slot.

FIG. 80 A cross sectional configuration view for explaining still another example of the method of inserting the optical sheet packaged body of FIG. 72 into a slot.

FIG. 81 A cross sectional configuration view of a display unit according to a sixth embodiment.

FIG. 82 A top view for explaining an example of the optical sheet packaged body of FIG. 81.

FIG. 83 A cross sectional structure view of an optical sheet packaged body according to a seventh embodiment, a perspective view of a light source image segmentation sheet included therein, and a perspective view of a luminance enhancement film included therein.

FIG. 84 A cross sectional structure view of a modified example of the optical sheet packaged body of FIG. 83 and a perspective view of a light source image segmentation sheet included therein.

FIG. 85 A cross sectional structure view of another modified example of the optical sheet packaged body of FIG. 83 and a perspective view of two light source image segmentation sheets included therein.

FIG. 86 A cross sectional structure view of a modified example of the optical sheet packaged body of FIG. 85 and a perspective view of a light source image segmentation sheet included therein.

FIG. 87 A cross sectional structure view of another modified example of the optical sheet packaged body of FIG. 85, and a perspective view of a light source image segmentation sheet included therein.

FIG. 88 A cross sectional structure view of still another modified example of the optical sheet packaged body of FIG. 83 and a perspective view of a light source image segmentation sheet included therein.

FIG. 89 A cross sectional structure view of still another modified example of the optical sheet packaged body of FIG. 83 and a perspective view of a light source image segmentation sheet included therein.

FIG. 90 A cross sectional structure view of a modified example of the optical sheet packaged body of FIG. 89 and a perspective view of a light source image segmentation sheet included therein.

FIG. 91 A cross sectional structure view of still another modified example of the optical sheet packaged body of FIG. 83 and a perspective view of a light source image segmentation sheet included therein.

FIG. 92 A cross sectional structure view of a modified example of the optical sheet packaged body of FIG. 91 and a perspective view of a light source image segmentation sheet included therein.

FIG. 93 A cross sectional structure view of an optical sheet packaged body according to an eighth embodiment and a perspective view of a light source image segmentation sheet included therein.

FIG. 94 A cross sectional structure view of a modified example of the optical sheet packaged body of FIG. 93 and a perspective view of a light source image segmentation portion and a light source image segmentation sheet included therein.

FIG. 95 A cross sectional structure view of a modified example of the optical sheet packaged body of FIG. 94 and a perspective view of a light source image segmentation portion and a light source image segmentation sheet included therein.

FIG. 96 A cross sectional structure view of another modified example of the optical sheet packaged body of FIG. 93 and a perspective view of a light source image segmentation portion and a light source image segmentation sheet included therein.

FIG. 97 A cross sectional structure view of still another modified example of the optical sheet packaged body of FIG. 93 and a perspective view of a light source image segmentation portion and a light source image segmentation sheet included therein.

FIG. 98 A cross sectional structure view of still another modified example of the optical sheet packaged body of FIG. 93 and a perspective view of a light source image segmentation portion and a light source image segmentation sheet included therein.

FIG. 99 A cross sectional configuration view of a display unit according to a ninth embodiment and perspective views of a light source image segmentation sheet, a luminance enhancement film, and a light source included therein.

FIG. 100 A cross sectional configuration view of a modified example of the display unit of FIG. 99 and perspective views of a light source image segmentation portion and a light source included therein.

FIG. 101 A cross sectional configuration view of a display unit according to a tenth embodiment and perspective views of two sheets of light source image segmentation sheet and a light source included therein.

FIG. 102 A cross sectional configuration view of a modified example of the display unit of FIG. 101 and perspective views of a light source image segmentation sheet and a light source included therein.

FIG. 103 A cross sectional configuration view of another modified example of the display unit of FIG. 101 and perspective views of a light source image segmentation portion, a light source image segmentation sheet, and a light source included therein.

FIG. 104 A cross sectional configuration view of still another modified example of the display unit of FIG. 101 and perspective views of a light source image segmentation portion, a light source image segmentation sheet, and a light source included therein.

FIG. 105 A cross sectional configuration view of a display unit according to an eleventh embodiment and perspective views of two sheets of light source image segmentation sheet and a light source included therein.

FIG. 106 A cross sectional configuration view of a modified example of the display unit of FIG. 105 and perspective views of a light source image segmentation sheet and a light source included therein.

FIG. 107 A cross sectional configuration view of another modified example of the display unit of FIG. 105 and perspective views of a light source image segmentation portion, a light source image segmentation sheet, and a light source included therein.

FIG. 108 A cross sectional configuration view of still another modified example of the display unit of FIG. 105 and perspective views of a light source image segmentation portion and a light source included therein.

FIG. 109 A cross sectional configuration view of another modified example of the display unit of FIG. 99.

FIG. 110 A cross sectional configuration view of a modified example of the display unit of FIG. 100.

FIG. 111 A schematic diagram for explaining a relation between a ridge of the light source image segmentation sheet of FIG. 89 and arrangement of point light sources.

FIG. 112 A characteristics diagram of the optical characteristics of the light source image segmentation sheet of FIG. 89 obtained by simulation.

FIG. 113 A conceptual diagram for explaining another example of an operation of the light source image segmentation sheet of FIG. 89.

FIG. 114 A conceptual diagram for explaining still another example of an operation of the light source image segmentation sheet of FIG. 89.

FIG. 115 A schematic diagram for explaining a relation between a ridge of the light source image segmentation sheet of FIG. 91 and arrangement of point light sources.

FIG. 116 A characteristics diagram of the optical characteristics of the light source image segmentation sheet of FIG. 91 obtained by simulation.

FIG. 117 A conceptual diagram for explaining another example of an operation of the light source image segmentation sheet of FIG. 91.

FIG. 118 A conceptual diagram for explaining still another example of an operation of the light source image segmentation sheet of FIG. 91.

### DETAILED DESCRIPTION

A description will be hereinafter given in detail of embodiments with reference to the drawings.

### First Embodiment

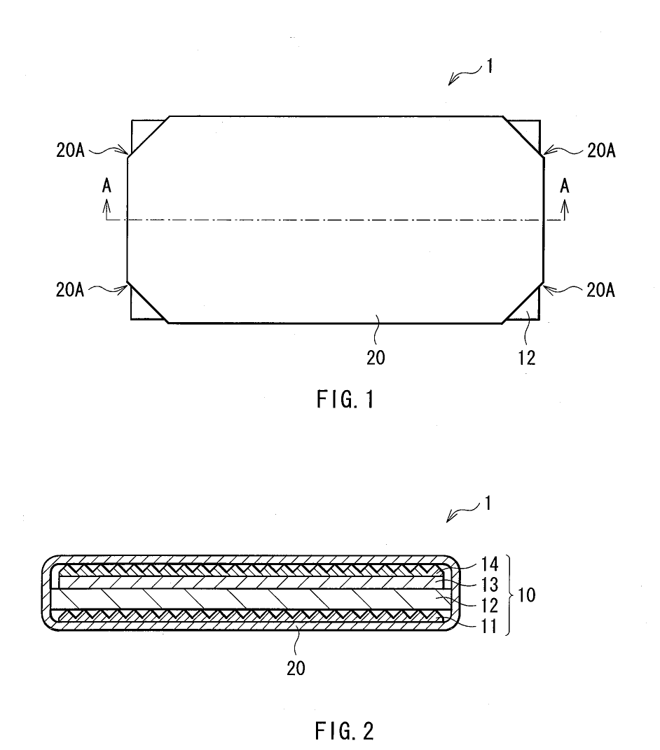

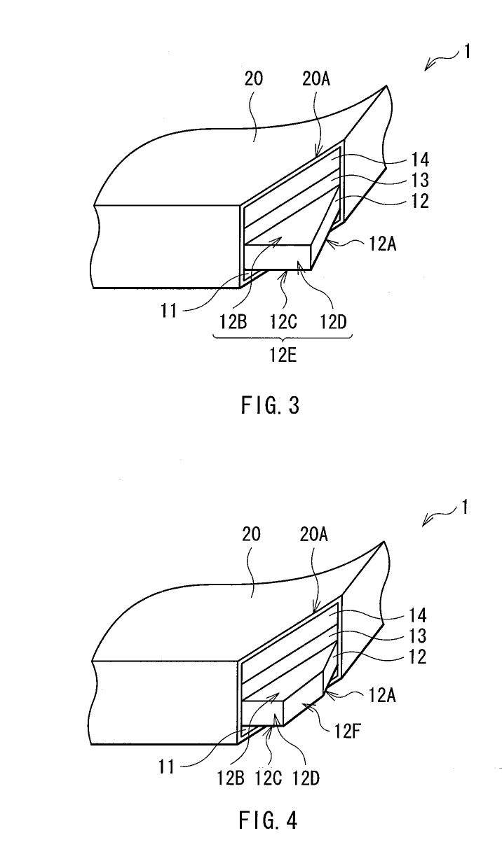

FIG. 1 shows an example of a top face structure of an optical sheet packaged body 1 according to a first embodiment. The optical sheet packaged body 1 is arranged, for example, between a liquid crystal display panel and a light source, and is suitably used to improve the optical characteristics of the light source. FIG. 2 shows a cross sectional structure taken along A-A of the optical sheet packaged body 1 of FIG. 1. FIG. 3 shows an enlarged end portion of the optical sheet packaged body 1 of FIG. 1.

The optical sheet packaged body 1 includes a laminated body 10 and a flexible film 20 as shown in FIG. 2.

The laminated body 10 is formed, for example, by layering a light source image segmentation sheet 11, a diffusion plate 12, a diffusion sheet 13, and a luminance enhancement film 14 in this order.

The light source image segmentation sheet 11 is a thin optical sheet in which a plurality of columnar prisms 11 A (linear convex portions) extending along a plane parallel to the bottom face on the top face thereof are arranged in line sequentially. In the case where a plurality of linear light sources are arranged in parallel directly under the laminated body 10, each prism 11A is preferably arranged in parallel so that the extending direction of each prism 11A is in parallel with the extending direction of the linear light sources (for example, horizontal direction). However, each prism 11A may be arranged to cross the extending direction of each linear light source within an allowable range based on optical characteristics.

Thereby, while the light source image segmentation sheet 11 refracts and transmits light entering the bottom face or the top face of each prism 11 A at an angle under the critical angle among light emitted from, for example, one linear light source, the light source image segmentation sheet 11 totally reflects light entering at an angle of the critical angle or more. Thus, the light source image segmentation sheet 11 has a function to segment a light source image created by the one linear light source into a plurality of light source images according to the number of faces composing the top face of each prism 11 A (strictly speaking, the number of faces classified for every inclined angle). In addition, in the case where the surface of each prism 11A has a curved face, the light source image segmentation sheet 11 has a function to segment the light source image created by the one light source into infinite of light source images. That is, the light source image segmentation sheet 11 segments the light source image created by one linear light source into the plurality of light source images so that a distance between each light source image formed by each light source image after segmentation is narrower than a distance between the linear light sources. Thus, the difference between the luminance level (maximum value) of the light source image after segmentation and the luminance level (minimum value) between each light source image after segmentation is able to be smaller than the difference between the luminance level (maximum value) of the light source image before segmentation and the luminance level (minimum value) between each light source image before segmentation, and thereby non-uniformity of the lighting luminance is able to be reduced. Accordingly, the light source image segmentation sheet 11 may be regarded as a kind of diffusion sheet as well.

In addition, the light source image represents a light beam showing the luminance peak in a light luminance distribution. The distance between light source images means a distance in the in-plane direction between adjacent peaks (tops) in the luminance distribution.

The light source image segmentation sheet 11 may be integrally formed by using a resin material having translucency such as a thermoplastic resin, or may be formed by transcribing an energy ray (for example, ultraviolet ray) cured resin on a transmissive base material such as PET (polyethylene terephthalate).

In this case, as the thermoplastic resin, considering the function to control the light emitting direction, a thermoplastic resin having a refractive index of 1.4 or more is preferably used. As such a resin, for example, an acrylic resin such as a polycarbonate resin and PMMA (polymethyl methacrylate resin), a polyester resin such as polyethylene terephthalate, a noncrystalline copolymer polyester resin such as MS (copolymer of methylmethacrylate and styrene), a polystyrene resin, a polyvinyl chloride resin and the like are cited.

The diffusion plate 12 is a thick and high rigid optical sheet having a light diffusion layer formed by, for example, dispersing a light diffusion material (filler) in a relatively thick plate-like transparent resin (rectangular transparent resin having a top face 12B, a bottom face 12C, and side faces 12D (refer to FIG. 3)). As will be described later, part of the diffusion sheet 12 is exposed from an opening 20A of the flexible film 20. The exposed portion is provided with, as will be described later, a shape for positioning to a chassis that supports the optical sheet packaged body 1.

In this case, as the plate-like transparent resin, for example, a light transmissive thermoplastic resin such as PET, acryl, and polycarbonate is used. The light diffusion layer included in the foregoing diffusion plate 12 is, for example, from 0.5 mm to 4 mm thick. Further, the light diffusion material is composed of a particle having an average particle diameter of, for example, from 0.5 μm to 10 μm, and is dispersed in the transparent resin in the range from 0.1 parts by weight to 10 parts by weight to the weight of the foregoing entire light diffusion layer. Thereby, the diffusion plate 12 has a function to diffuse a light source image created by the light source image segmentation sheet 11.

If the light diffusion layer is thinner than 0.5 mm, the light diffusion characteristics are lost, and there is a possibility that the sheet rigidity is not able to be secured in supporting the diffusion plate 12 d by the chassis as will be described later. Meanwhile, if the light diffusion layer is thicker than 4 mm, when the diffusion plate 12 is heated by light from the light source, the heat is difficult to be dissipated, and thus the diffusion plate 12 may be bent. When the average particle diameter of the light diffusion material is in the range from 0.5 μm to 10 μm, and the light diffusion material is dispersed in the transparent resin in the range from 0.1 parts by weight to 10 parts by weight to the weight of the entire light diffusion layer, effects as the light diffusion material are effectively exerted, and luminance non-uniformity is able to be effectively eliminated by being used in combination with the light source image segmentation sheet 11.

The diffusion sheet 13 is, for example, a thin optical sheet formed by coating a relatively thin film transparent resin with a transparent resin containing a light diffusion material.

In this case, as the film transparent resin, for example, a light transmissive thermoplastic resin such as PET, acryl, and polycarbonate is used as in the foregoing diffusion plate 12. The light diffusion layer included in the foregoing diffusion plate has a structure similar to that of the foregoing diffusion plate 12. Thereby, the diffusion sheet 13 has a function to diffuse a light source image created by the light source image segmentation sheet 11.

The luminance enhancement film 14 is a thin optical sheet in which a plurality of columnar prisms 14A (linear convex portions) extending along a plane parallel to the bottom face on the top face thereof are arranged in line sequentially. In the case where a plurality of linear light sources are arranged in parallel directly under the laminated body 10, each prism 14A is preferably arranged in parallel so that the extending direction of each prism 14A is in parallel with the extending direction of the linear light sources (for example, horizontal direction). However, each prism 14A may be arranged to cross the extending direction of each linear light source within an allowable range based on optical characteristics.

Thereby, the luminance enhancement film 14 refracts and transmits a component in the arrangement direction of each prism 14A among light entering from the bottom face side toward the normal line direction of the bottom face to improve the directivity.

The luminance enhancement film 14 is made of a resin material having translucency like the light source image segmentation sheet 11.

The flexible film 20 is, for example, composed of a single layer or a plurality of layers having transparency in a state of a film, a sheet, a plate, or a pouch.

The transmittance of the flexible film 20 is preferably from 5 to 95%. To provide damage-resistant characteristics, prevention of blur due to contact, or optical scattering characteristics, a surface shape may be given to the packaged body itself, or the flexible film 20 may be made of an inorganic particle such as TiO₂, Si₂, Al₂O₃, CaCO₃, and BaSO₄; polymethyl methacrylate; an organic particle such as polystyrene, vinyl chloride, a fluorine-based resin, polyester; and further a particle having a hole made of the foregoing material; or a material having a hole. Further, the flexible film 20 may be made of a mixture or a synthesis of two or more resins. Any material may be used as long as transparency, damage-resistant characteristics, contact prevention, and optical scattering characteristics are able to be provided.

Further, in the case where the flexible film 20 has anisotropy, the optical anisotropy is preferably small, more specifically, the retardation is preferably 50 nm or less. As the flexible film 20, a uniaxially-stretched sheet/film or biaxially-stretched sheet/film is preferably used. In the case where such a sheet or such a film is used, the flexible film 20 is able to be shrunk in the direction opposite to the stretch direction by applying heat. Thereby, the contact characteristics between the flexible film 20 and the optical device laminated body is able to be improved.

As the flexible film 20, for example, a polymer material having transparency is able to be used. As the polymer material, for example, a polyolefin-based resin such as polyethylene (PE), polypropylene (PP), and polybutylene (PB); a polyester-based resin such as polyethylene terephthalate (PET), polyethylene naphthalate (PEN), polybutylene terephthalate, and polybutylene naphthalate; a polycarbonate (PC)-based resin; a cycloolefin-based resin; a urethane-based resin; a urea-based resin; a vinyl chloride-based rosin; a natural rubber-based resin; an artistic rubber-based resin; a polymethyl methacrylate-based resin; a vinyl-based resin such as a polystyrene-based resin; a block copolymer of vinyl aromatic carbon hydride and conjugate diene and the like are able to be used. In particular, the block copolymer of vinyl aromatic carbon hydride and conjugate diene is preferable. Further, as the polymer material, any of a crystalline material and a noncrystalline material is able to be used. The flexible film 20 may be made of two or more of these materials, which may be used as a means for thermal adhesion or the like in joining for binding or the like. For example, it is possible that one layer is used as a base material, and an easy-adhesive layer in which a low-molecular component is increased is provided on the opposite face thereof. Otherwise, it is possible that a low-molecular component of a thermoplastic resin layer or a primer as an easy-adhesive layer is formed on one face of one base material by shaping, coating, laminating or the like.

As described above, the flexible film 20 preferably contains at least block copolymer of vinyl aromatic carbon hydride and conjugate diene. In addition, in the case where the flexible film 20 is composed of a plurality of layers, at least one of the plurality of layers contains at least the block copolymer of vinyl aromatic carbon hydride and conjugate diene.

As the vinyl aromatic carbon hydride in the block copolymer, for example, styrene, o-methylstyrene, p-methylstyrene, 2,4-dimethylstyrene, 2,5-dimethylstyrene, α-methylstyrene, vinylnaphthalene, vinylanthracene or the like is cited. In particular, styrene is generally cited.

As the conjugate diene in the block copolymer, 2,3-butadiene, 2-methyl-1,3-butadiene (isopropylene), 2,3-dimethyl-1,3-butadiene, 1,3 pentadiene or the like is cited. As a particularly general conjugate diene, 1,3 butadiene and isoprene are cited.

The weight ratio between the vinyl aromatic carbon hydride and the conjugate diene [(vinyl aromatic carbon hydride):(conjugate diene)] is preferably from 95:5 to 5:95, and more preferably from 90:10 to 60:40. If the weight ratio of the vinyl aromatic carbon hydride is under 5 wt %, the film rigidity is lowered. Meanwhile, if the weight ratio of the vinyl aromatic carbon hydride is over 95 wt %, the surface characteristics deteriorate.

The block ratio of the vinyl aromatic carbon hydride and the conjugate diene is preferably from 70 to 90%. If the block ratio is under 70 wt %, the film synthesis is lowered. Meanwhile, if the block ratio is over 90 wt %, the surface characteristics deteriorate and there is a possibility that the film is not able to be practically used. In addition, the block ratio of the vinyl aromatic carbon hydride is obtained by expression (W1/W0)×100 where the mass of a block polymerization chain of the vinyl aromatic carbon hydride in the copolymer is W1 and the total mass of the vinyl aromatic carbon hydride in the block copolymer is W0. W1 is obtained, for example, as follows. The block copolymer is ozone-decomposed, and the obtained vinyl aromatic carbon hydride polymer component is measured by gel permeation chromatograph. The molecular weight corresponding to the chromatogram is obtained from the calibration curve formed by using standard polystyrene and styrene oligomer. The results having a number average molecular weight of over 3000 is obtained by quantitative determination based on the peak area. As a detector, for example, an ultraviolet spectroscopic detector in which wavelength is set to 254 nm is able to be used.

A heat-shrinkable film used for a single layer or a plurality of layers of the flexible film 20 preferably further contains a vinyl aromatic carbon hydride polymer. This is because heat resistance, rigidity, and contact characteristics with the optical device is able to be improved depending on material characteristics of the optical device and a configuration of the lighting device. The vinyl aromatic carbon hydride polymer used in this embodiment is at least one polymer selected from (a) vinyl aromatic carbon hydride polymer, (b) copolymer of vinyl aromatic carbon hydride and (meta) acrylic acid, (c) copolymer of vinyl aromatic carbon hydride and (meta) acrylic ester, and (d) rubber-modified styrene-based polymer.

As (a) vinyl aromatic carbon hydride polymer, for example, a single polymer of the foregoing vinyl aromatic carbon hydride polymer or a copolymer of two or more thereof is used. As a particularly general example, polystyrene is cited.

(b) Copolymer of vinyl aromatic carbon hydride and (meta) acrylic acid is obtained by, for example, polymerizing the foregoing vinyl aromatic carbon hydride polymer and the (meta) acrylic acid. For polymerization, one or two or more respective monomers may be selectively used, respectively. As the (meta) acrylic acid, for example, acrylic acid, methacrylic acid and the like are cited.

(c) Copolymer of vinyl aromatic carbon hydride and (meta) acrylic ester is obtained by, for example, polymerizing the foregoing vinyl aromatic carbon hydride polymer and the (meta) acrylic ester. For polymerization, one or two or more respective monomers may be selectively used, respectively. As the (meta) acrylic ester, for example, methyl acrylate, ethyl acrylate, butyl acrylate, methyl methacrylate, ethyl methacrylate, butyl methacrylate and the like are cited.

The copolymer (b) or the copolymer (c) is obtained by polymerizing a monomer mixture in which a weight ratio between vinyl aromatic carbon hydride and (meta) acrylic acid or vinyl aromatic carbon hydride and (meta) acrylic ester is preferably 5:95 to 95:1 or more preferably 70:30 to 99:1.

(d) Rubber-modified styrene polymer is obtained by, for example, polymerizing a mixture of vinyl aromatic carbon hydride or a monomer capable of being polymerized therewith and various elastomers. As the vinyl aromatic carbon hydride polymer, the vinyl aromatic carbon hydride polymer described in the foregoing block copolymer is used. As the monomer capable of being polymerized therewith, (meta) acrylic acid, (meta) acrylic ester, acrylonitrile or the like is cited. As the elastomer, for example, butadiene rubber, styrene-butadiene rubber, chloroprene rubber or the like is used. An impact-resistant rubber-modified styrene resin (HIPS) is particularly preferable.

In the case where the block copolymer and the vinyl aromatic carbon hydride polymer are blended and used, the weight ratio between the block copolymer and the vinyl aromatic carbon hydride polymer is preferably 100:0 to 50:50. If the block copolymer is under 50 wt %, the heat shrinkability of the film is insufficient.

In the case where the flexible film 20 is composed of a plurality of layers (multilayer film), at least one layer contains the block copolymer or the block copolymer and the vinyl aromatic carbon hydride polymer as a component, but the other layers not containing the block copolymer or the block copolymer and the vinyl aromatic carbon hydride polymer as a component is not particularly limited as long as these other layers are a styrene-based polymer. As the styrene-based polymer, for example, the styrene-butadiene block copolymer described in the foregoing vinyl aromatic carbon hydride, the foregoing vinyl aromatic carbon hydride polymer, ABS resin, a styrene-acrylonitrile copolymer or the like is cited. The resin or the polymer may be used singly, or a plurality thereof may be used together. A preferable example is a styrene-butadiene block copolymer different from the styrene-butadiene block copolymer previously used in at least one layer containing the block copolymer as a component, or the foregoing vinyl aromatic carbon hydride polymer.

The flexible film 20 wraps around the laminated body 10. In the case where the light source is arranged directly under the laminated body 10, the flexible film 20 is formed at least in a region through which light from the light source passes. Further, the flexible film 20 may be joined to at least one of the light source image segmentation sheet 11, the diffusion plate 12, the diffusion sheet 13, and the luminance enhancement film 14.

Further, as shown in FIG. 1 and FIG. 3, the flexible film 20 has one or a plurality of openings 20A for letting at least part of the outer edge of the diffusion plate 12 expose. FIG. 1 and FIG. 3 show a case where the openings 20A are provided in corners of the diffusion plate 12 as an example. Hereinafter, in this embodiment, a description will be given of the flexible film 20 and the diffusion plate 12 under the condition that the opening 20A is provided at least in a corner of the diffusion plate 12.

As shown in FIG. 3, the top face 12B, the bottom face 12C, and the side face 12D of the diffusion plate 12 are respectively exposed partly from the opening 20A. A portion exposed from the opening 20A (exposed portion 12A) is in the shape of a three-dimensional figure in which adjacent faces out of the top face 12B, the bottom face 12C, and the side face 12D are orthogonal to each other.

In this case, part of the portion exposed from the opening 20A (exposed portion 12A) functions as a supported portion 12E for positioning to the chassis that supports the optical sheet packaged body 1. For example, the top face 12B and the bottom face 12C function as the supported portion 12E, or the side face 12D functions as the supported portion 12E according to the shape of the chassis.

In addition, the exposed portion 12A is not necessarily in the shape of a three dimensional figure as shown in FIG. 3. For example, as shown in FIG. 4, the exposed portion 12A may be in the shape of a three dimensional figure in which the end portion where adjacent faces out of the top face 12B, the bottom face 12C, and the side face 12D are orthogonal to each other is cut off flatly in a direction almost in parallel with the opposing direction of the top face 12B and the bottom face 12C. In this case, however, the side face having a planar shape at a given angle to the side face 12D that is formed by cutting off the end portion is caused to function as a supported portion 12F for positioning to the chassis that supports the optical sheet packaged body 1.

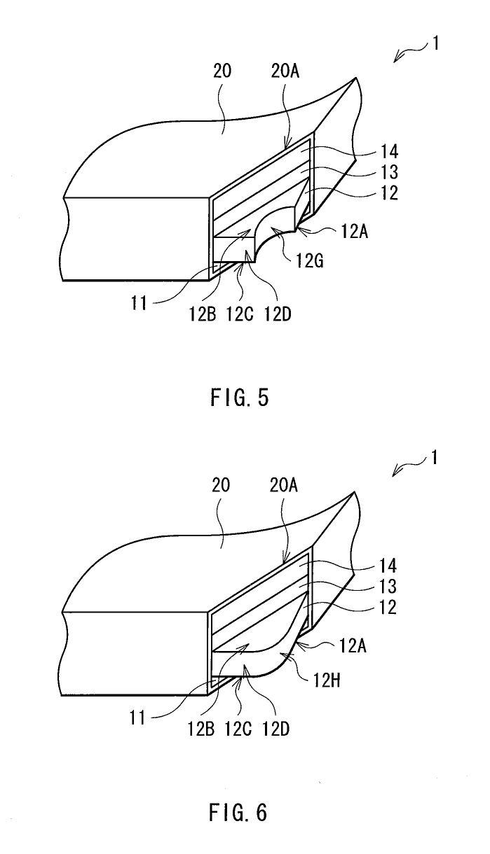

Further, for example, as shown in FIG. 5, the exposed portion 12A may be in the shape of a three dimensional figure in which the end portion where adjacent faces out of the top face 12B, the bottom face 12C, and the side face 12D are orthogonal to each other is cut off in a state of a concave face in a direction almost in parallel with the opposing direction of the top face 12B and the bottom face 12C. In this case, however, the side face having a concave curved shape that is formed by cutting off the end portion can be caused to function as a supported portion 12G for positioning to the chassis that supports the optical sheet packaged body 1.

Further, for example, as shown in FIG. 6, the exposed portion 12A may be in the shape of a three dimensional figure in which the end portion where adjacent faces out of the top face 12B, the bottom face 12C, and the side face 12D are orthogonal to each other is cut off in a state of a convex face in a direction almost in parallel with the opposing direction of the top face 12B and the bottom face 12C. In this case, however, the side face having a convex curved shape that is formed by cutting off the end portion is caused to function as a supported portion 12H for positioning to the chassis that supports the optical sheet packaged body 1.

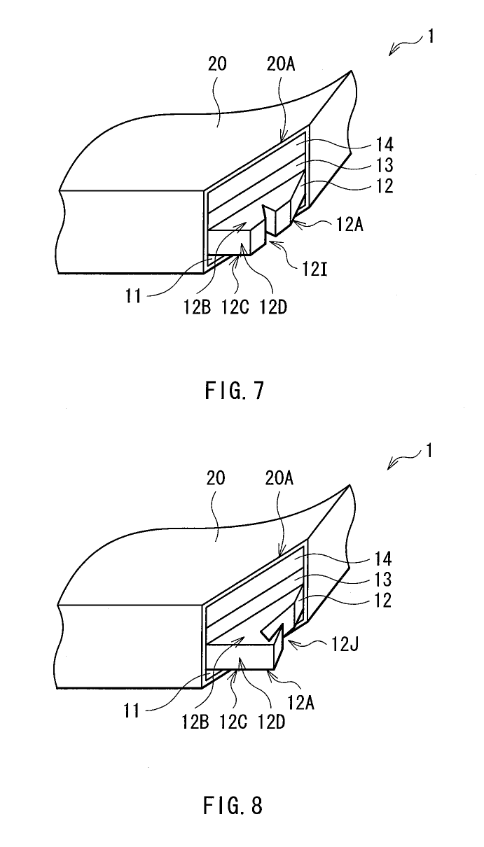

Further, for example, as shown in FIG. 7, the exposed portion 12A may be in the shape of a three dimensional figure in which the end portion where adjacent faces out of the top face 12B, the bottom face 12C, and the side face 12D are orthogonal to each other is cut off flatly in a direction almost in parallel with the opposing direction of the top face 12B and the bottom face 12C, and a notch extending in the direction almost in parallel with the opposing direction of the top face 12B and the bottom face 12C is provided in the side face having a planar shape at a given angle to the side face 12D that is formed by cutting off the end portion. In this case, however, the side face having a concave notch shape that is formed by cutting off the end portion and providing the notch is caused to function as a supported portion 121 for positioning to the chassis that supports the optical sheet packaged body 1.

Further, for example, as shown in FIG. 8, the exposed portion 12A may be in the shape of a three dimensional figure in which a notch extending in a direction almost in parallel with the opposing direction of the top face 12B and the bottom face 12C is provided in one side face 12D out of the end portion where adjacent faces out of the top face 12B, the bottom face 12C, and the side face 12D are orthogonal to each other. In this case, however, the side face having a concave notch shape that is formed by notching the end portion is caused to function as a supported portion 12J for positioning to the chassis that supports the optical sheet packaged body 1.

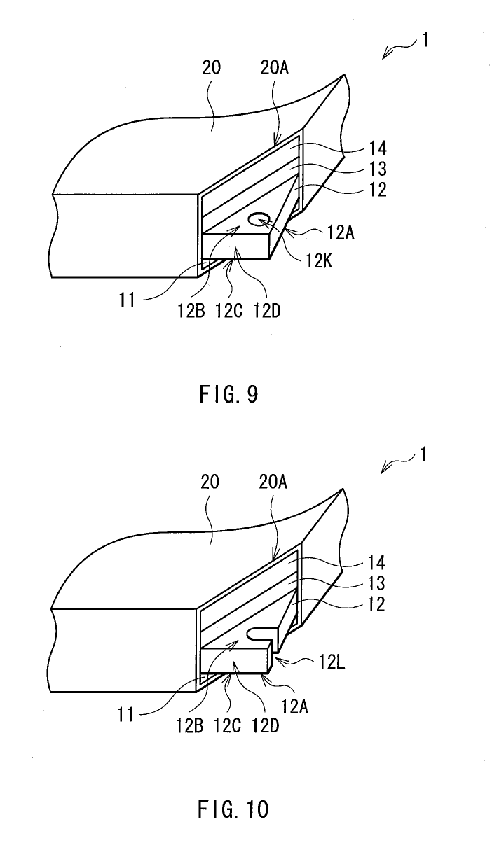

Further, for example, as shown in FIG. 9, the exposed portion 12A may be in the shape of a three dimensional figure in which a through-hole penetrating the top face 12B and the bottom face 12C is provided in the top face 12B and the bottom face 12C of the end portion where adjacent faces out of the top face 12B, the bottom face 12C, and the side face 12D are orthogonal to each other. In this case, however, the through-hole provided in the end portion is caused to function as a supported portion 12K for positioning to the chassis that supports the optical sheet packaged body 1. In addition, the cross-sectional shape of the through-hole is able to be in a state of a circle, an oval, a square, or a rectangle extending in one direction, a shape in which a corner of a rectangle extending in one direction is chamfered or the like.

Further, for example, as shown in FIG. 10, the exposed portion 12A may be in the shape of a three dimensional figure in which a cut groove extending in a direction almost in parallel with the opposing direction of the top face 12B and the bottom face 12C is provided in the side face 12D of the end portion where adjacent faces out of the top face 12B, the bottom face 12C, and the side face 12D are orthogonal to each other. In this case, however, the cut groove provided in the end portion is caused to function as a supported portion 12L for positioning to the chassis that supports the optical sheet packaged body 1.

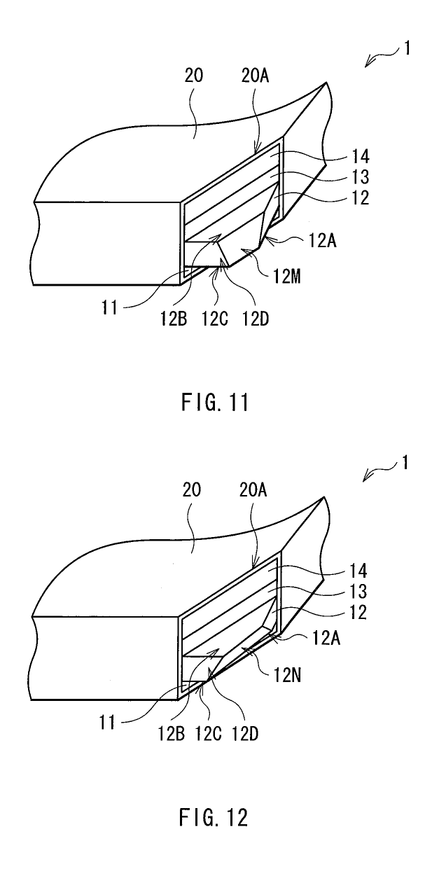

Further, for example, as shown in FIG. 11, the exposed portion 12A may be in the shape of a three dimensional figure in which the end portion where adjacent faces out of the top face 12B, the bottom face 12C, and the side face 12D are orthogonal to each other is cut off flatly in a direction that crosses the opposing direction of the top face 12B and the bottom face 12C and that is obliquely headed from the central portion of the diffusion plate 12 to the end portion thereof. In this case, however, the side face having a planar shape at a blunt angle to the top face 12B that is formed by cutting off the end portion and providing a notch is caused to function as a supported portion 12M for positioning to the chassis that supports the optical sheet packaged body 1.

Further, for example, as shown in FIG. 12, the exposed portion 12A may be in the shape of a three dimensional figure in which the end portion where adjacent faces out of the top face 12B, the bottom face 12C, and the side face 12D are orthogonal to each other is cut off flatly in a direction that crosses the opposing direction of the top face 12B and the bottom face 12C and that is obliquely headed from the end portion of the diffusion plate 12 to the central portion thereof. In this case, however, the side face having a planar shape at a blunt angle to the bottom face 12C that is formed by cutting off the end portion and providing a notch is caused to function as a supported portion 12N for positioning to the chassis that supports the optical sheet packaged body 1.

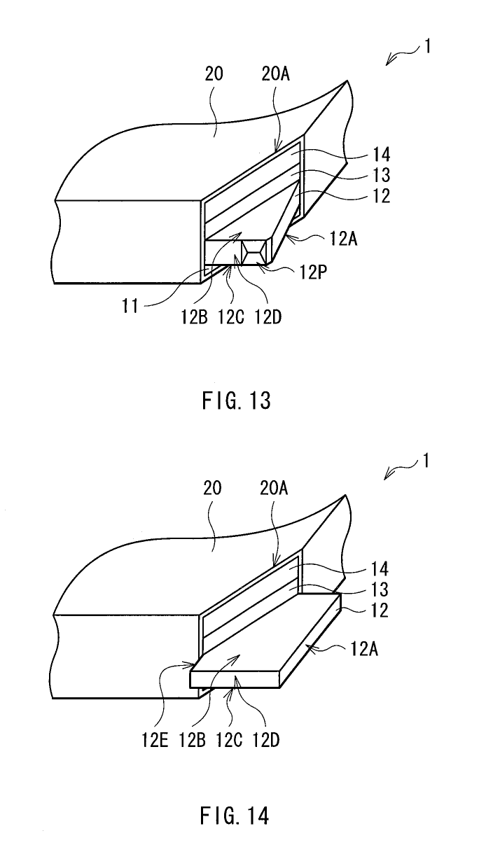

Further, for example, as shown in FIG. 13, the exposed portion 12A may be in the shape of a three dimensional figure in which a notch extending in a direction almost orthogonal to the opposing direction of the top face 12B and the bottom face 12C is provided in one side face 12D out of the end portion where adjacent faces out of the top face 12B, the bottom face 12C, and the side face 12D are orthogonal to each other. In this case, however, the notch provided in the end portion is caused to function as a supported portion 12P for positioning to the chassis that supports the optical sheet packaged body 1.

Further, for example, as shown in FIG. 14, the exposed portion 12A may be in the shape of a three dimensional figure in which the end portion where adjacent faces out of the top face 12B, the bottom face 12C, and the side face 12D are orthogonal to each other is projected outward more than the side face of the laminated body 10. In this case, however, the side face 12D adjacent to the flexible film 20 out of the side faces 12D of the end portion is caused to function as a supported portion 12E for positioning to the chassis that supports the optical sheet packaged body 1.

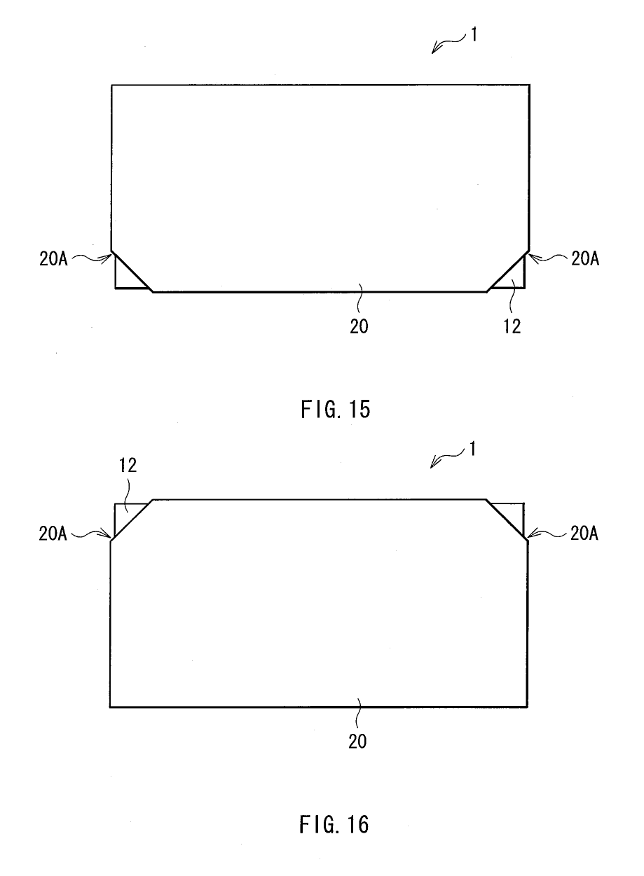

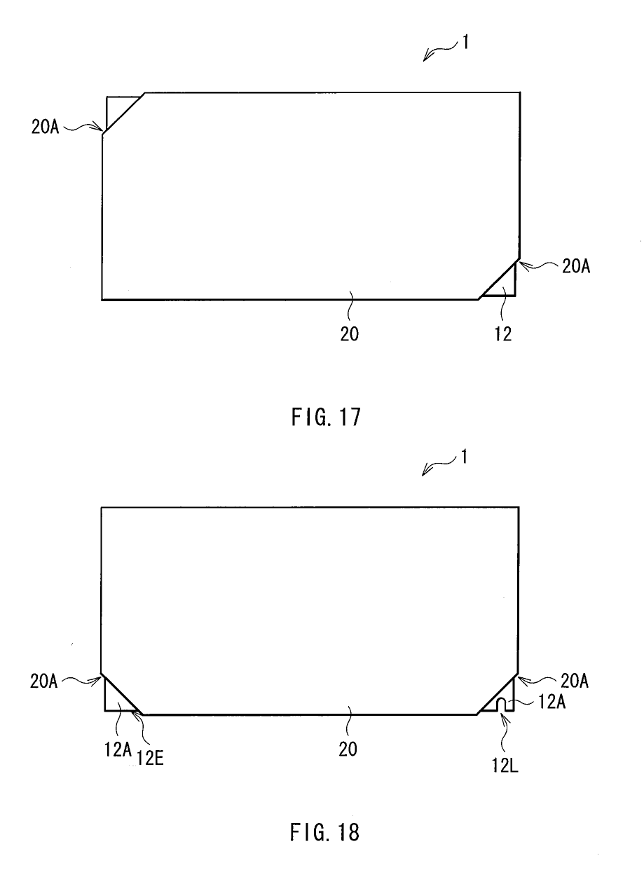

By the way, FIG. 1 shows a case that the openings 20A are provided in the four corners of the diffusion plate 12 as an example. However, the openings 20A are not necessarily provided in the four corners. For example, as shown in FIG. 15, the openings 20A may be provided only in the two corners on the lower side of the diffusion plate 12. On the contrary, for example, as shown in FIG. 16, the openings 20A may be provided only in the two corners on the upper side of the diffusion plate 12. Further, as shown in FIG. 17, the openings 20A may be provided only in the two corners diagonally opposite each other of the diffusion plate 12.

Further, it is not necessary that each exposed portion 12A of the diffusion plate 12 functions as a supported portion. It is enough that at least two of each exposed portion 12A of the diffusion plate 12 function as a supported portion, or one of each exposed portion 12A of the diffusion plate 12 has at least two supported portions in the exposed portion. That is, it is enough that each supported portion is structured so that in supporting the diffusion plate 12 by the chassis, movement in one in-plane direction of the diffusion plate 12 (for example, long side direction) is suppressed by one supported portion, and movement in a direction crossing the one in-plane direction of the diffusion plate 12 (for example, short side direction) is suppressed by two supported portions (the foregoing supported portion may be included).

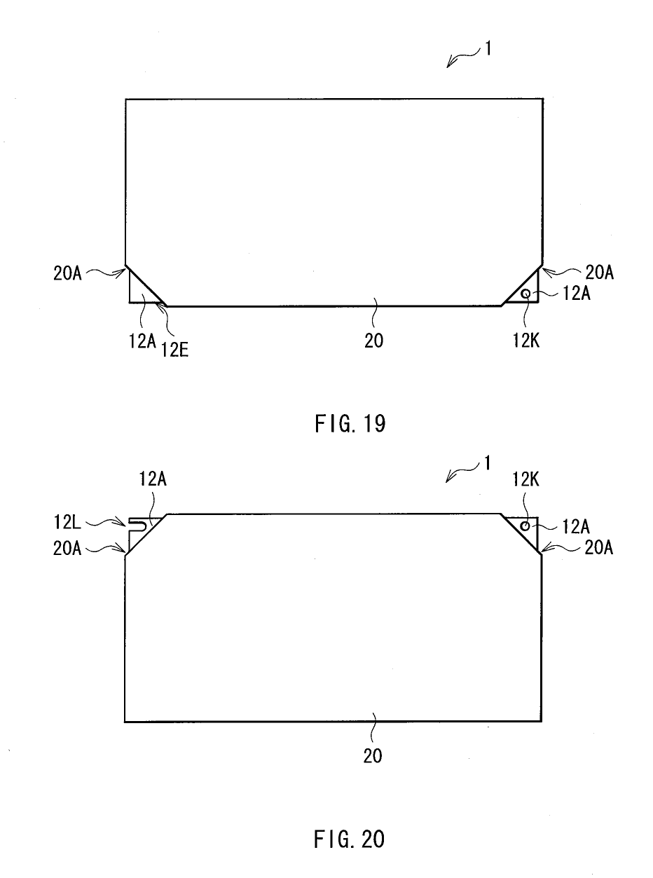

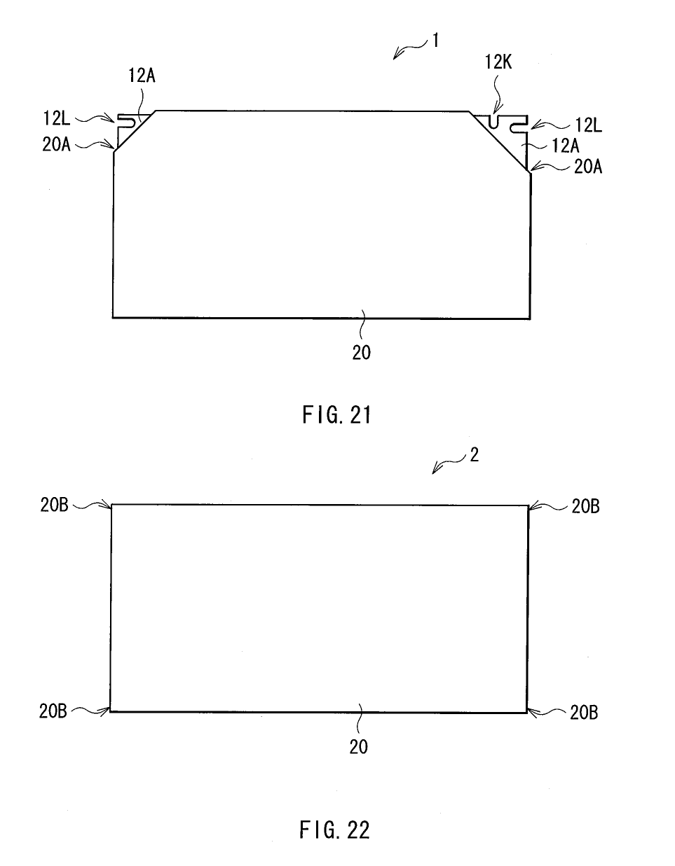

For example, as shown in FIG. 18, it is possible that the side face 12D on the lower side of one of the exposed portions 12A provided in the two corners on the lower side of the diffusion plate 12 functions as the supported portion 12E, a cut groove is provided in the side face 12D on the lower side of the other exposed portion, and the cut groove functions as the supported portion 12L. Further, for example, as shown in FIG. 19, it is possible that the side face 12D on the lower side of one of the exposed portions 12A provided in the two corners on the lower side of the diffusion plate 12 functions as the supported portion 12E, a through-hole is provided in the other exposed portion, and the through-hole functions as the supported portion 12K. Furthermore, for example, as shown in FIG. 20, it is possible that a cut groove is provided in the side face in the horizontal direction of one of the exposed portions 12A provided in the two corners on the upper side of the diffusion plate 12, the cut groove functions as the supported portion 12L, a through-hole is provided in the other exposed portion, and the through-hole functions as the supported portion 12K. Moreover, for example, as shown in FIG. 21, it is possible that a cut groove is provided in the side face in the horizontal direction of one of the exposed portions 12A provided in the two corners on the upper side of the diffusion plate 12, the cut groove functions as the supported portion 12L, cut grooves are respectively provided on the both side faces in the horizontal direction and in the vertical direction of the other exposed portion, and these two cut grooves respectively function as the supported portion 12L.

In addition, in the foregoing respective examples, the exposed portion 12A is provided only in corners of the diffusion plate 12. However, the exposed portion 12A may be provided in one side (outer edge) including two corners of the diffusion plate 12. For example, though not shown, it is possible that the exposed portion 12A is provided on the side (outer edge) on the lower side including the two corners on the lower side of the diffusion plate 12, the side face 12D on the lower side of one corner of the exposed portions 12A functions as the supported portion 12E, a cut groove is provided on the side face 12D on the lower side of the other corner, and the cut groove functions as the supported portion 12L.

Next, a description will be given of an optical operation of the optical sheet packaged body 1 of this embodiment. In addition, in the followings, the description will be given of a case where a plurality of linear light sources are arranged directly under the optical sheet packaged body 1 (directly under the light source image segmentation sheet 11) so that the plurality of linear light sources are in parallel with the extending direction of each prism of the light source image segmentation sheet 11.

When light from each linear light source arranged directly under the optical sheet packaged body 1 enters the optical sheet packaged body 1, the incident light is segmented into minute light beams by the light source image segmentation sheet 11, and a light source image obtained by the segmentation is diffused by the diffusion plate 12 and the diffusion sheet 13. Thereby, the luminance distribution in the in-plane direction becomes uniform. The diffusion light having uniform luminance is collected by the luminance enhancement film 14, and the front luminance increases.

In this case, the flexible film 20 is a flexible optical sheet formed at least in the region through which light from the light source passes out of the surface of the laminated body 10. Thus, the flexible film 20 does not optically act on the incident light and does not disturb the luminance distribution of the incident light.

Further, the flexible film 20 wraps around each optical sheet such as the light source image segmentation sheet 11, the diffusion plate 12, the diffusion sheet 13, and the luminance enhancement film 14, and has one or the plurality of openings 20A to expose at least part of the outer edge of the diffusion plate 12. Further, the shape for positioning to the chassis that supports the optical sheet packaged body 1 is provided in the exposed portion 12A that is exposed from at least one opening 20A of the diffusion plate 12. Thereby, in positioning the laminated body 10 to the chassis, it is possible that only the diffusion plate 12 of the laminated body 10 is supported by the chassis and each optical sheet is supported by the flexible film 20. As a result, each optical sheet in the laminated body 10 is able to be individually stretched and shrunk to the lamination in-plane direction. Accordingly, it is possible to eliminate generation of wrinkles.

### Second Embodiment

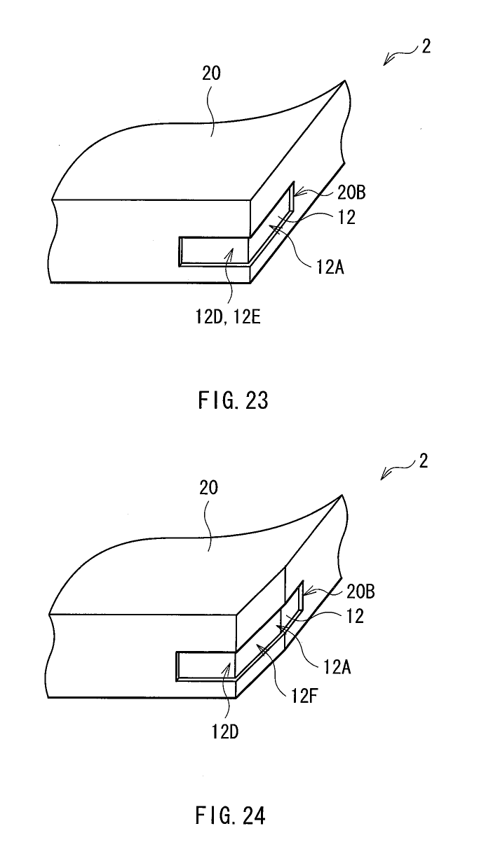

FIG. 22 shows an example of a top face structure of an optical sheet packaged body 2 according to a second embodiment. The optical sheet packaged body 2 is arranged, for example, between the liquid crystal display panel and the light source as in the foregoing embodiment, and is suitably used to improve the optical characteristics of the light source. FIG. 23 shows an enlarged end portion of the optical sheet packaged body 2 of FIG. 22. The optical sheet packaged body 2 of FIG. 22 has a cross sectional structure similar to the cross sectional structure of FIG. 2.

The optical sheet packaged body 2 includes the laminated body 10 and the flexible film 20 as shown in FIG. 2. In addition, a description for structures, operations, and effects similar to those of the foregoing embodiment will be omitted as appropriate, and a description will be hereinafter mainly given of the differences from the foregoing embodiment.

As shown in FIG. 23, the flexible film 20 in this embodiment has one or a plurality of openings 20B to expose at least part of the outer edge (side face) of the diffusion plate 12. FIG. 22 and FIG. 23 show a case where the openings 20B are provided in corners of the diffusion plate 12 as an example. In this embodiment, a description will be hereinafter given of the flexible film 20 and the diffusion plate 12 under the condition that the opening 20A is provided at least in a corner of the diffusion plate 12.

As shown in FIG. 23, part of the side face 12D of the diffusion plate 12 is exposed from the opening 20B. In this case, part of the portion exposed from the opening 20B (exposed portion 12A) functions as a supported portion 12E for positioning to the chassis that supports the optical sheet packaged body 2. For example, the side face 12D in the vertical direction functions as the supported portion 12E, or the side face 12D in the horizontal direction functions as the supported portion 12E depending on the shape of the chassis.

In addition, the exposed portion 12A is not necessarily in the shape of a plane face as shown in FIG. 23. For example, as shown in FIG. 24, the exposed portion 12A may be in the shape of a three dimensional figure in which the end portion where the both side faces 12D are orthogonal to each other is cut off flatly in a direction almost in parallel with the opposing direction of the top face 12B and the bottom face 12C. In this case, however, the side face having a planar shape at a given angle to the side face 12D that is formed by cutting off the end portion is caused to function as the supported portion 12F for positioning to the chassis that supports the optical sheet packaged body 2.

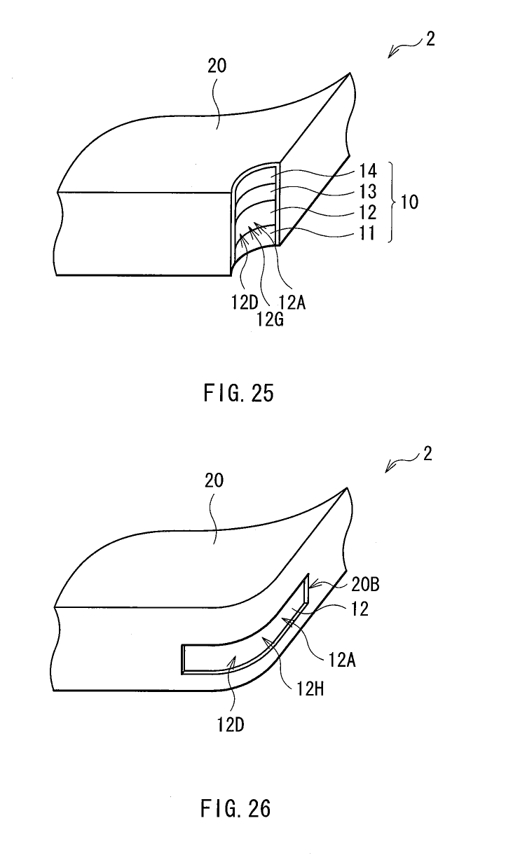

Further, for example, as shown in FIG. 25, the exposed portion 12A may be in the shape of a three dimensional figure in which the end portion where adjacent faces out of the top face 12B, the bottom face 12C, and the side face 12D are orthogonal to each other is cut off in a state of a concave face in a direction almost in parallel with the opposing direction of the top face 12B and the bottom face 12C. In this case, however, the side face having a concave curved shape that is formed by cutting off the end portion is caused to function as the supported portion 12G for positioning to the chassis that supports the optical sheet packaged body 2.

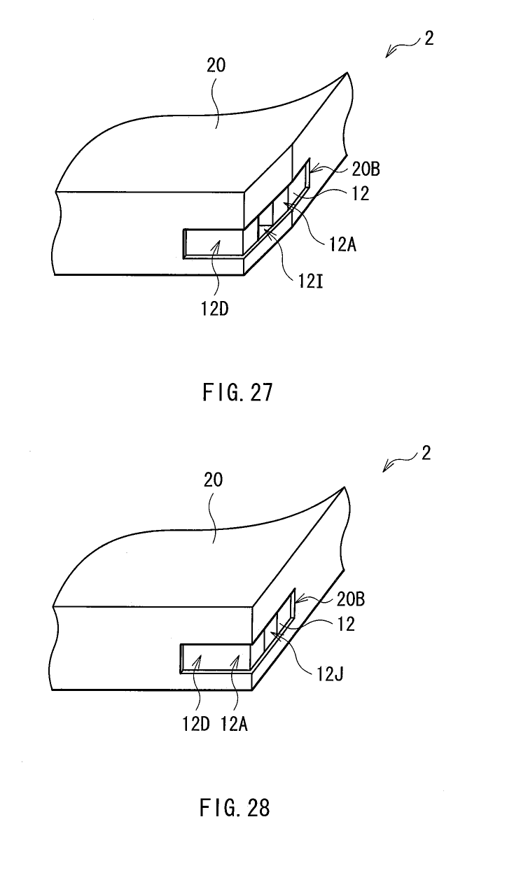

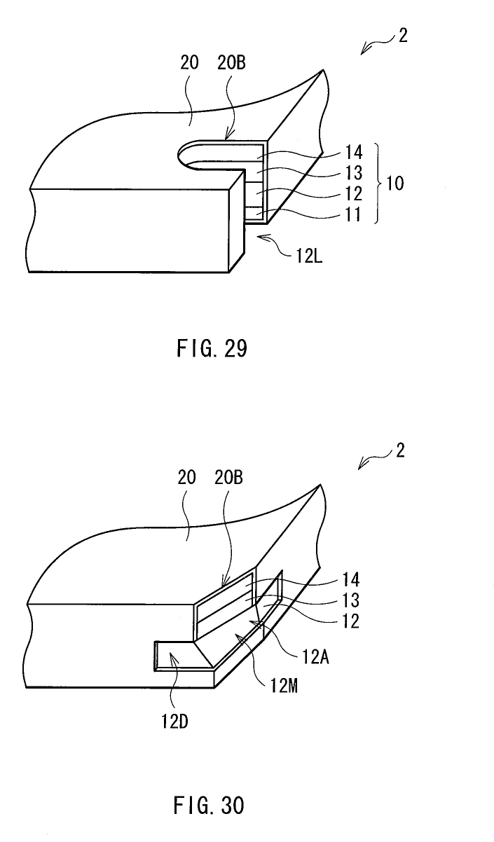

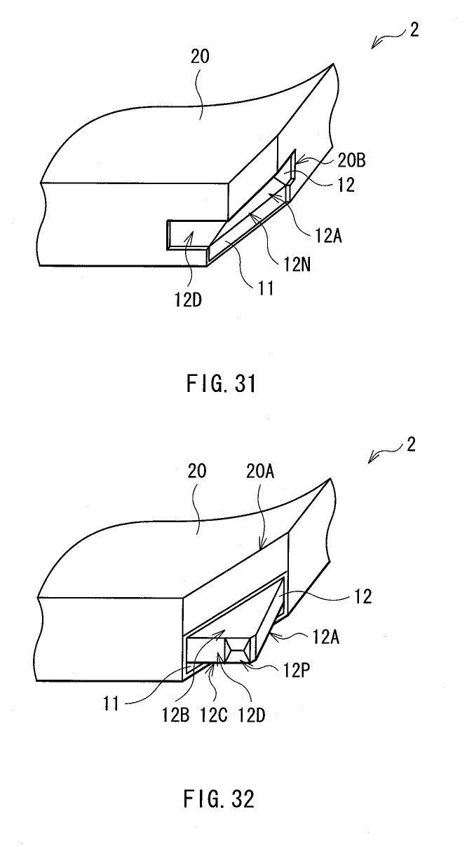

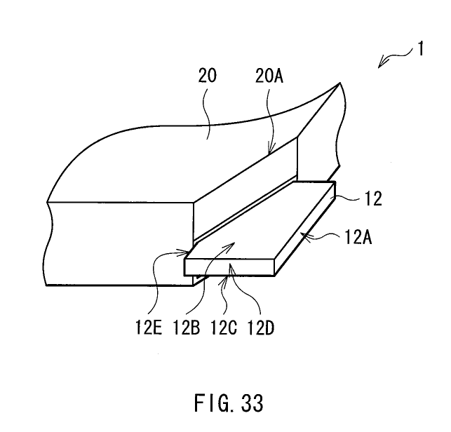

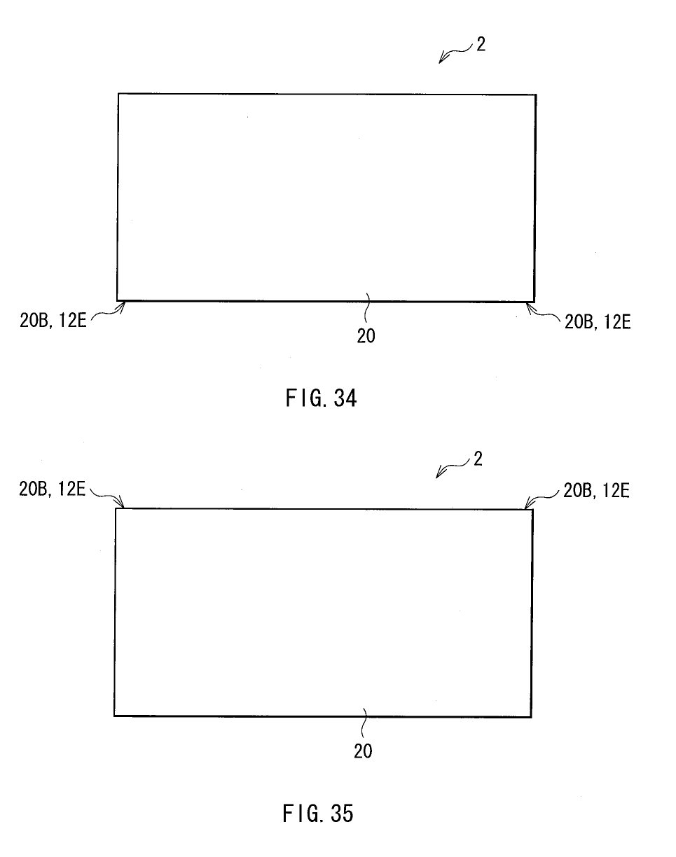

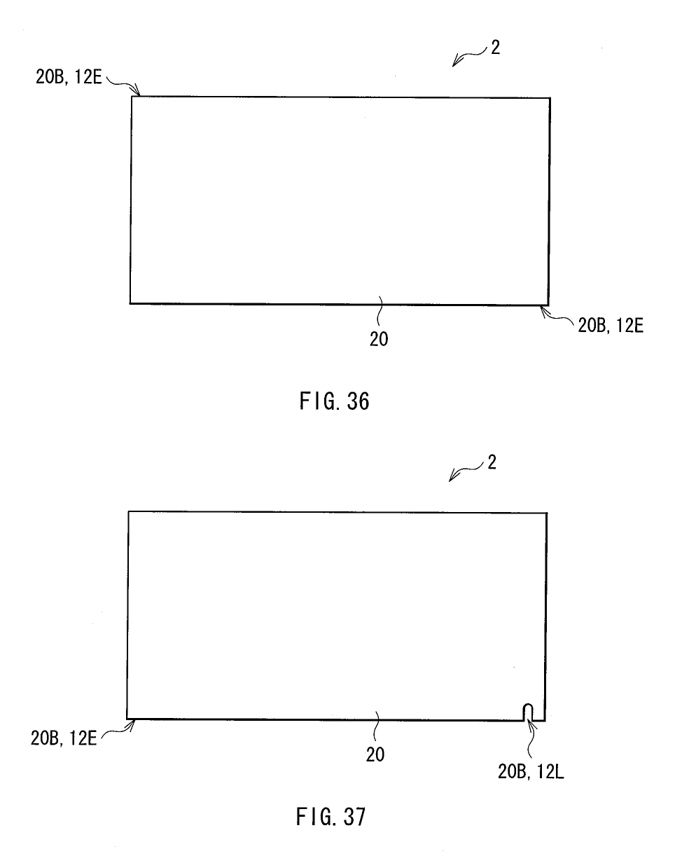

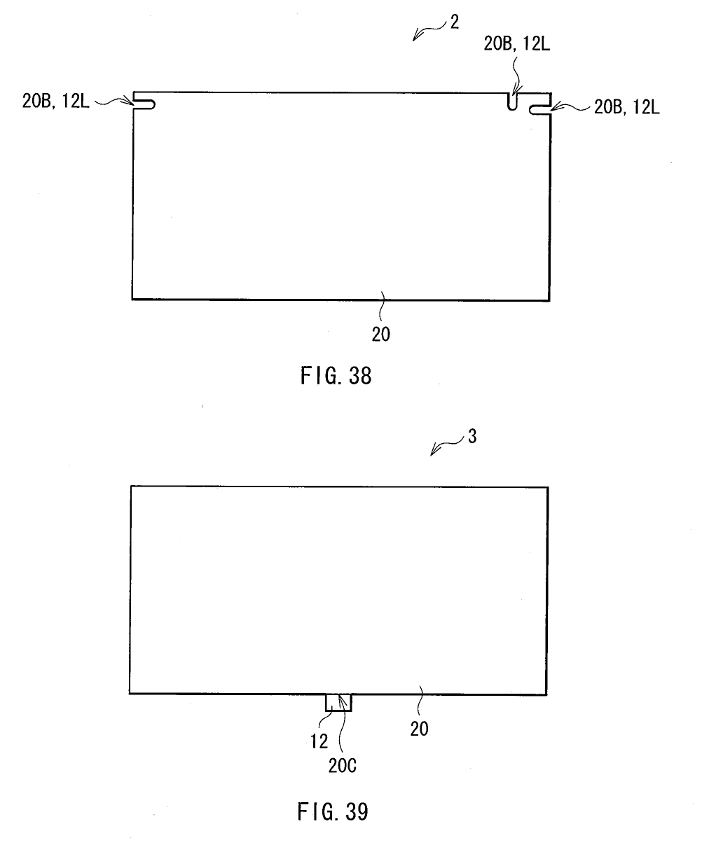

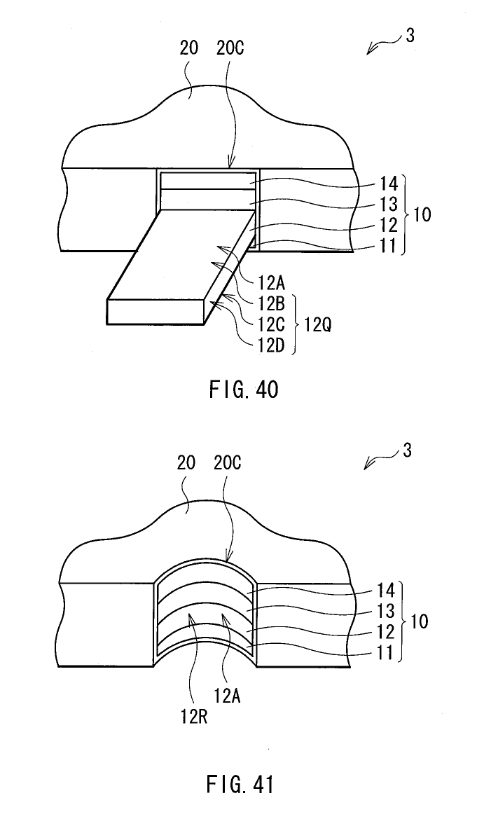

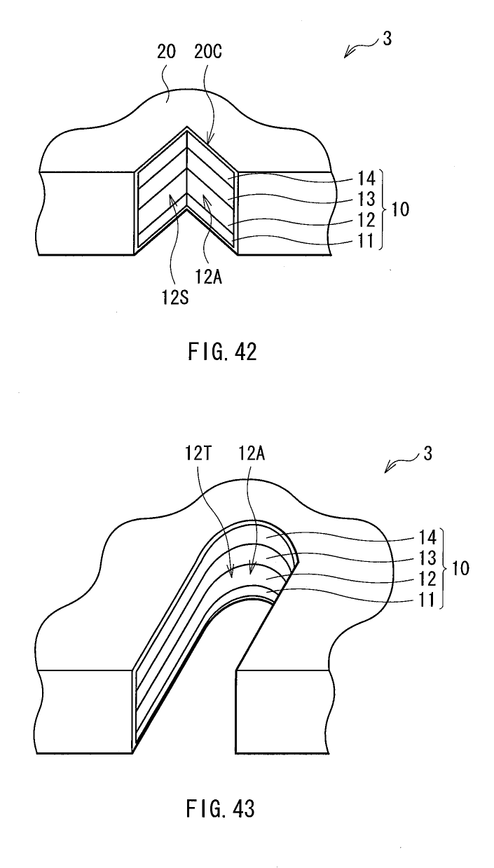

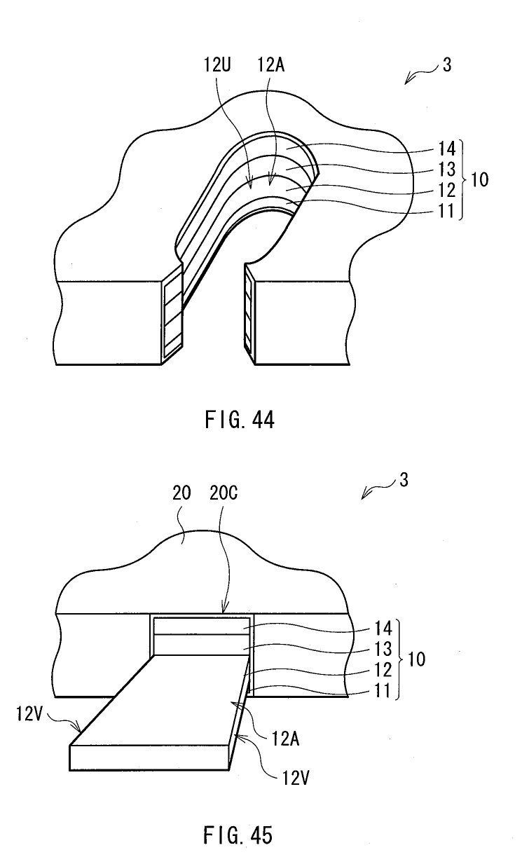

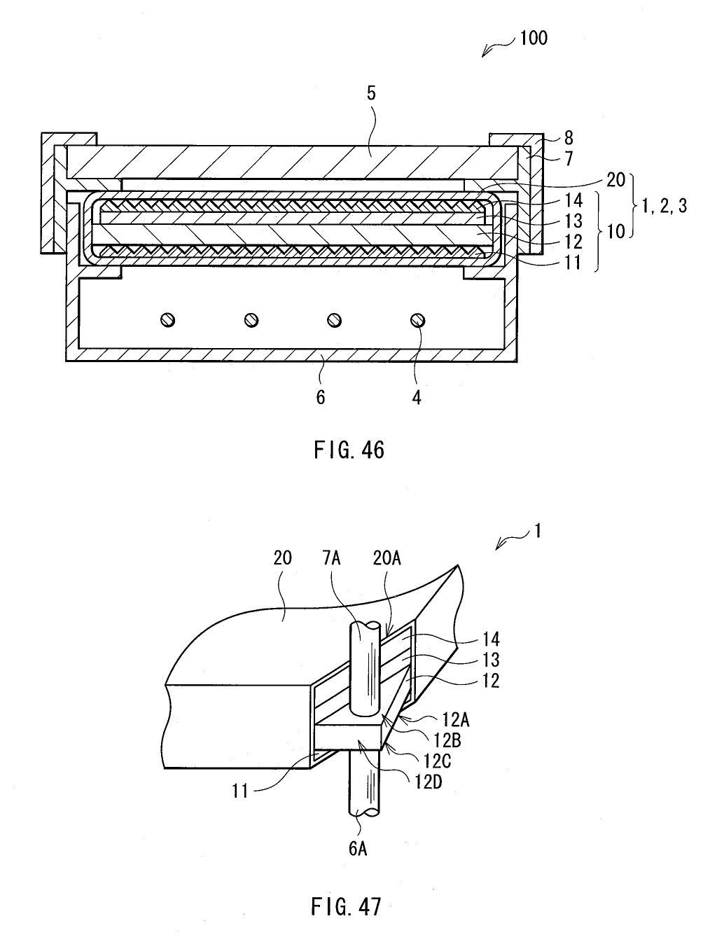

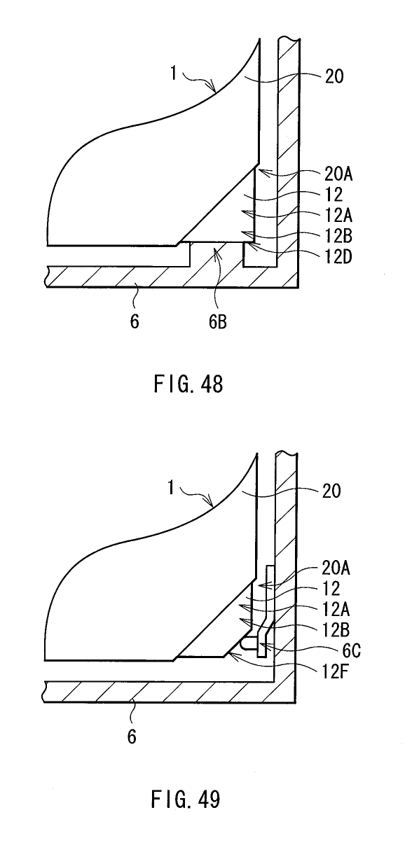

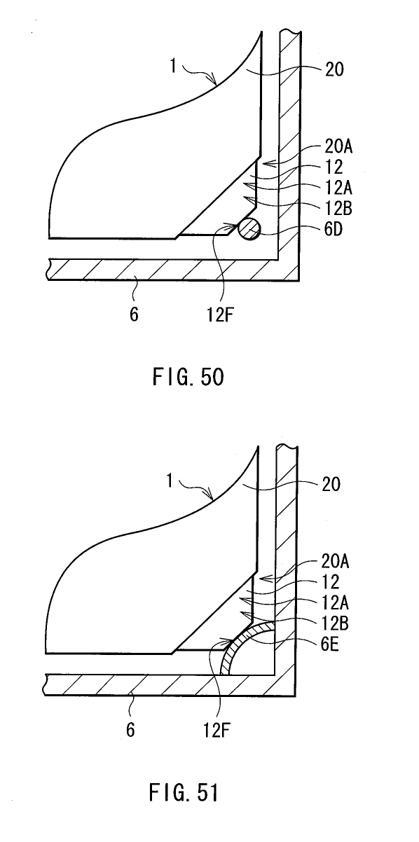

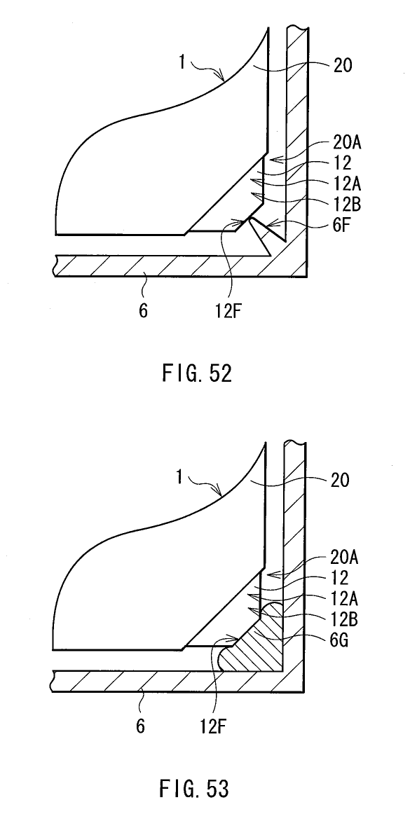

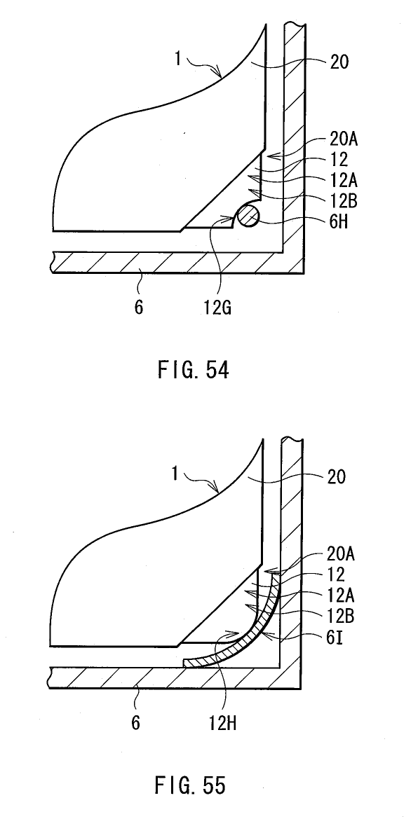

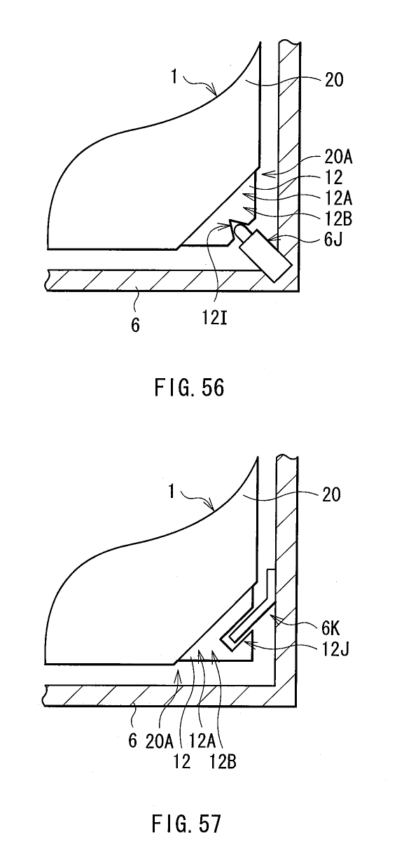

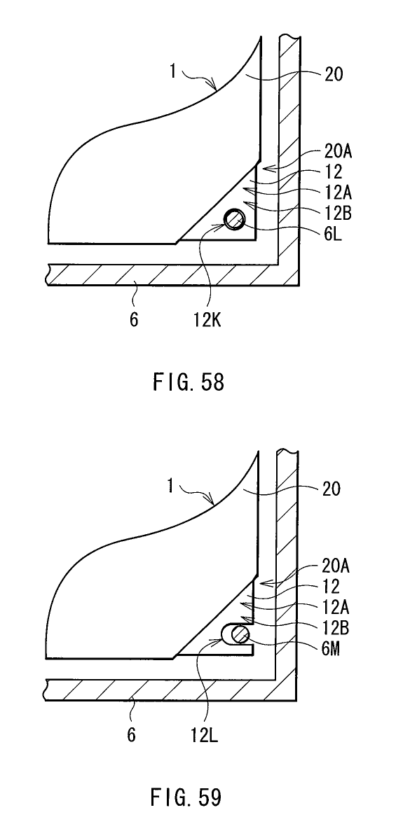

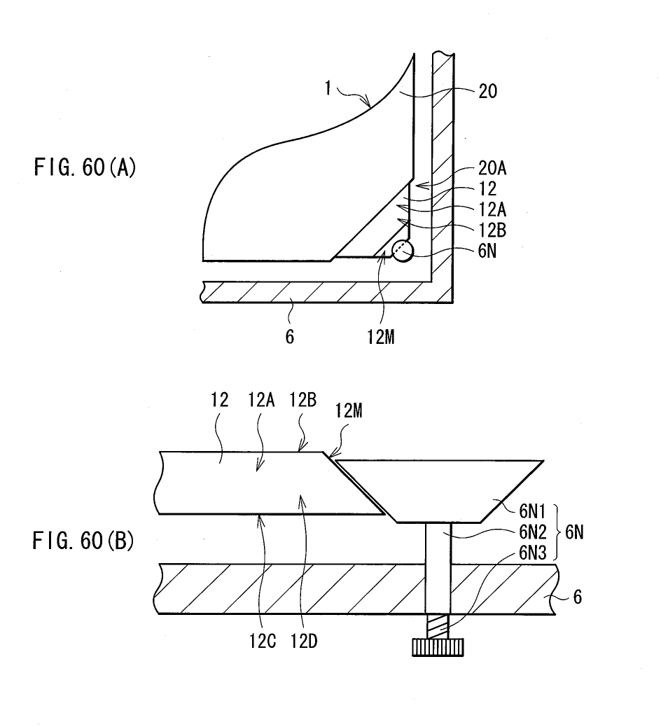

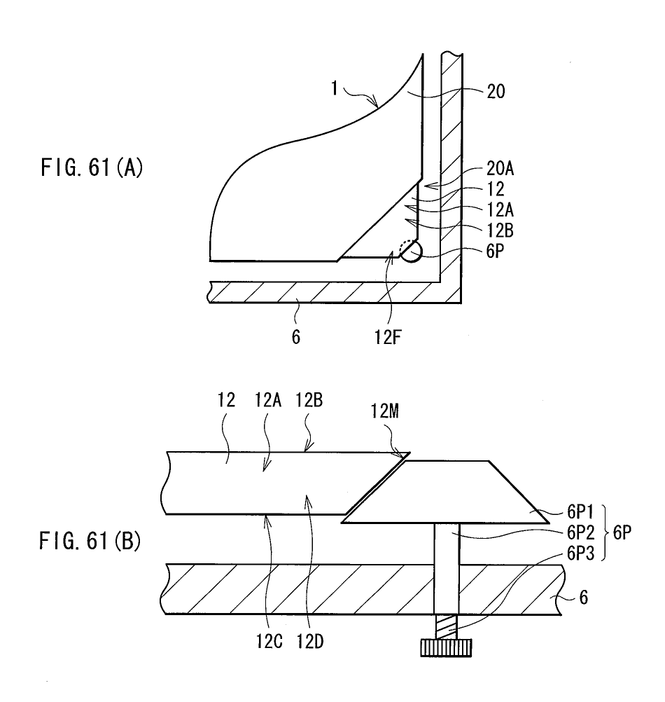

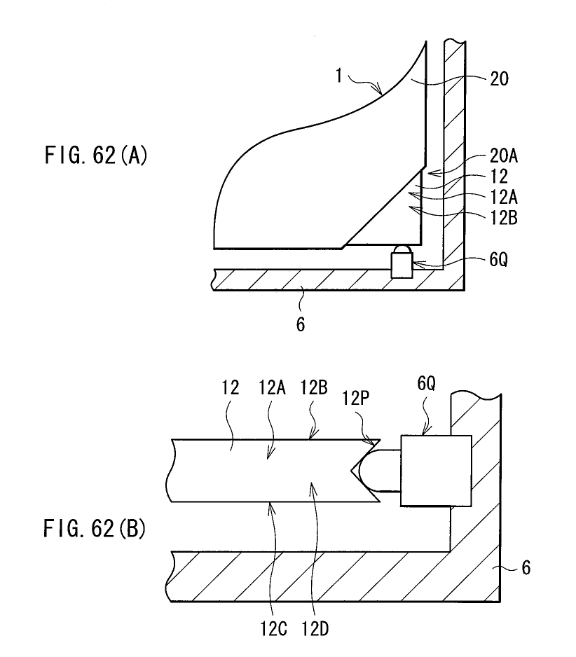

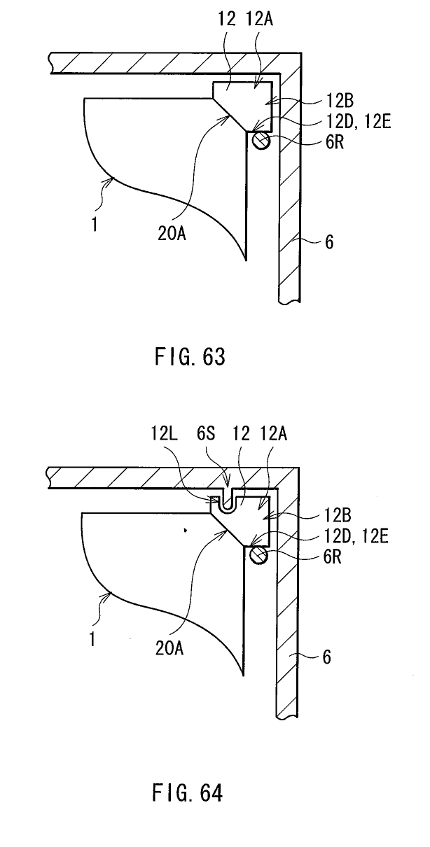

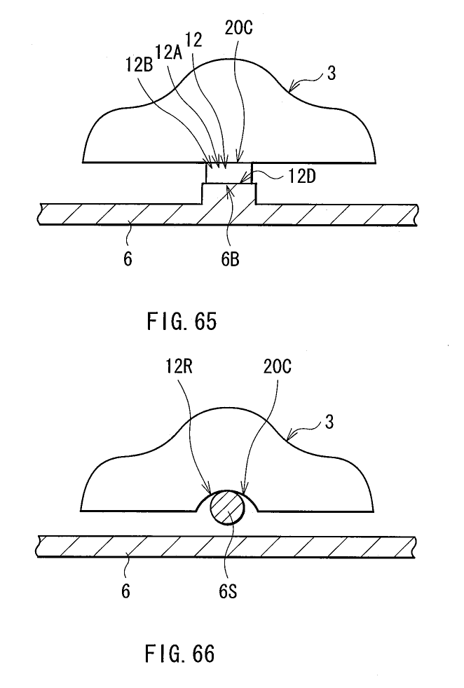

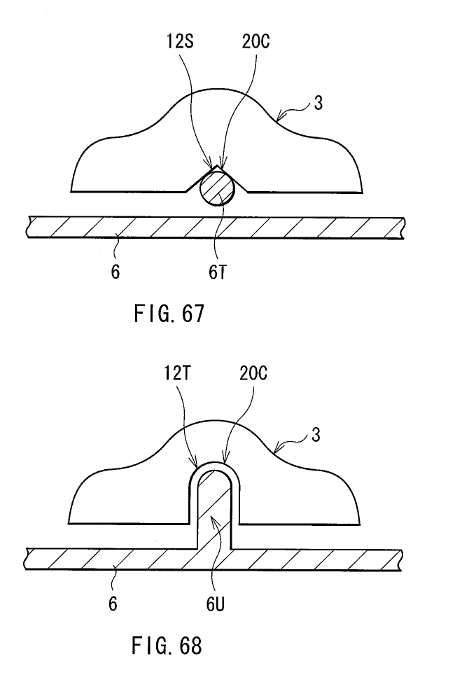

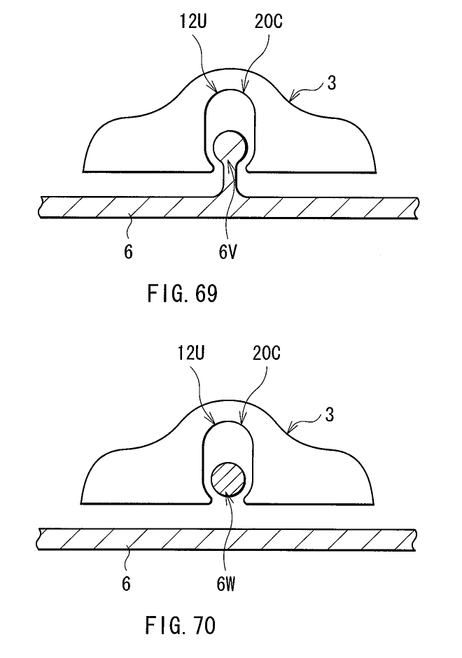

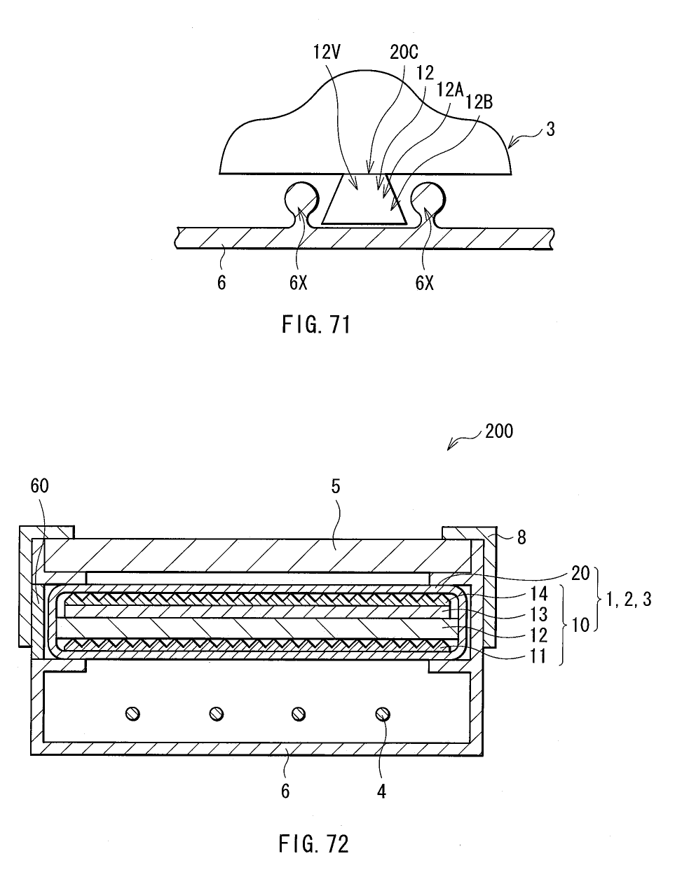

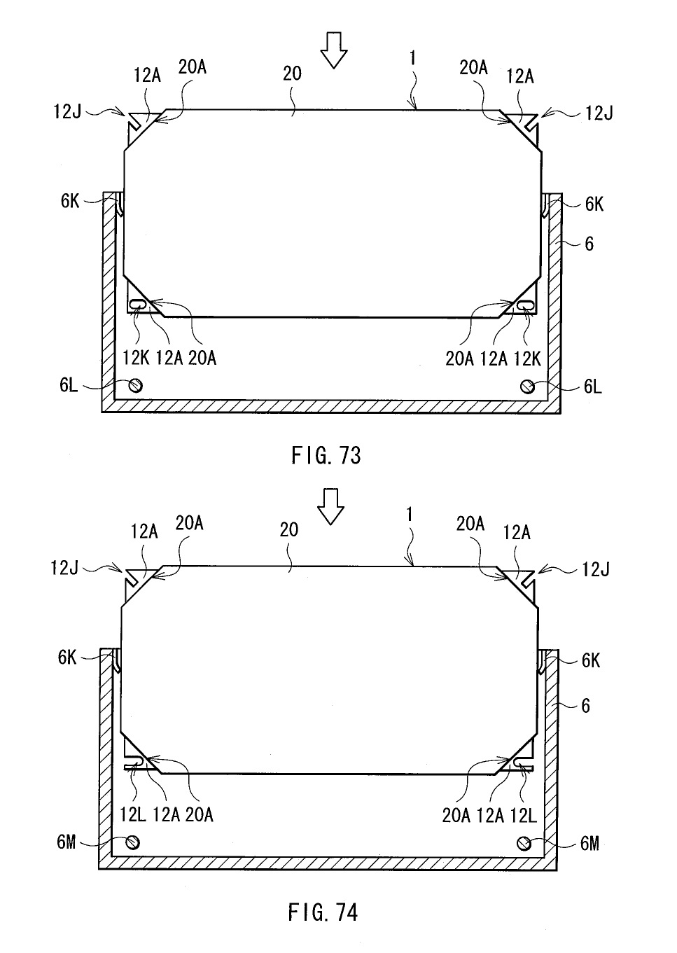

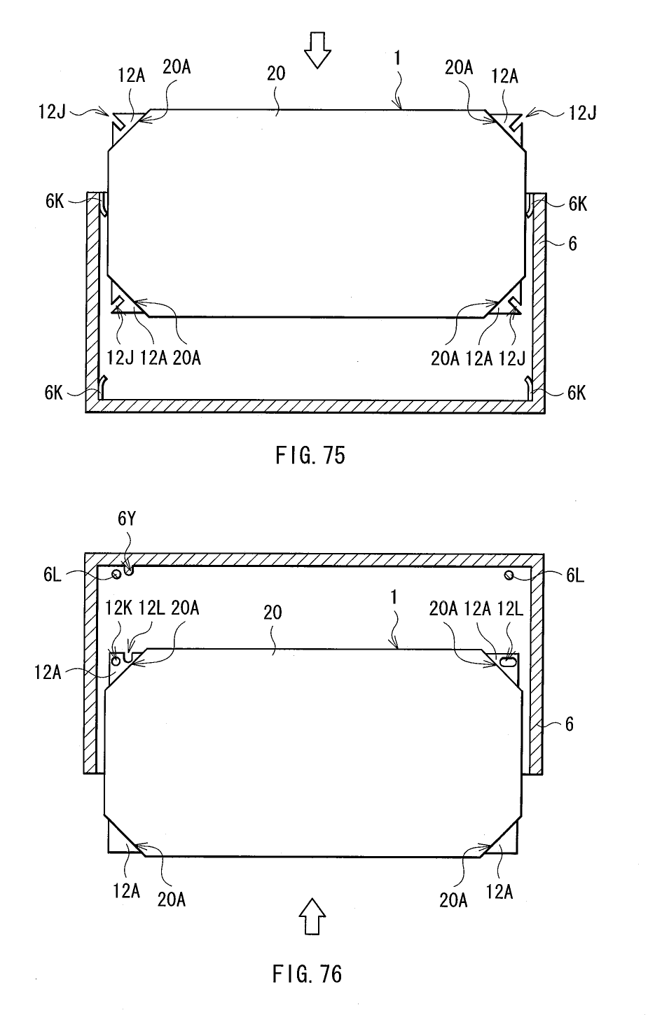

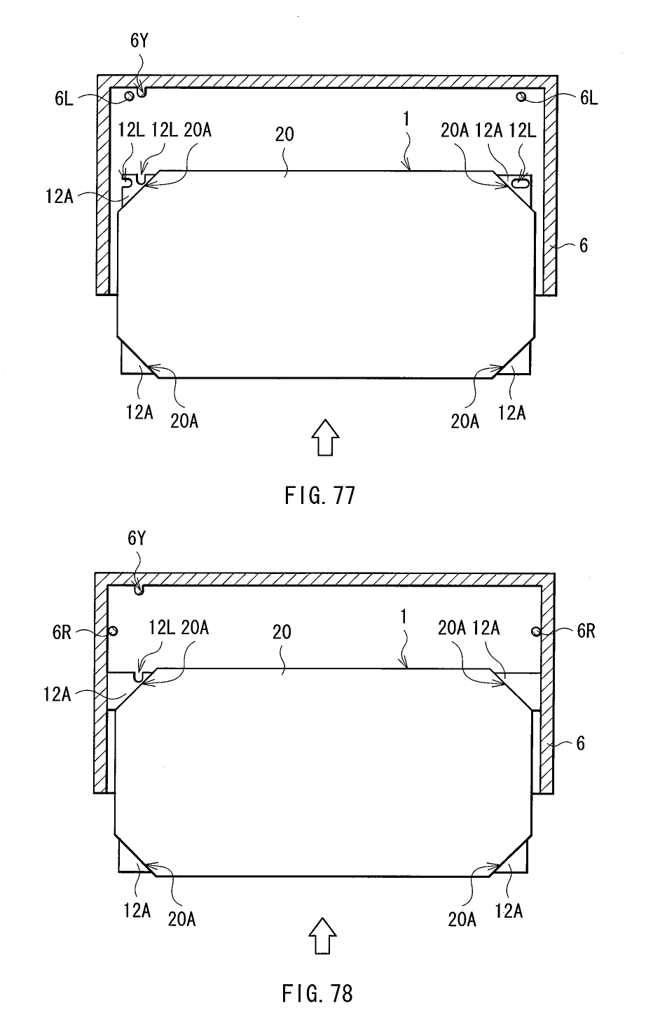

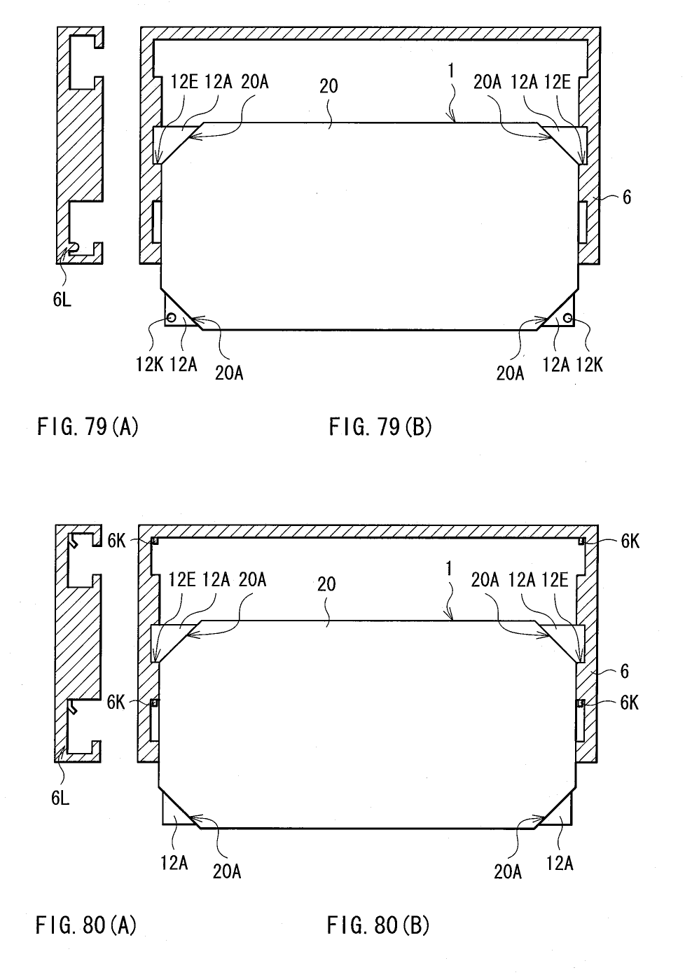

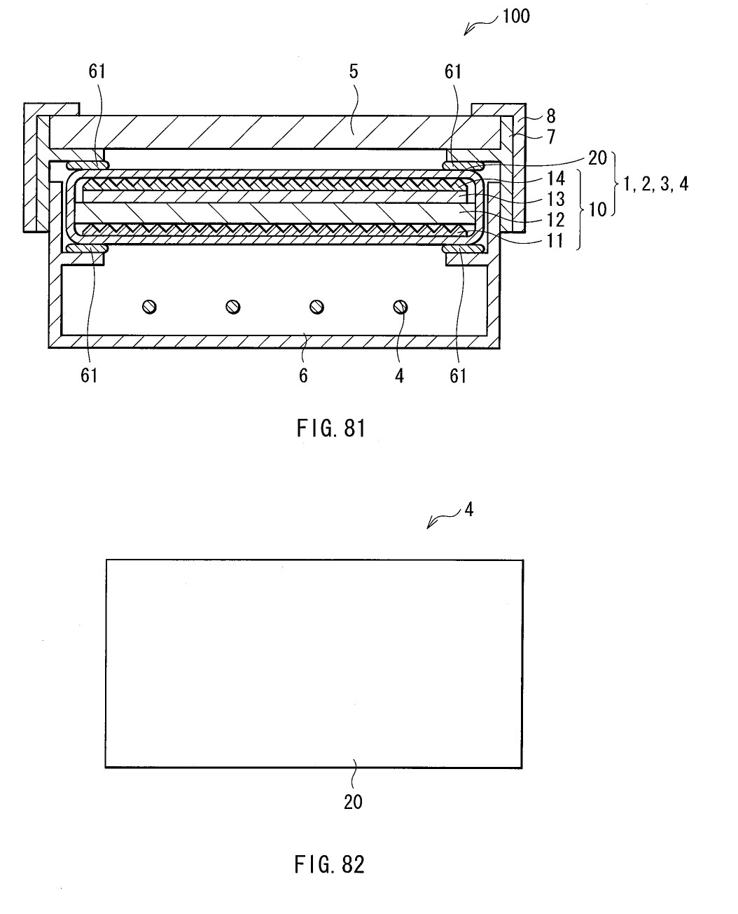

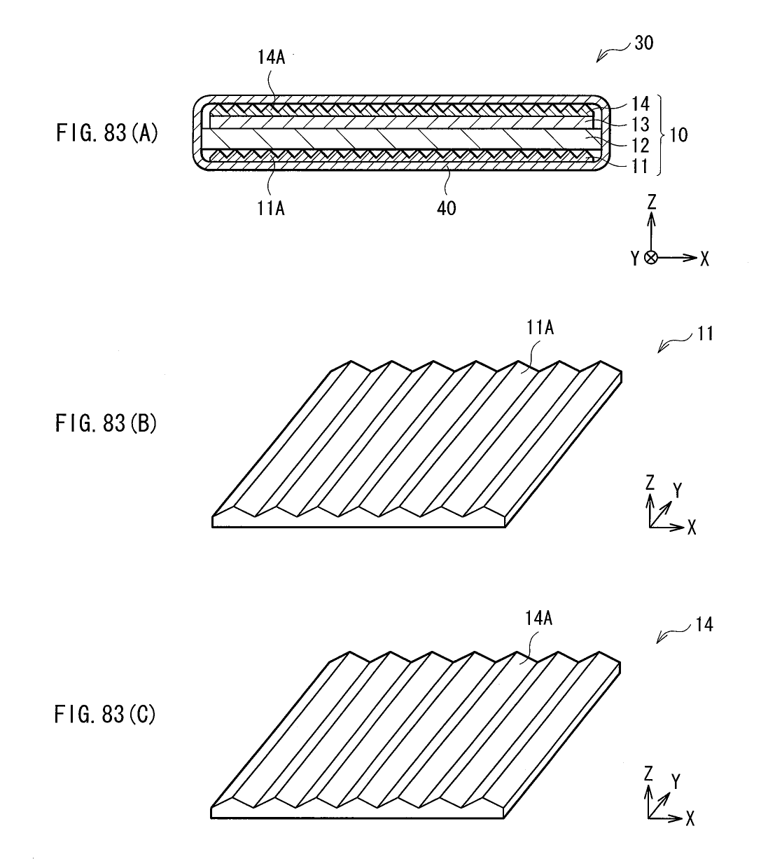

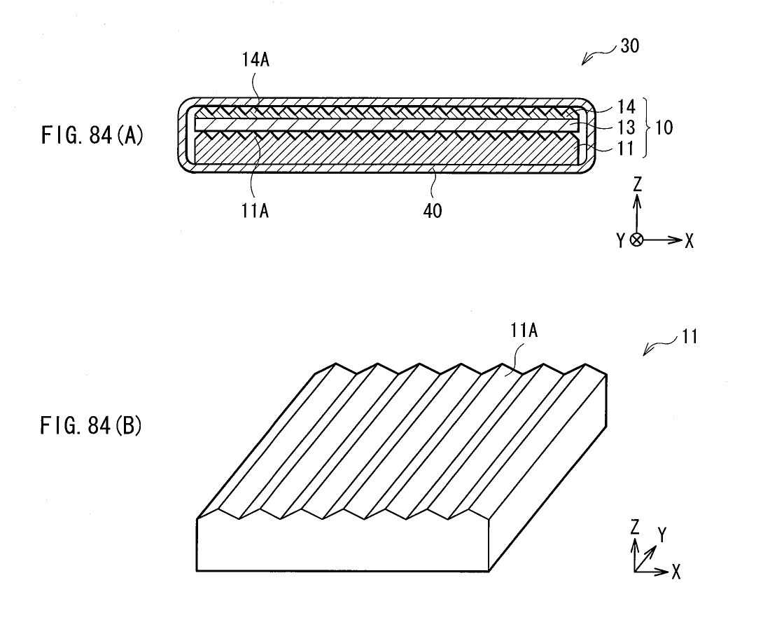

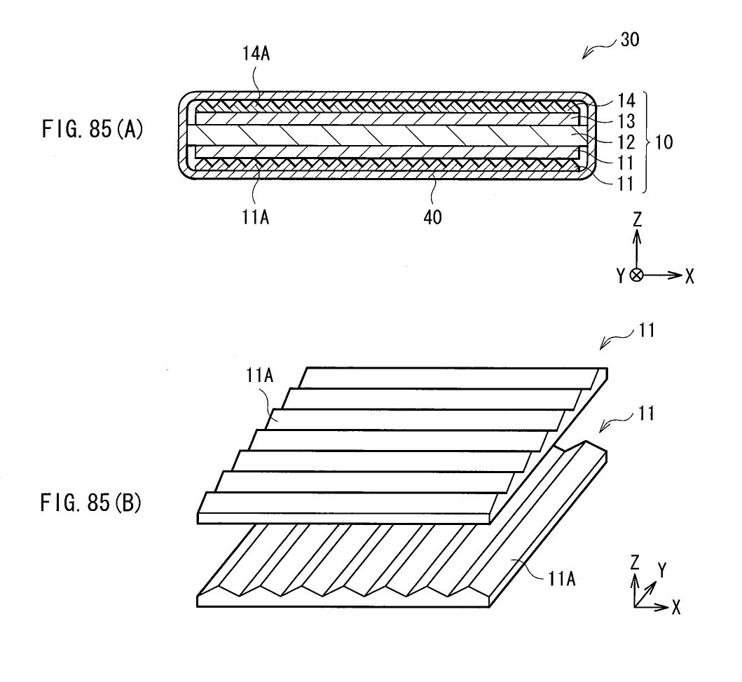

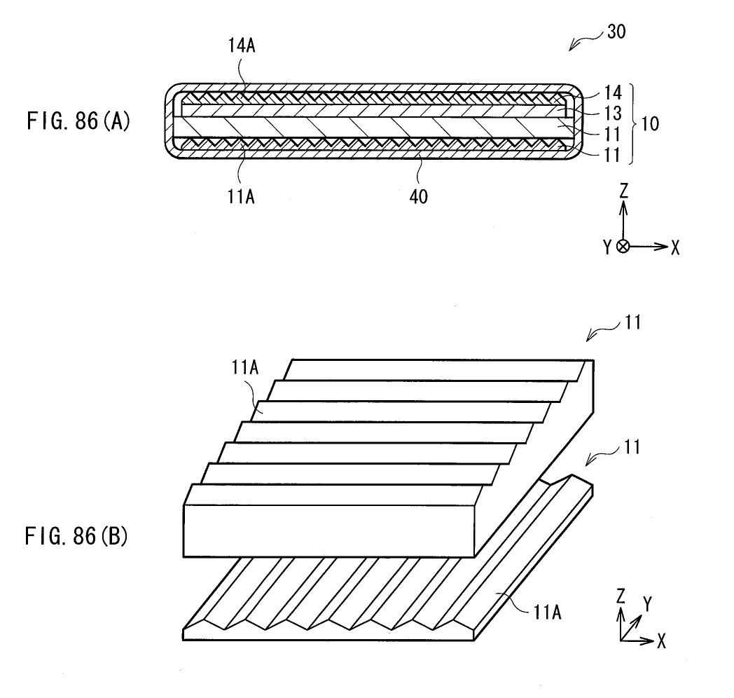

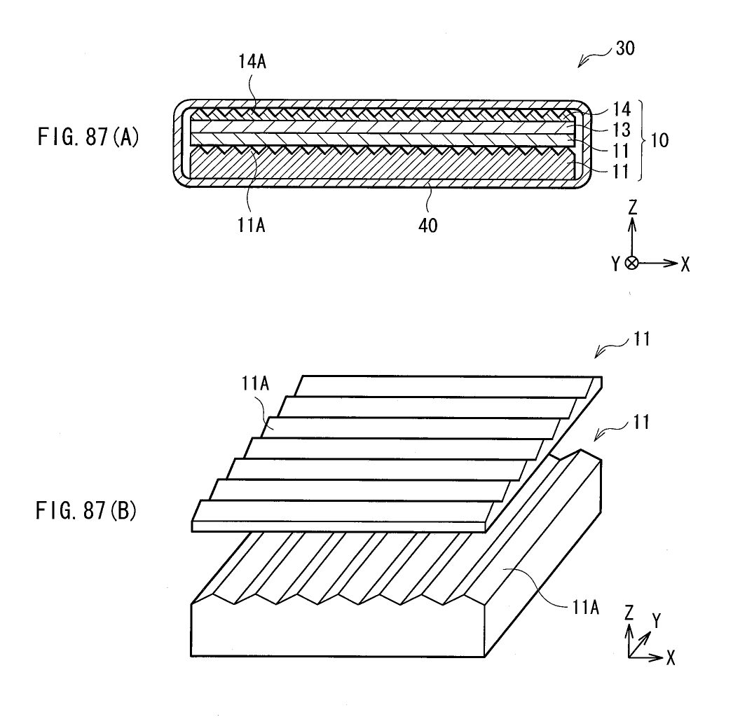

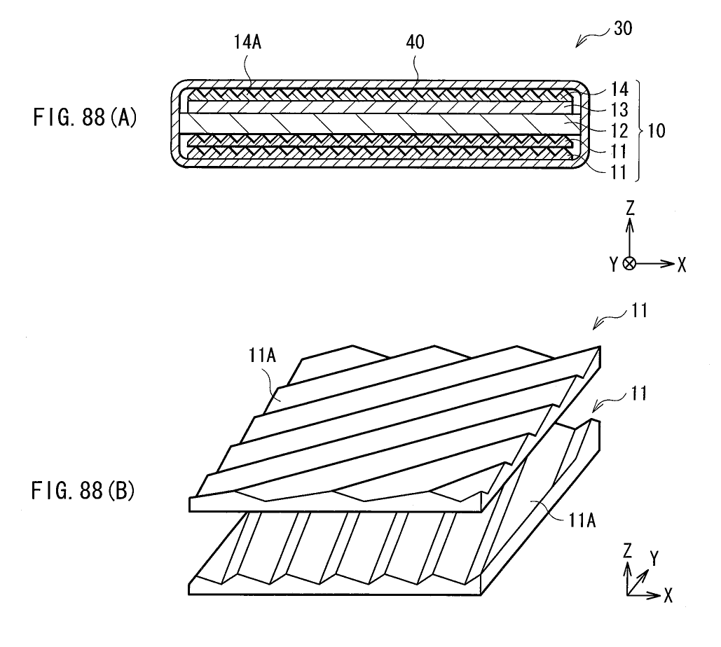

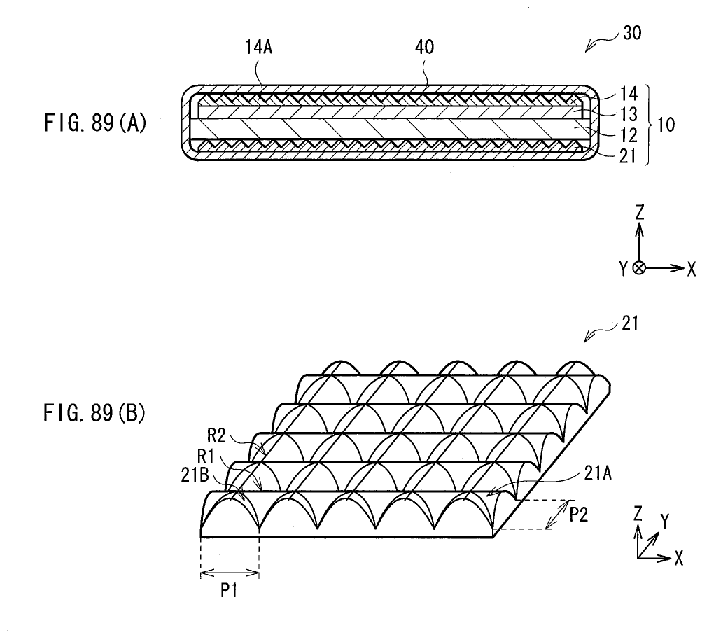

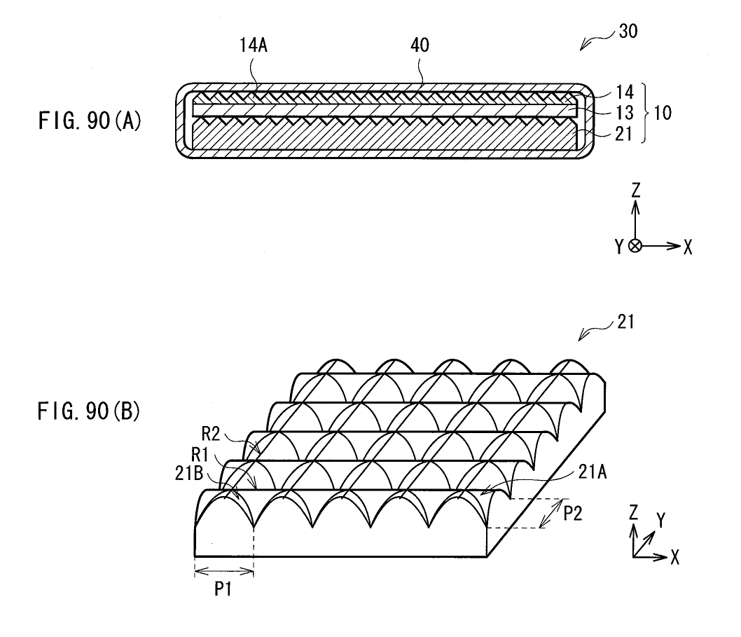

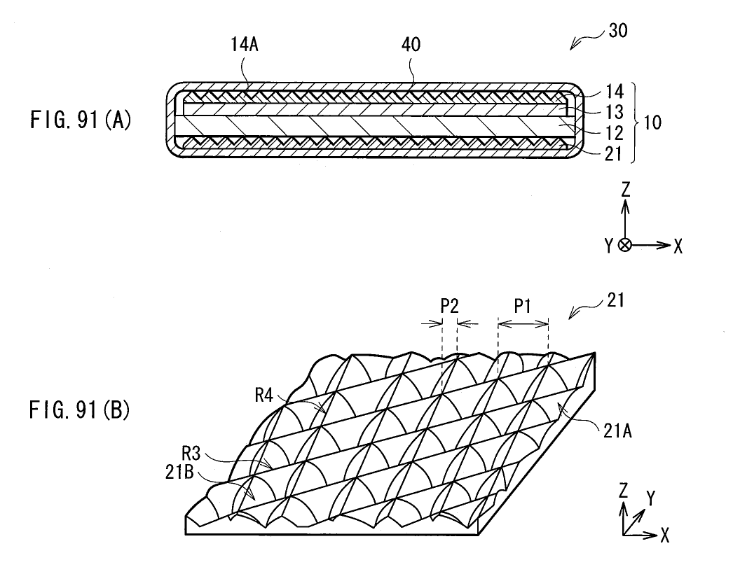

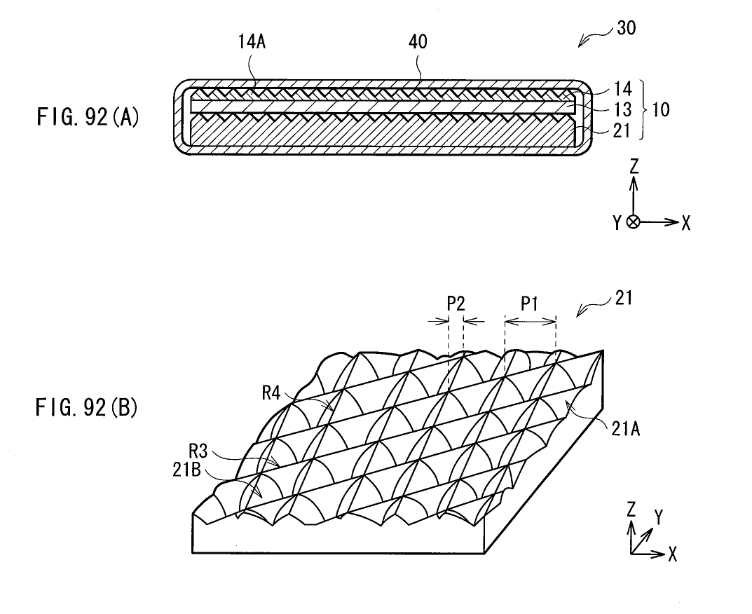

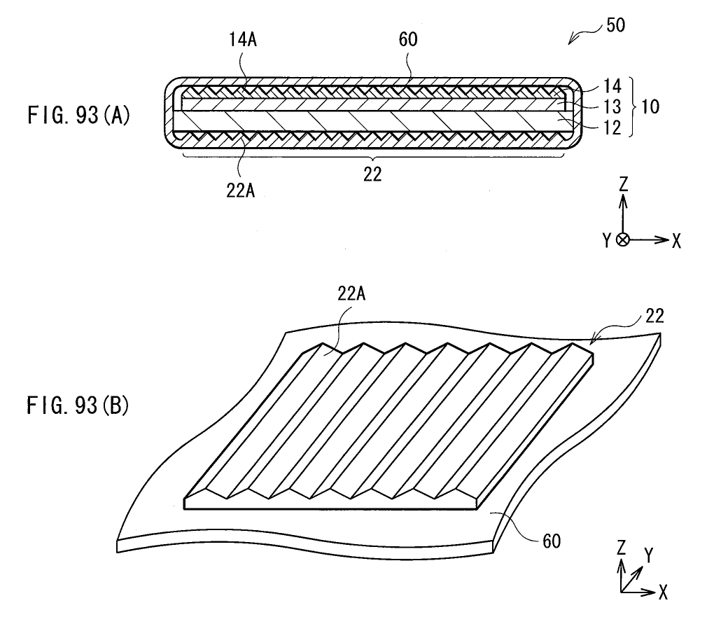

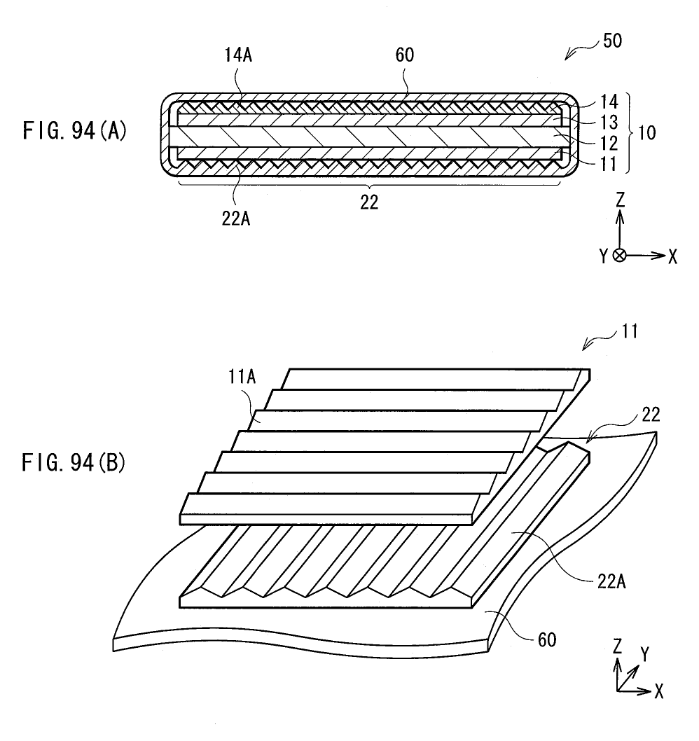

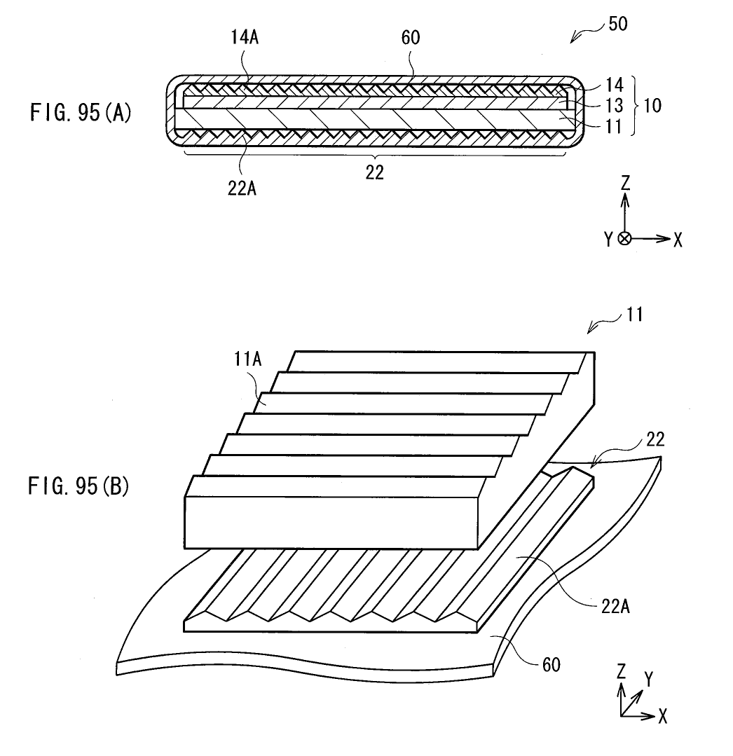

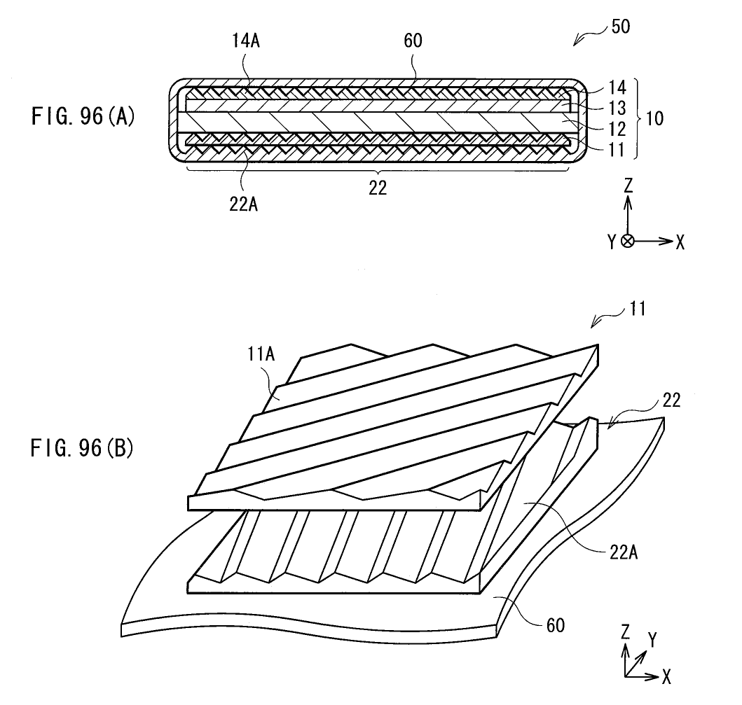

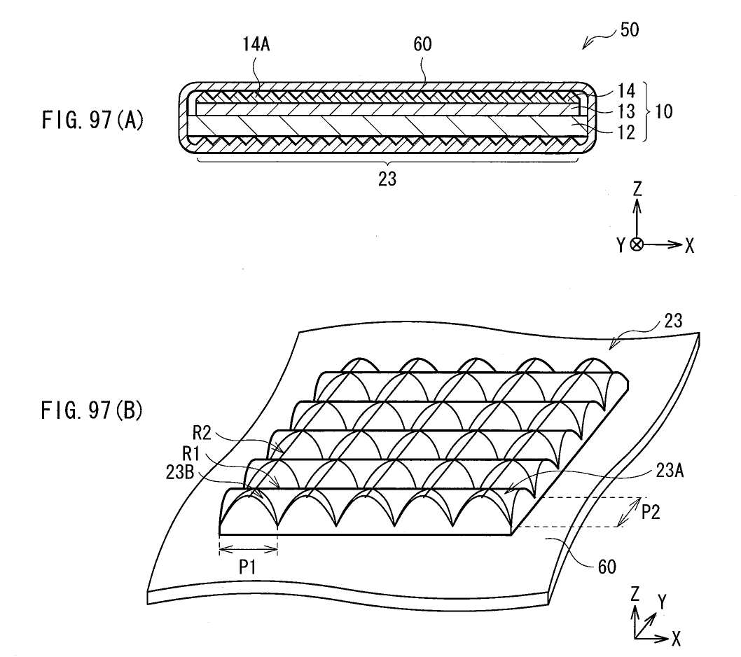

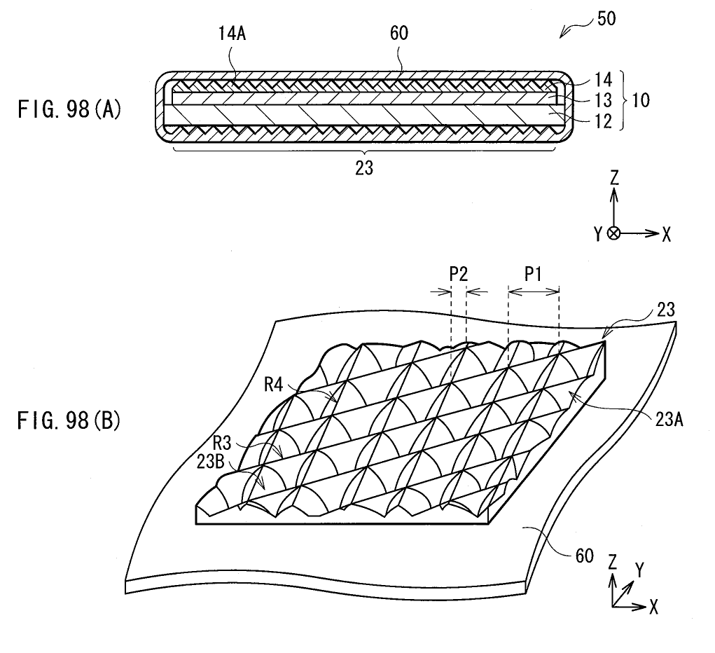

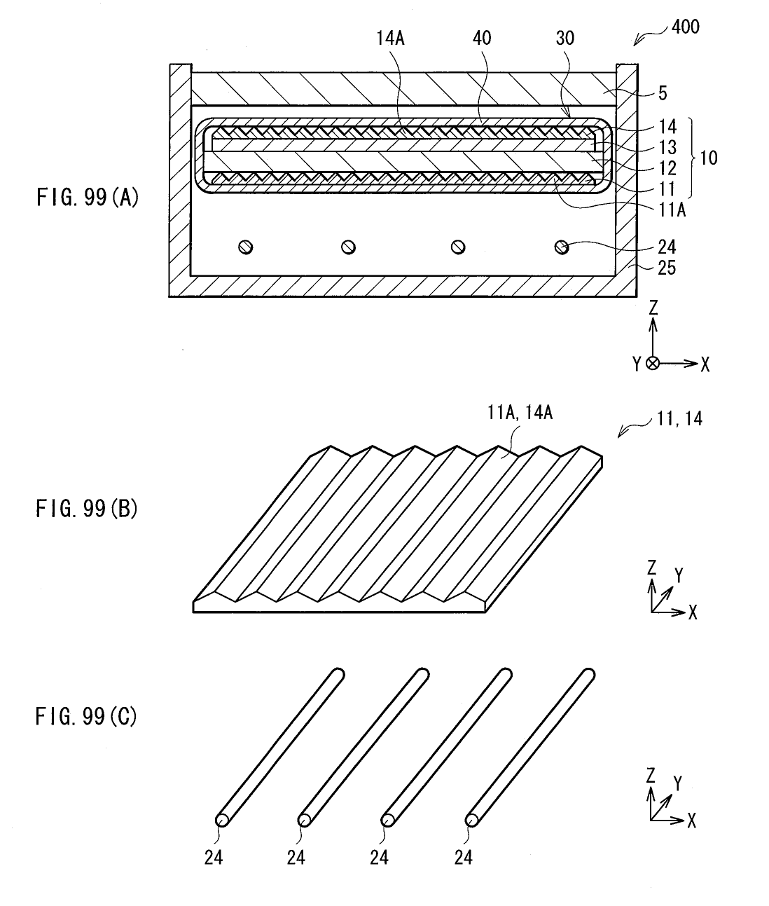

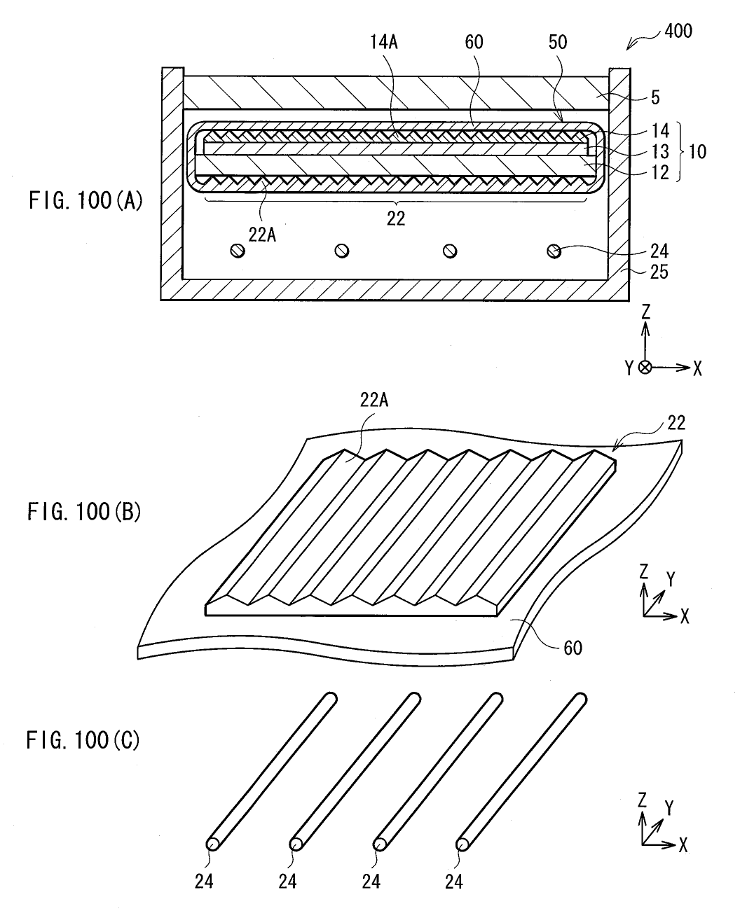

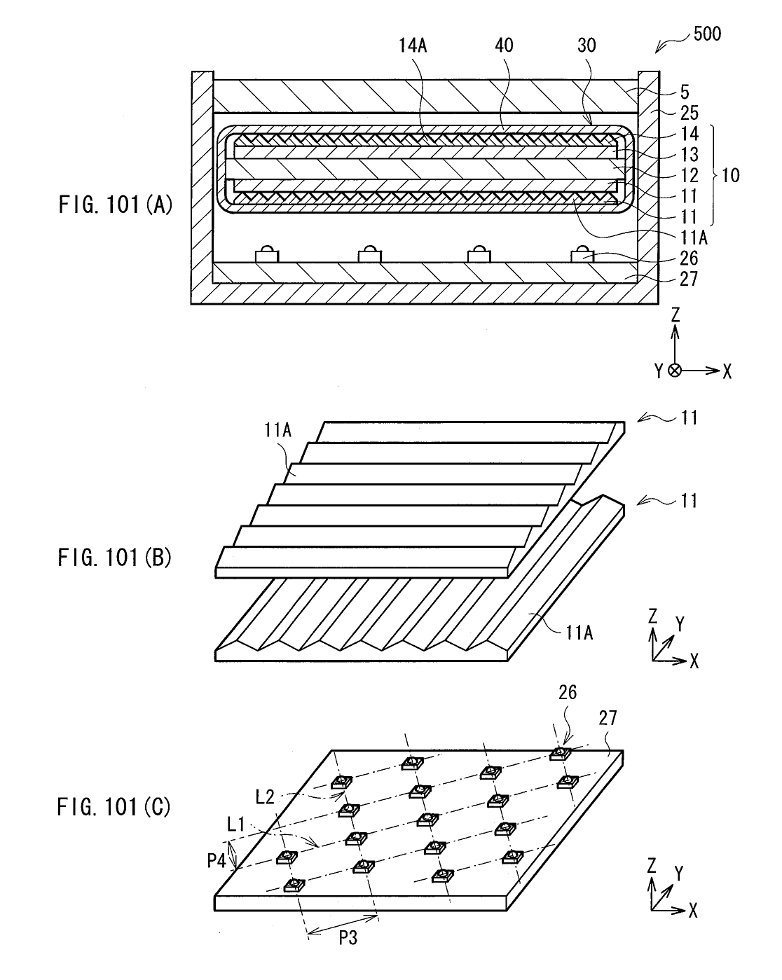

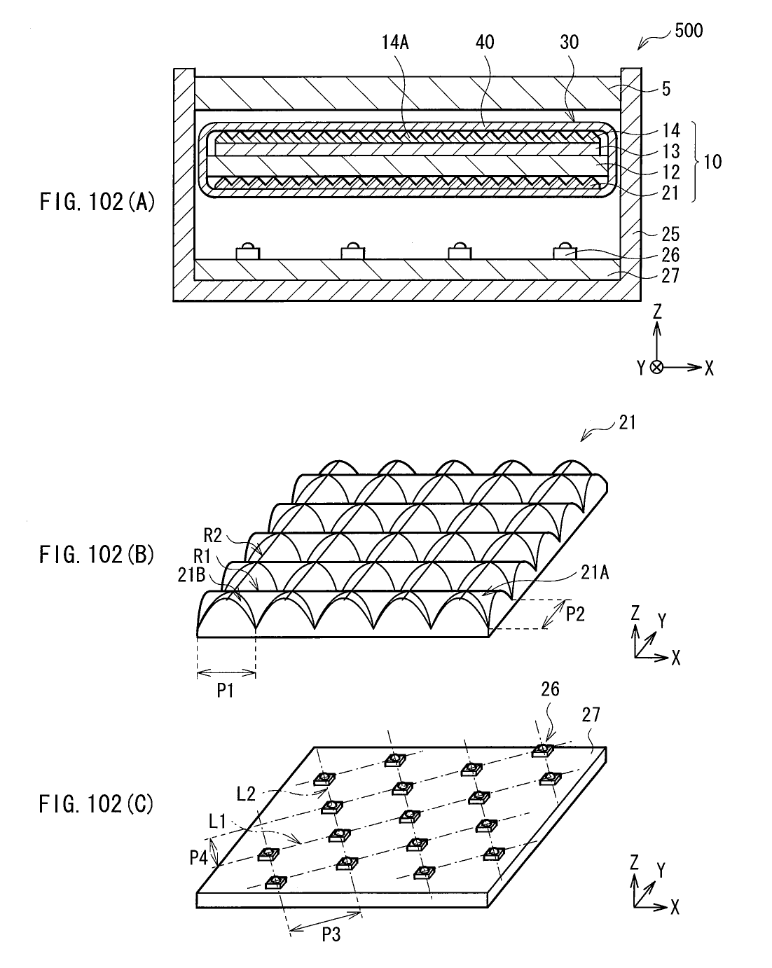

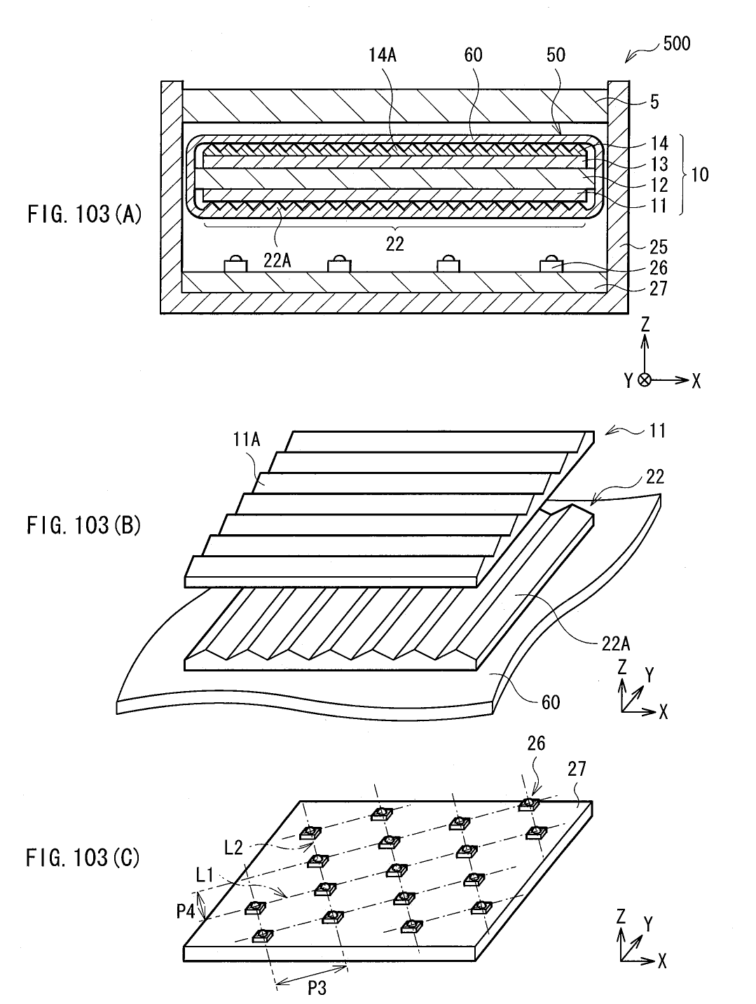

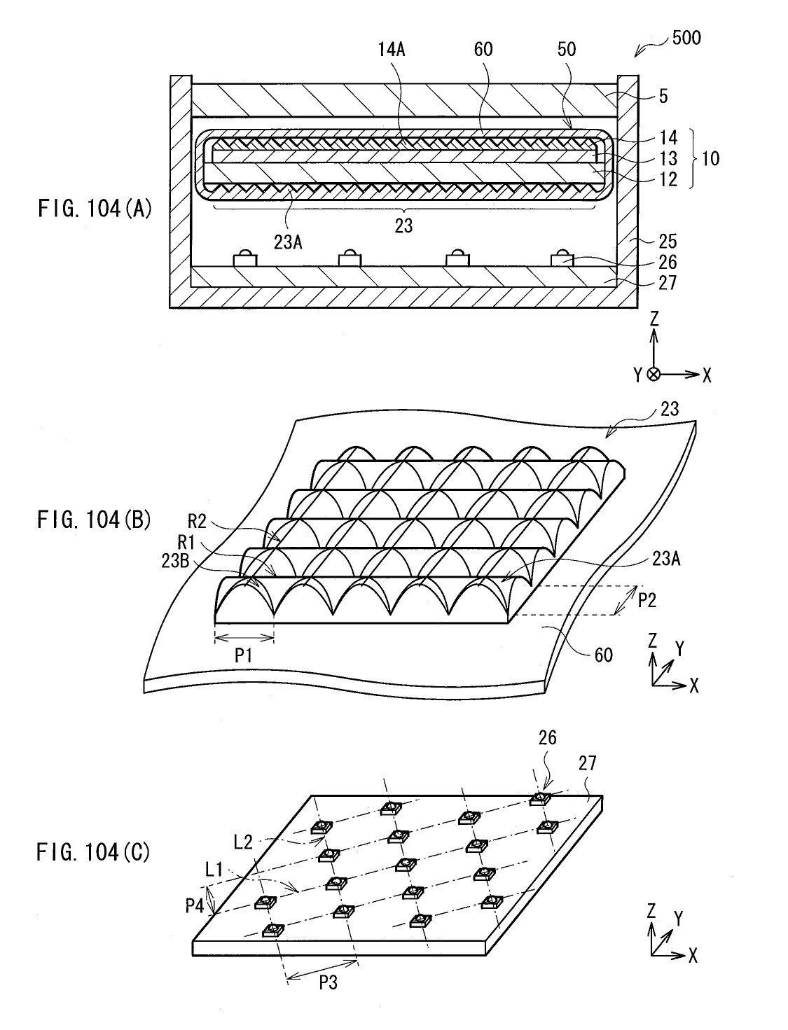

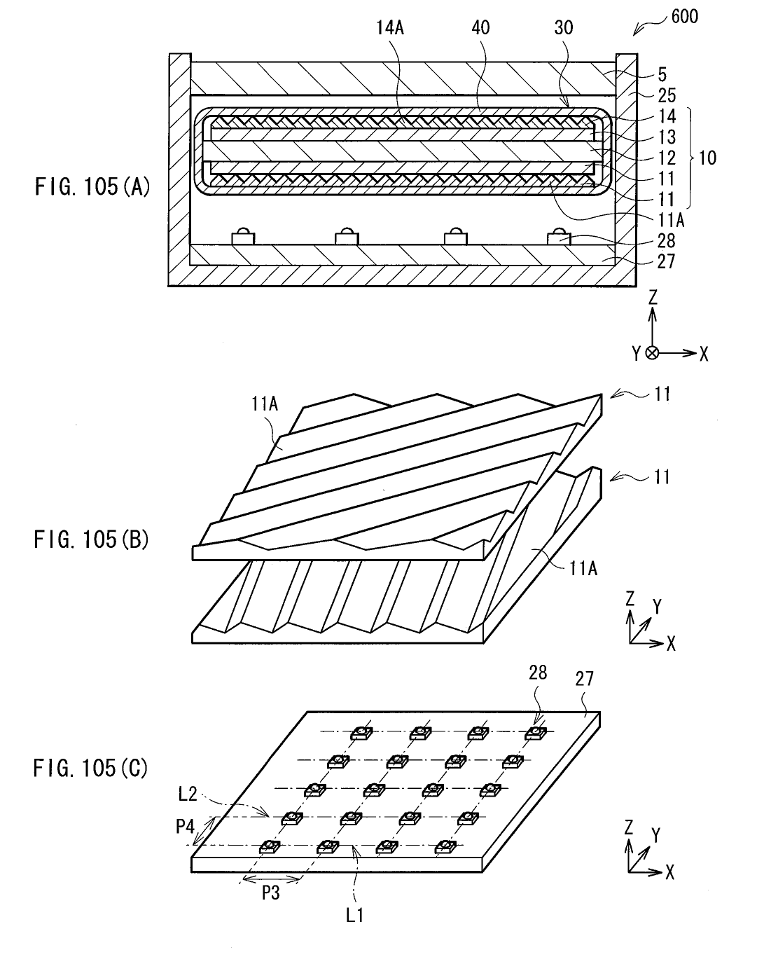

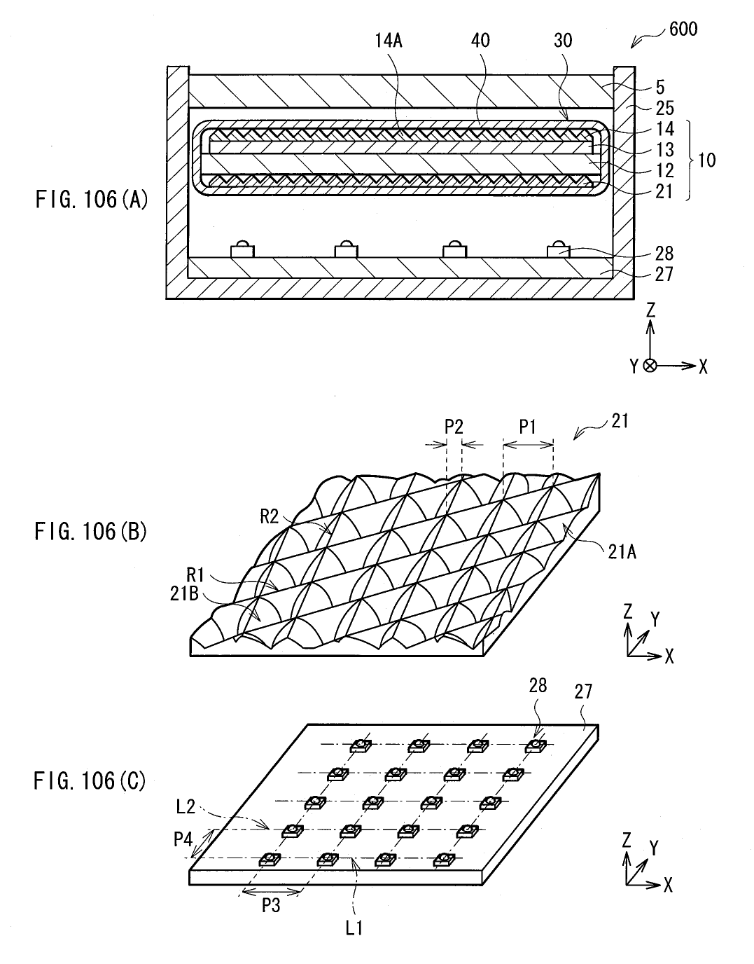

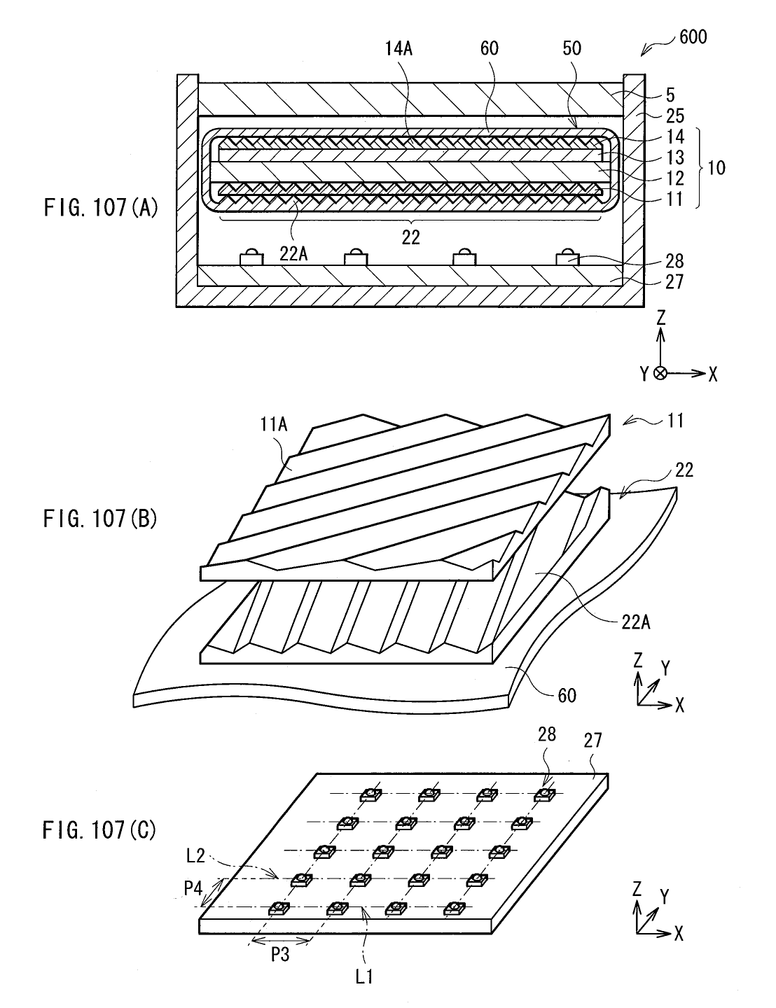

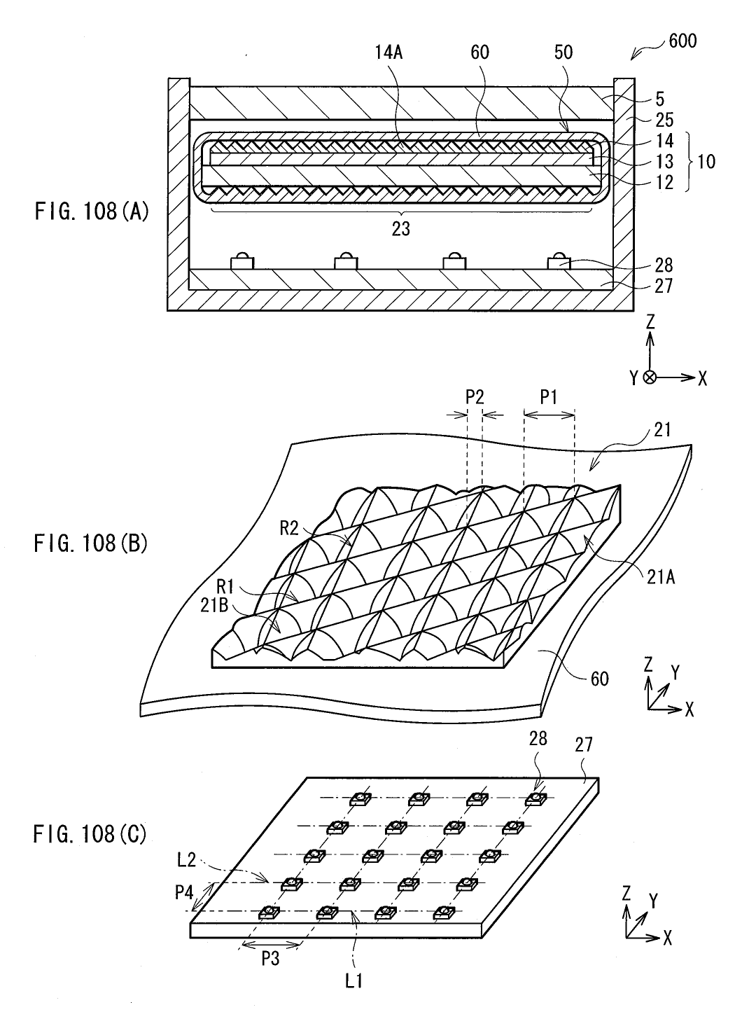

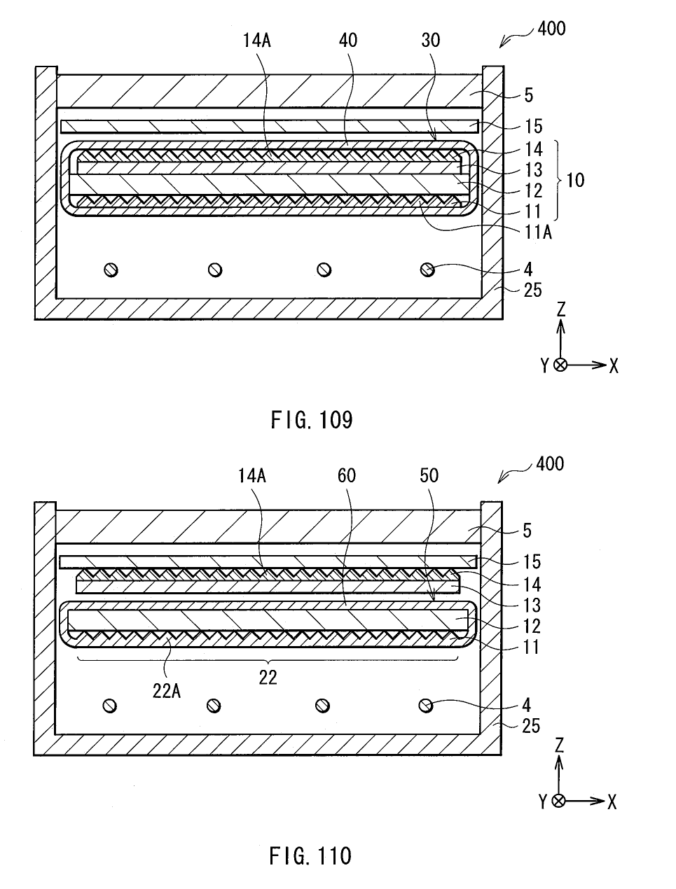

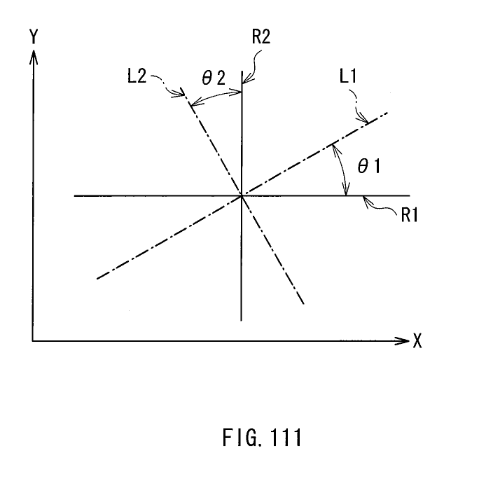

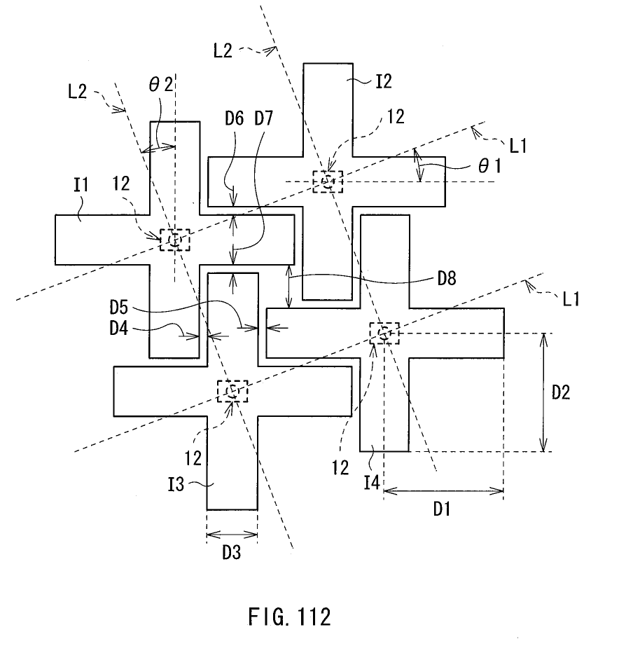

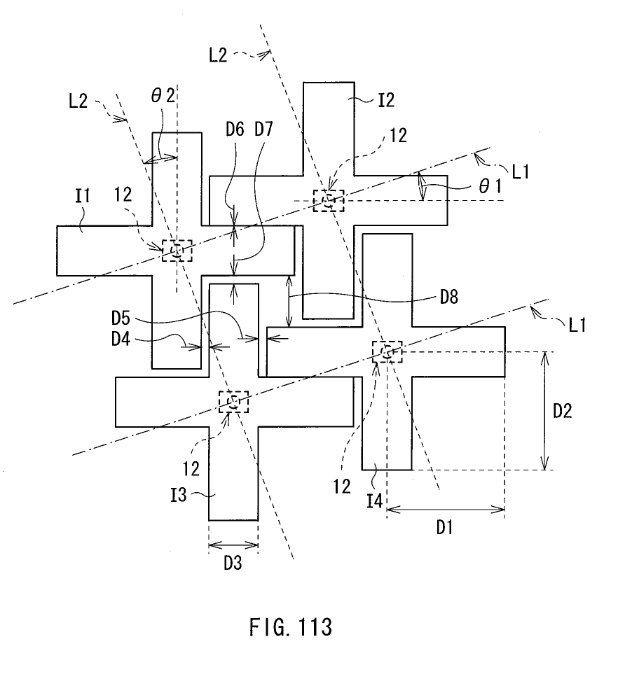

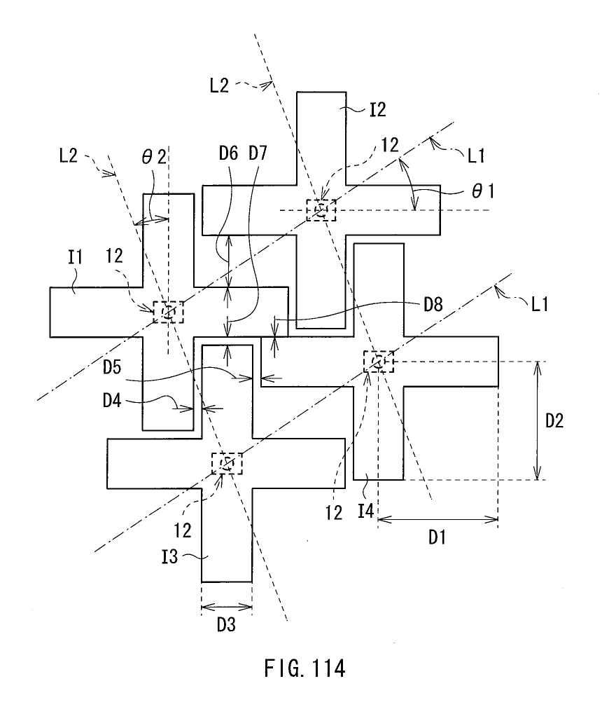

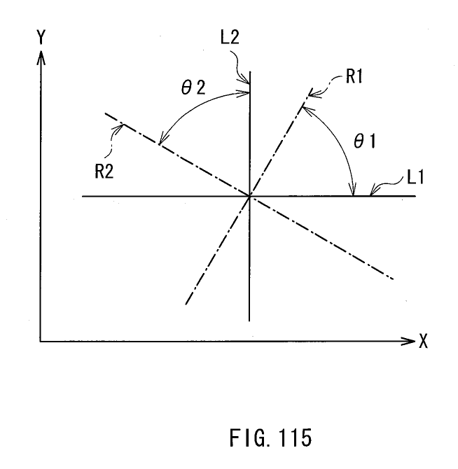

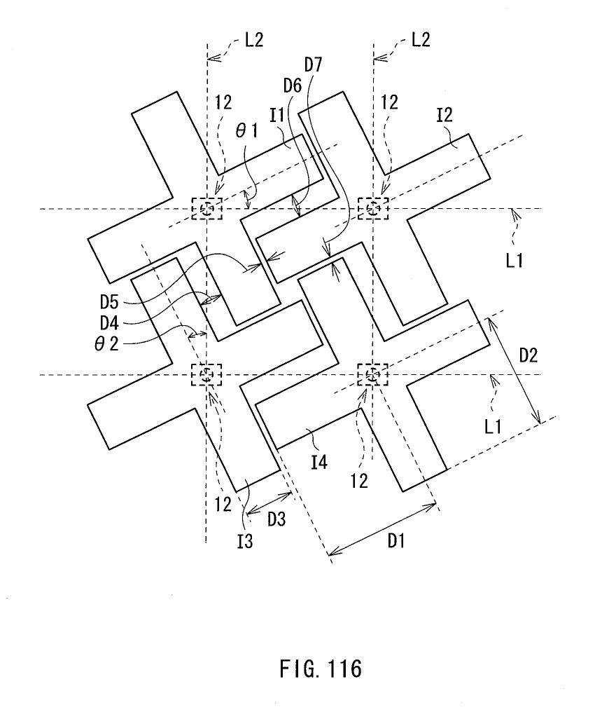

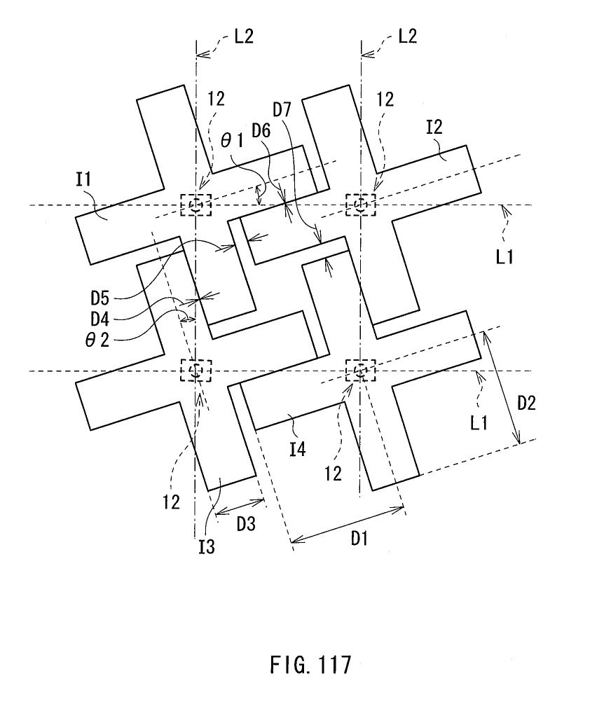

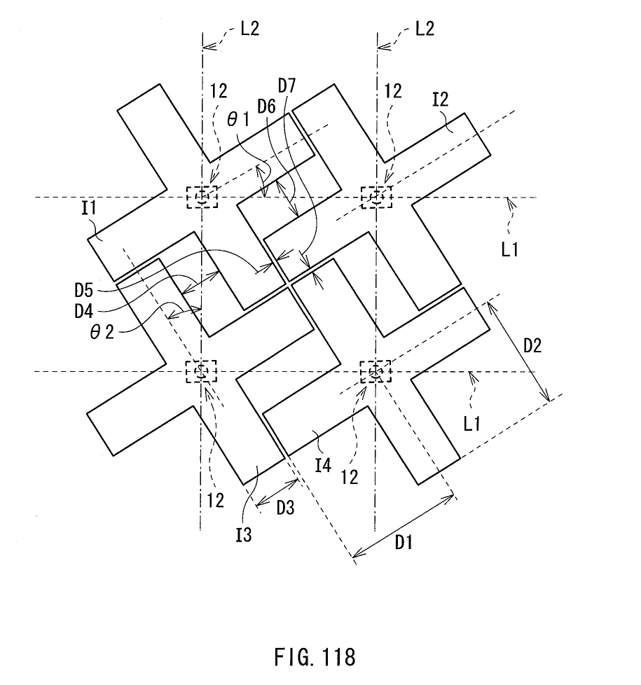

Further, for example, as shown in FIG. 26, the exposed portion 12A may be in the shape of a three dimensional figure in which the end portion where adjacent faces out of the top face 12B, the bottom face 12C, and the side face 12D are orthogonal to each other is cut off in a state of a convex face in a direction almost in parallel with the opposing direction of the top face 12B and the bottom face 12C. In this case, however, the side face having a convex curved shape that is formed by cutting off the end portion is caused to function as the supported portion 12H for positioning to the chassis that supports the optical sheet packaged body 2.

Further, for example, as shown in FIG. 27, the exposed portion 12A may be in the shape of a three dimensional figure in which the end portion where adjacent faces out of the top face 12B, the bottom face 12C, and the side face 12D are orthogonal to each other is cut off flatly in a direction almost in parallel with the opposing direction of the top face 12B and the bottom face 12C, and a notch extending in the direction almost in parallel with the opposing direction of the top face 12B and the bottom face 12C is provided in the side face having a planar shape at a given angle to the side face 12D that is formed by cutting off the end portion. In this case, however, the side face having a concave notch shape that is formed by cutting off the end portion and providing the notch is caused to function as the supported portion 121 for positioning to the chassis that supports the optical sheet packaged body 2.

Further, for example, as shown in FIG. 28, the exposed portion 12A may be in the shape of a three dimensional figure in which a notch extending in a direction almost in parallel with the opposing direction of the top face 12B and the bottom face 12C is provided in one side face 12D out of the end portion where adjacent faces of the top face 12B, the bottom face 12C, and the side face 12D are orthogonal to each other. In this case, however, the side face having a concave notch shape that is formed by notching the end portion is caused to function as the supported portion 12J for positioning to the chassis that supports the optical sheet packaged body 2.

Further, for example, as shown in FIG. 29, the exposed portion 12A may be in the shape of a three dimensional figure in which a cut groove extending in a direction almost in parallel with the opposing direction of the top face 12B and the bottom face 12C is provided in the side face 12D of the end portion where adjacent faces out of the top face 12B, the bottom face 12C, and the side face 12D are orthogonal to each other. In this case, however, the cut groove provided in the end portion is caused to function as the supported portion 12L for positioning to the chassis that supports the optical sheet packaged body 2.

Further, for example, as shown in FIG. 30, the exposed portion 12A may be in the shape of a three dimensional figure in which the end portion where adjacent faces out of the top face 12B, the bottom face 12C, and the side face 12D are orthogonal to each other is cut off flatly in a direction that crosses the opposing direction of the top face 12B and the bottom face 12C and that is obliquely headed from the central portion of the diffusion plate 12 to the end portion thereof. In this case, however, the side face having a planar shape at a blunt angle to the top face 12B that is formed by cutting off the end portion and providing a notch is caused to function as the supported portion 12M for positioning to the chassis that supports the optical sheet packaged body 2.

Further, for example, as shown in FIG. 31, the exposed portion 12A may be in the shape of a three dimensional figure in which the end portion where adjacent faces out of the top face 12B, the bottom face 12C, and the side face 12D are orthogonal to each other is cut off flatly in a direction that crosses the opposing direction of the top face 12B and the bottom face 12C and that is obliquely headed from the end portion of the diffusion plate 12 to the central portion thereof. In this case, however, the side face having a planar shape at a blunt angle to the bottom face 12C that is formed by cutting off the end portion and providing a notch is caused to function as the supported portion 12N for positioning to the chassis that supports the optical sheet packaged body 2.

Further, for example, as shown in FIG. 32, the exposed portion 12A may be in the shape of a three dimensional figure in which a notch extending in a direction almost orthogonal to the opposing direction of the top face 12B and the bottom face 12C is provided in one side face 12D out of the end portion where adjacent faces out of the top face 12B, the bottom face 12C, and the side face 12D are orthogonal to each other. In this case, however, the notch provided in the end portion is caused to function as the supported portion 12P for positioning to the chassis that supports the optical sheet packaged body 2.

Further, for example, as shown in FIG. 33, the exposed portion 12A may be in the shape of a three dimensional figure in which the end portion where adjacent faces out of the top face 12B, the bottom face 12C, and the side face 12D are orthogonal to each other is projected outward than the side face of the laminated body 10. In this case, however, the side face 12D adjacent to the flexible film 20 of the side faces 12D of the end portion is caused to function as the supported portion 12E for positioning to the chassis that supports the optical sheet packaged body 2.

By the way, FIG. 22 shows a case where the openings 20B are provided in the four corners of the diffusion plate 12 as an example. However, the openings 20B are not necessarily provided in the four corners. For example, as shown in FIG. 34, the openings 20B may be provided only in the two corners on the lower side of the diffusion plate 12. On the contrary, for example, as shown in FIG. 35, the openings 20B may be provided only in the two corners on the upper side of the diffusion plate 12. Further, as shown in FIG. 36, the openings 20B may be provided only in the two corners diagonally opposite each other of the diffusion plate 12.

Further, it is not necessary that each exposed portion 12A of the diffusion plate 12 functions as a supported portion. It is enough that at least two of each exposed portion 12A of the diffusion plate 12 function as a supported portion, or one of each exposed portions 12A of the diffusion plate 12 has at least two supported portions in the exposed portion. That is, it is enough that each supported portion is structured so that in supporting the diffusion plate 12 by the chassis, movement in one in-plane direction of the diffusion plate 12 (for example, long side direction) is suppressed by one supported portion, and movement in a direction crossing the one in-plane direction of the diffusion plate 12 (for example, short side direction) is suppressed by two supported portions (the foregoing supported portion may be included).

For example, as shown in FIG. 37, it is possible that the side face 12D on the lower side of one of the exposed portions 12A provided in the two corners on the lower side of the diffusion plate 12 functions as the supported portion 12E, a cut groove is provided in the side face 12D on the lower side of the other exposed portion, and the cut groove functions as the supported portion 12L. Further, for example, as shown in FIG. 38, it is possible that a cut groove is provided in the side face in the horizontal direction of one of the exposed portions 12A provided in two corners on the upper side of the diffusion plate 12, the cut groove functions as the supported portion 12L, cut grooves are respectively provided in the both side faces in the horizontal direction and in the vertical direction of the other exposed portion, and these two cut grooves respectively function as the supported portion 12L.

In addition, in the foregoing respective examples, the exposed portion 12A is provided only in a corner of the diffusion plate 12. However, the exposed portion 12A may be provided in one side (outer edge) including two corners of the diffusion plate 12. For example, though not shown, it is possible that the exposed portion 12A is provided on the side (outer edge) on the lower side including the two corners on the lower side of the diffusion plate 12, the side face 12D on the lower side of one corner of the exposed portions 12A functions as the supported portion 12E, a cut groove is provided in the side face 12D on the lower side of the other corner, and the cut groove functions as the supported portion 12L.

In the optical sheet packaged body 2 in this embodiment, the flexible film 20 wraps around each optical sheet such as the light source image segmentation sheet 11, the diffusion plate 12, the diffusion sheet 13, and the luminance enhancement film 14, and has one or the plurality of openings 20B to expose at least part of the outer edge (side face) of the diffusion plate 12. Further, the shape for positioning to the chassis that supports the optical sheet packaged body 2 is provided in the exposed portion 12A that is exposed from at least one opening 20B of the diffusion plate 12. Thereby, in positioning the laminated body 10 to the chassis, it is possible that only the diffusion plate 12 of the laminated body 10 is supported by the chassis and each optical sheet is supported by the flexible film 20. As a result, each optical sheet in the laminated body 10 is able to be individually stretched and shrunk to the lamination in-plane direction. Accordingly, it is possible to eliminate generation of wrinkles.

### Third Embodiment

FIG. 39 shows an example of a top face structure of an optical sheet packaged body 3 according to a third embodiment. The optical sheet packaged body 3 is arranged, for example, between the liquid crystal display panel and the light source as in the foregoing embodiments, and is suitably used to improve the optical characteristics of the light source. FIG. 40 shows an enlarged end portion of the optical sheet packaged body 3 of FIG. 39. The optical sheet packaged body 3 of FIG. 39 has a cross sectional structure similar to the cross sectional structure of FIG. 2.

The optical sheet packaged body 3 includes the laminated body 10 and the flexible film 20 as shown in FIG. 2. In addition, a description for structures, operations, and effects similar to those of the foregoing embodiments will be omitted as appropriate, and a description will be hereinafter mainly given of the differences from the foregoing embodiments.

As shown in FIG. 40, the flexible film 20 in this embodiment has one or a plurality of openings 20C to expose at least part of the outer edge of the diffusion plate 12. In addition, FIG. 39 and FIG. 40 show a case where the opening 20C is provided in the middle of one side (outer edge) of the diffusion plate 12 (central portion of the bottom side of the diffusion plate 12) as an example. In this embodiment, a description will be hereinafter given of the flexible film 20 and the diffusion plate 12 under the condition that the opening 20C is provided at least in the middle of one side of the diffusion plate 12.

As shown in FIG. 40, the top face 12B, the bottom face 12C, and the side face 12D of the diffusion plate 12 is respectively exposed (projected) partly from the opening 20C. A portion exposed from the opening 20C (exposed portion 12A) is in the shape of a three-dimensional figure (in a state of a convex rectangle) in which adjacent faces out of the top face 12B, the bottom face 12C, and the side face 12D are orthogonal to each other.

In this case, part of the portion exposed from the opening 20C (exposed portion 12A) functions as a supported portion 12Q for positioning to the chassis that supports the optical sheet packaged body 3. For example, the top face 12B and the bottom face 12C function as the supported portion 12Q, or the side face 12D functions as the supported portion 12Q depending on the shape of the chassis.

In addition, the exposed portion 12A is not necessarily in the shape of a three dimensional figure as shown in FIG. 40. For example, as shown in FIG. 41, the exposed portion 12A may be in the shape of a three dimensional figure in which one side of the diffusion plate 12 is cut off in a shape of a concave face in a direction almost in parallel with the opposing direction of the top face 12B and the bottom face 12C. In this case, however, the side face having a concave curved shape provided in one side of the diffusion plate 12 is caused to function as a supported portion 12R for positioning to the chassis that supports the optical sheet packaged body 3.

Further, for example, as shown in FIG. 42, the exposed portion 12A may be in the shape of a three dimensional figure in which one side of the diffusion plate 12 is cut off in a shape of a triangle pole in a direction almost in parallel with the opposing direction of the top face 12B and the bottom face 12C. In this case, however, the side face having a triangle pole-like curved shape provided in one side of the diffusion plate 12 is caused to function as a supported portion 12S for positioning to the chassis that supports the optical sheet packaged body 3.

Further, for example, as shown in FIG. 43, the exposed portion 12A may be in the shape of a three dimensional figure in which a cut groove extending in a direction almost in parallel with the opposing direction of the top face 12B and the bottom face 12C is provided in the side face 12D of one side of the diffusion plate 12. In this case, however, the cut groove provided in one side of the diffusion plate 12 is caused to function as a supported portion 12T for positioning to the chassis that supports the optical sheet packaged body 3.

Further, for example, as shown in FIG. 44, the exposed portion 12A may be in the shape of a three dimensional figure (fit shape) in which a cut groove extending in a direction almost in parallel with the opposing direction of the top face 12B and the bottom face 12C is provided in the side face 12D of one side of the diffusion plate 12 and a convex shape to narrow the entrance of the cut groove is provided in the vicinity of the entrance. In this case, however, the recessed shape provided in one side of the diffusion plate 12 is caused to function as a supported portion 12U for positioning to the chassis that supports the optical sheet packaged body 3.

Further, for example, as shown in FIG. 45, the exposed portion 12A may be in the shape of a trapezoidal three dimensional figure in which one side of the diffusion plate 12 is projected from the opening 20C and the top of the projected portion is widened more than the root portion of the projected portion. In this case, however, the trapezoidal three dimensional figure is caused to function as a supported portion 12V for positioning to the chassis that supports the optical sheet packaged body 3.

In the optical sheet packaged body 3 in this embodiment, the flexible film 20 wraps around each optical sheet such as the light source image segmentation sheet 11, the diffusion plate 12, the diffusion sheet 13, and the luminance enhancement film 14, and the flexible film 20 has one or the plurality of openings 20C letting at least the middle portion of one side (outer edge) of the diffusion plate 12 expose. Further, the shape for positioning to the chassis that supports the optical sheet packaged body 3 is provided in the exposed portion 12A that is exposed from at least one opening 20C of the diffusion plate 12. Thereby, in positioning the laminated body 10 to the chassis, it is possible that only the diffusion plate 12 of the laminated body 10 is supported by the chassis and each optical sheet is supported by the flexible film 20. As a result, each optical sheet in the laminated body 10 is able to be individually stretched and shrunk to the lamination in-plane direction. Accordingly, it is possible to eliminate generation of wrinkles.

### Fourth Embodiment

FIG. 46 shows an example of a cross sectional configuration of a display unit 100 according to a fourth embodiment. The display unit 100 includes a liquid crystal display panel 5, a light source 4 arranged behind the liquid crystal display panel 5, and the optical sheet packaged body 1, 2, or 3 arranged between the liquid crystal display panel 5 and the light source 4. The front face of the liquid crystal display panel 5 is oriented to an viewer (not shown) side. In addition, in this embodiment, for the purpose of convenience, the liquid crystal display panel 5 is arranged so that the front face thereof is orthogonal to the horizontal plane.

Though not shown, the liquid crystal display panel 5 has a lamination structure having a liquid crystal layer between a transparent substrate on the viewer side and a transparent substrate on the light source 4 side. Specifically, the liquid crystal display panel 5 has a polarization plate, the transparent substrate, a color filter, a transparent electrode, an alignment film, the liquid crystal layer, an alignment film, a transparent pixel electrode, the transparent substrate, and a polarization plate in order from the viewer side.

The polarization plate is a kind of an optical shutter, and transmits only light (polarized light) in a certain oscillation direction. These polarization plates are respectively arranged so that each polarizing axis is shifted from each other by 90 degrees. Thereby, light emitted from the light source 4 is transmitted through the liquid crystal layer or blocked. The transparent substrate is composed of a substrate transparent to visible light such as a plate glass. In addition, in the transparent substrate on the light source 4 side, an active driving circuit including a TFT (Thin Film Transistor) as a driving device electrically connected to the transparent pixel electrode, wiring and the like is formed. In the color filter, for example, color filters for providing color separation into three primary colors of red (R), green (G), and blue (B) for the light emitted from the light source 4 are arranged. The transparent electrode is made of, for example, ITO (Indium Tin Oxide), and functions as a common counter electrode. The alignment film is made of, for example, a polymer material such as polyimide, and provides alignment for the liquid crystal. The liquid crystal layer is formed of, for example, a liquid crystal in VA (Vertical Alignment) mode, TN (Twisted Nematic) mode, or STN (Super Twisted Nematic) mode, and has a function to transmit or block the light emitted from the light source 4 for every pixel by a voltage applied from the driving circuit. The transparent pixel electrode is made of, for example, ITO, and functions as an electrode for every pixel.

In the light source 4, for example, a plurality of linear light sources are arranged in parallel at equal intervals (for example, at the intervals of 20 μm). The linear light source is typically a cold cathode fluorescent lamp called CCFL, but may be a light source in which point light sources such as Light Emitting Diode (LED) are linearly arranged. Each linear light source extends and is arranged, for example, in the horizontal direction.

Further, the display unit 100 includes a bottom chassis 6, a middle chassis 7 and a top chassis 8 that are arranged on the bottom chassis 6.

The bottom chassis 6 supports the light source 4 and the optical sheet packaged body 1, 2, or 3 from the side face and the rear face (face on the opposite side of a viewer). The bottom chassis 6 has a beam supporting the optical sheet packaged body 1, 2, or 3 from the rear face. The beam has a circular shape having an opening in a region opposed to a portion other than the outer edge portion of the optical sheet packaged body 1, 2, or 3. Further, the bottom chassis 6 has side walls arranged with a given distance apart from the side face of the optical sheet packaged body 1, 2, or 3. On the side wall, after-mentioned various supporting portions are provided. The supporting portion supports the optical sheet packaged body 1, 2, or 3 in the vertical direction and the horizontal direction (in some cases, in the lamination direction additionally).

Further, on the inner wall (in particular, the rear face) of the bottom chassis 6, a not-shown reflecting sheet is provided. The reflecting sheet reflects light from the light source 4 toward the optical sheet packaged body 1, 2, or 3 side.

The middle chassis 7 supports the optical sheet packaged body 1, 2, or 3 supported by the bottom chassis 6 from the front side (viewer side). The middle chassis 7 is a frame having a circular beam having an opening in a region opposed to a portion other than the outer edge portion of the optical sheet packaged body 1, 2, or 3. The rear face side of the beam (face on the other side of the viewer side) supports the optical sheet packaged body 1, 2, or 3, and the front side of the beam (viewer side) supports the liquid crystal display panel 5. Further, the middle chassis 7 has circular side walls that extends from the edge of the beam to the rear face side (face on the other side of the viewer side) and to the front side (viewer side). The portion extending to the front side of the side walls is contacted with the side face of the liquid crystal display panel 5. The portion extending to the rear face side of the side walls is connected to the outer wall of the bottom chassis 6.

The top chassis 8 supports the liquid crystal display panel 5 supported by the middle chassis 7 from the front side (viewer side). The top chassis 8 is a frame having a circular beam having an opening in a region opposed to a portion other than the outer edge portion of the liquid crystal display panel 5. The rear face side of the beam (face on the other side of the viewer side) supports the liquid crystal display panel 5. Further, the top chassis 8 has a circular side walls that extend from the edge of the beam to the rear face side (face on the other side of the viewer side). The side wall is connected to the side wall of the middle chassis 7.

The optical sheet packaged body 1, 2, or 3 is supported by the side wall of the middle chassis 7 in the exposed portion 12A of the diffusion plate 12. In the case where the top face 12B, the bottom face 12C, and the side face 12D of the diffusion plate 12 included in the optical sheet packaged body 1 are respectively exposed partly from the opening 20A in the end portion of the diffusion plate 12, for example, as shown in FIG. 47, when the top face 12B of the portion exposed from the opening 20A (exposed portion 12A) is supported by a supporting portion 7A extending from the beam of the middle chassis 7, and the bottom face 12C of the exposed portion 12A is supported by a supporting portion 6A extending from the beam of the middle chassis 6, movement in the lamination direction of the portion sandwiched between the supporting portion 6A and the supporting portion 7A in the exposed portion 12A is limited. In addition, in the case where the magnitude of pressure applied by the supporting portions 6A and 7A to the diffusion plate 12 is large, movement in the in-plane direction (horizontal direction and vertical direction) is limited in addition to the movement in the lamination direction.

Further, for example, as shown in FIG. 48, when the side face 12D in the vertical direction of the exposed portion 12A is supported by a supporting portion 6B extending from the side wall of the bottom chassis 6, in the exposed portion 12A, movement in the in-plane direction (vertical direction) is limited by the supporting portion 6B.

Further, for example, as shown in FIG. 49, when the supported portion 12F of the exposed portion 12A is supported by a spring-like supporting portion 6C provided on the side wall of the bottom chassis 6, in the exposed portion 12A, movement in the in-plane direction (horizontal direction and vertical direction) is limited by the supporting portion 6C.

Further, for example, as shown in FIG. 50, when the supported portion 12F of the exposed portion 12A is supported by a columnar pin (supporting portion 6D) extending from the rear face of the bottom chassis 6, in the exposed portion 12A, movement in the in-plane direction (horizontal direction and vertical direction) is limited by the supporting portion 6D.

Furthermore, for example, as shown in FIG. 51, when the supported portion 12F of the exposed portion 12A is supported by an arcuate elastic body (supporting portion 6E) that is provided on the side wall of the bottom chassis 6 and is arranged with the convex side directed to the supported portion 12F, in the exposed portion 12A, movement in the in-plane direction (horizontal direction and vertical direction) is limited by the supporting portion 6E.

Furthermore, for example, as shown in FIG. 52, when the supported portion 12F of the exposed portion 12A is supported by a columnar pin (supporting portion 6F) extending from the side wall of the bottom chassis 6, in the exposed portion 12A, movement in the in-plane direction (horizontal direction and vertical direction) is limited by the supporting portion 6F.

Further, for example, as shown in FIG. 53, when the supported portion 12F of the exposed portion 12A is supported by a supporting portion 6G made of low-repulsion urethane or the like provided on the side wall of the bottom chassis 6, in the exposed portion 12A, movement in the in-plane direction (horizontal direction and vertical direction) is limited by the supporting portion 6G.

Further, for example, as shown in FIG. 54, when the supported portion 12C of the exposed portion 12A is supported by a columnar pin (supporting portion 6H) extending from the bottom face of the bottom chassis 6, in the exposed portion 12A, movement in the in-plane direction (horizontal direction and vertical direction) is limited by the supporting portion 6H.

Further, for example, as shown in FIG. 55, when the supported portion 12H of the exposed portion 12A is supported by an arcuate elastic body (supporting portion 6I) that is provided on the side wall of the bottom chassis 6 and is arranged with the concave side directed to the supported portion 12H, in the exposed portion 12A, movement in the in-plane direction (horizontal direction and vertical direction) is limited by the supporting portion 6I.

Further, for example, as shown in FIG. 56, when the supported portion 121 of the exposed portion 12A is supported by a columnar pin (supporting portion 6J) provided on the side wall of the bottom chassis 6, in the exposed portion 12A, movement in the in-plane direction (horizontal direction and vertical direction) is limited by the supporting portion 6J.

Further, for example, as shown in FIG. 57, when the supported portion 12J of the exposed portion 12A is supported by a spring-like clinch pin (supporting portion 6K) provided on the side wall of the bottom chassis 6, in the exposed portion 12A, movement in the in-plane direction (horizontal direction and vertical direction) is limited by the supporting portion 6K.

Further, for example, as shown in FIG. 58, when the supported portion 12K of the exposed portion 12A is supported by a columnar pin (supporting portion 6L) that extends from the bottom face of the bottom chassis 6 and that has almost the same cross sectional shape and almost the same size thereof as the cross sectional shape and the size thereof of the supported portion 12K, in the exposed portion 12A, movement in the in-plane direction (horizontal direction and vertical direction) is limited by the supporting portion 6L. Meanwhile, in the case where a clearance is provided in the horizontal direction between the supporting portion 6L and the supported portion 12K, movement in the in-plane direction (horizontal direction) is limited by the supporting portion 6L.

Further, for example, as shown in FIG. 59, when the supported portion 12L of the exposed portion 12A is supported by a columnar pin (supporting portion 6M) extending from the bottom face of the bottom chassis 6, in the exposed portion 12A, movement in the in-plane direction (one of the horizontal direction and the vertical direction (vertical direction in FIG. 59)) is limited by the supporting portion 6M.

Further, for example, as shown in FIGS. 60(A) and 60(B), when the supported portion 12M of the exposed portion 12A is supported by a supporting portion 6N provided on the bottom face of the bottom chassis 6, in the exposed portion 12A, movement in the lamination direction is also limited in addition to movement in the in-plane direction (horizontal direction and vertical direction) by the supporting portion 6N. In addition, as shown in FIG. 60(B), the supporting portion 6N has a trapezoidal member 6N1 having a tilted face opposed to the supported portion 12M, a joining portion 6N2 that is joined with a region other than the tilted face of the member 6N1, and an adjustment portion 6N3 for adjusting the position of the member 6N1 with the joining portion 6N2 in between.

Further, for example, as shown in FIGS. 61(A) and 61(B), when the supported portion 12N of the exposed portion 12A is supported by a supporting portion 6P provided on the bottom face of the bottom chassis 6, in the exposed portion 12A, movement in the lamination direction is also limited in addition to movement in the in-plane direction (horizontal direction and vertical direction) by the supporting portion 6P. In addition, as shown in FIG. 61(B), the supporting portion 6P has a trapezoidal member 6P1 having a tilted face opposed to the supported portion 12N, a joining portion 6P2 that is joined with a region other than the tilted face of the member 6P1, and an adjustment portion 6P3 for adjusting the position of the member 6P1 with the joining portion 6P2 in between.

Further, for example, as shown in FIGS. 62(A) and 62(B), when the supported portion 12P of the exposed portion 12A is supported by a columnar pin (supporting portion 6Q) provided on the side face of the bottom chassis 6, in the exposed portion 12A, movement in the lamination direction is also limited in addition to the in-plane directions (one of the horizontal direction and the vertical direction (in FIGS. 62(A) and 62(B), vertical direction)) by the supporting portion 6Q.

Further, for example, as shown in FIG. 63, when the supported portion 12E (side face 12D on the lower side in the vertical direction) of the exposed portion 12A is supported by a columnar pin (supporting portion 6R) extending from the bottom face of the bottom chassis 6, in the exposed portion 12A, movement in the in-plane direction (vertical direction) is limited by the supporting portion 6R.

Further, for example, as shown in FIG. 64, in addition to the structure of FIG. 63, when the supported portion 12E (side face 12D on the upper side in the vertical direction) of the exposed portion 12A is supported by a columnar pin (supporting portion 6S) extending from the side face of the bottom chassis 6, in the exposed portion 12A, movement in the in-plane direction (vertical direction) is limited by the supporting portion 6R, and movement in the in-plane direction (horizontal direction) is limited by the supporting portion 6S.

In addition, in the case where part (side face) of the diffusion plate 12 included in the optical sheet packaged body 2 is exposed from the opening 20B at the end portion of the diffusion plate 12, in the same manner as the case of the optical sheet packaged body 1, movement in the in-plane direction (horizontal direction and vertical direction) and movement in the lamination direction are limited by the supporting portion 6R.

Further, in the case where the diffusion plate 12 is exposed from the opening 20C in the middle (central portion of the bottom side of the diffusion plate 12) of one side (outer edge) of the diffusion plate 12 included in the optical sheet packaged body 3, when, for example, as shown in FIG. 65, the side face 12D of the portion exposed from the opening 20C (exposed portion 12A) is supported by the supporting portion 6B extending from the bottom face of the bottom chassis 6, movement in the in-plane direction (vertical direction) is limited in the exposed portion 12A.

Further, for example, as shown in FIG. 66, when the supported portion 12R of the exposed portion 12A is supported by the supporting portion 6S extending from the side face of the bottom chassis 6, in the exposed portion 12A, movement in the in-plane direction (vertical direction) is limited.

Further, for example, as shown in FIG. 67, when the supported portion 12S of the exposed portion 12A is supported by a supporting portion 6T extending from the side face of the bottom chassis 6, in the exposed portion 12A, movement in the in-plane direction (horizontal direction or vertical direction) is limited.

Further, for example, as shown in FIG. 68, when the supported portion 12T of the exposed portion 12A is supported by a supporting portion 6U extending from the side face of the bottom chassis 6, in the exposed portion 12A, movement in the in-plane direction (horizontal direction or vertical direction) is limited.

Further, for example, as shown in FIG. 69, when the supported portion 12U of the exposed portion 12A is supported by a supporting portion 6V extending from the side face of the bottom chassis 6, in the exposed portion 12A, movement in the in-plane direction (horizontal direction or vertical direction) is limited. In addition, in this case, the supporting portion 6V is not easily dropped from the supported portion 12U. Thus, it is possible to prevent the optical sheet packaged body 3 from being wrongly dropped off the bottom chassis 6.

Further, for example, as shown in FIG. 70, when the supported portion 12U of the exposed portion 12A is supported by a supporting portion 6W extending from the bottom face of the bottom chassis 6, in the exposed portion 12A, movement in the in-plane direction (horizontal direction or vertical direction) is limited. In addition, in this case, the supporting portion 6W is not easily dropped from the supported portion 12U as well. Thus, it is also possible to prevent the optical sheet packaged body 3 from being wrongly dropped off the bottom chassis 6.

Further, for example, as shown in FIG. 71, when the supported portion 12V of the exposed portion 12A is supported by a pair of supporting portions 6W extending from the side wall of the bottom chassis 6 from the both side faces in the horizontal direction, in the exposed portion 12A, movement in the in-plane direction (horizontal direction or vertical direction) is limited. In addition, in this case, the supported portion 12V is not easily dropped from the pair of supporting portions 6× as well. Thus, it is also possible to prevent the optical sheet packaged body 3 from being wrongly dropped off the bottom chassis 6.

Next, a description will be given of a basic operation in displaying an image in the display unit 100 of this embodiment.

Light emitted from each light source 4 directly enters the optical sheet packaged body 1 or is reflected by the reflecting sheet in the bottom chassis 6 and then enters the optical sheet packaged body 1. The incident light into the optical sheet packaged body 1 is segmented into minute light beams by the light source image segmentation sheet 11, and a light source image obtained by the segmentation is diffused by the diffusion plate 12 and the diffusion sheet 13. Thereby, the in-plane luminance distribution becomes uniform. The diffusion light having uniform luminance is collected by the luminance enhancement film 14, and the front luminance increases.

When the uniform light having high luminance passed through the optical sheet packaged body 1 as above enters the liquid crystal display panel 5, a polarization component crossing the polarizing axis of the polarization plate on the other side of a viewer is absorbed into the polarization plate, and a polarization component in parallel with the polarizing axis of the polarization plate passes through the polarization plate. The straight polarized light passed through the polarization plate enters each pixel electrode, is modulated in the liquid crystal layer according to a voltage applied between each pixel electrode and the opposed electrode, is further provided with color separation by the color filter, and enters the polarization plate on the viewer side. Among the light entered the polarization plate, a polarization component crossing the polarizing axis of the polarization plate is absorbed into the polarization plate, and a polarization component in parallel with the polarizing axis of the polarization plate passes through the polarization plate to form an image on the front face of the panel. Accordingly, the image is displayed in the display unit 100.

In this case, the flexible film 20 in the optical sheet packaged body 1 is a flexible optical sheet formed at least in the region through which light from the light source 4 passes of the surface of the laminated body 10. Thus, the flexible film 20 does not optically act on the incident light and does not disturb the luminance distribution of the incident light.

Further, in the display unit 100 of this embodiment, the flexible film 20 wraps around each optical sheet such as the light source image segmentation sheet 11, the diffusion plate 12, the diffusion sheet 13, and the luminance enhancement film 14, and has one or the plurality of openings 20A, 20B, or 20C to expose at least part of the outer edge of the diffusion plate 12. Further, the shape for positioning to the chassis (the bottom chassis 6 and the middle chassis 7) that supports the optical sheet packaged body 1, 2, or 3 is provided in the exposed portion 12A that is exposed from at least one opening 20A, 20B, or 20C of the diffusion plate 12. Thereby, in positioning the laminated body 10 to the chassis, it is possible that only the diffusion plate 12 of the laminated body 10 is supported by the chassis and each optical sheet is supported by the flexible film 20. As a result, each optical sheet in the laminated body 10 is able to be individually stretched and shrunk to the lamination in-plane direction. Accordingly, it is possible to eliminate generation of wrinkles.

### Fifth Embodiment

FIG. 72 shows an example of a cross sectional configuration of a display unit 200 according to a fifth embodiment. The display unit 200 includes the liquid crystal display panel 5, the light source 4 arranged behind the liquid crystal display panel 5, and the optical sheet packaged body 1, 2, or 3 arranged between the liquid crystal display panel 5 and the light source 4 as in the fourth embodiment. However, the display unit 200 differs from the fourth embodiment in that the display unit 200 includes the bottom chassis 6 as an integrated structure of the bottom chassis 6 and the middle chassis 7 in the fourth embodiment. Consequently, a description for configuration, operations, and effects common to those of the fourth embodiment will be omitted as appropriate, and a description will be hereinafter given in detail of the differences from the fourth embodiment.

The bottom chassis 6 in this embodiment supports the light source 4, the optical sheet packaged body 1, 2, or 3, and the liquid crystal display panel 5. The bottom chassis 6 has a beam supporting the optical sheet packaged body 1, 2, or 3 from the rear face (face on the opposite side of a viewer), and a beam supporting the optical sheet packaged body 1, 2, or 3 from the front face (face on the viewer side). These beams have a circular shape having an opening in a region opposed to a portion other than the outer edge portion of the optical sheet packaged body 1, 2, or 3. Further, the bottom chassis 6 has a side wall arranged with a given distance apart from the side face of the optical sheet packaged body 1, 2, or 3. On the side wall, after-mentioned various supporting portions are provided. The supporting portion supports the optical sheet packaged body 1, 2, or 3 in the vertical direction and the horizontal direction (in some cases, in the lamination direction additionally).

Further, on the side wall, a cover 60 is provided. The cover 60 is removable in a portion opposed to one side face or adjacent two side faces of the optical sheet packaged body 1, 2, or 3 with the cover 60 removed, the optical sheet packaged body 1, 2, or 3 is able to be inserted (slot in) through the portion where the cover 60 is removed (side face of the bottom chassis 6).

For example, in the case where the cover 60 is provided on the vertical top face side of the bottom chassis 6, the optical sheet packaged body 1, 2, or 3 is able to be inserted from the vertical top face side of the bottom chassis 6 as shown in FIG. 73, FIG. 74, and FIG. 75. Further, for example, in the case where the cover 60 is provided on the vertical bottom face side of the bottom chassis 6, the optical sheet packaged body 1, 2, or 3 is able to be inserted from the vertical bottom face side of the bottom chassis 6 as shown in FIG. 76, FIG. 77, FIG. 78, and FIG. 79.

Next, a description will be given of an example of a structure of the diffusion plate 12 suitable for inserting the optical sheet packaged body 1, 2, or 3 into a slot.

In the case where the optical sheet packaged body 1 in which the opening 20A is provided in at least a corner of the diffusion plate 12 is inserted from the vertical top face, for example as shown in FIG. 73, it is possible that while each supported portion 12J is respectively provided in each exposed portion 12A provided in the two corners on the upper side of the diffusion plate 12, each supported portion 12K is respectively provided in each exposed portion 12A provided in the two corners on the lower side of the diffusion plate 12, and while the supporting portion 6K is provided correspondingly to the supported portion 12J on the upper side of the side wall of the bottom chassis 6, the supporting portion 6L is provided correspondingly to the supported portion 12K on the lower side of the bottom face of the bottom chassis 6.

Further, for example, as shown in FIG. 74, it is possible that while each supported portion 12J is respectively provided in each exposed portion 12A provided in the two corners on the upper side of the diffusion plate 12, each supported portion 12L is respectively provided in each side face in the horizontal direction of the exposed portion 12A provided in the two corners on the lower side of the diffusion plate 12, and while the supporting portion 6K is provided correspondingly to the supported portion 12J on the upper side of the side wall of the bottom chassis 6, the supporting portion 6M is provided correspondingly to the supported portion 12L on the lower side of the bottom face of the bottom chassis 6.

Further, for example, as shown in FIG. 75, it is possible that each supported portion 12J is respectively provided in each exposed portion 12A provided in the four corners of the diffusion plate 12, and the supporting portion 6K is provided correspondingly to the supported portion 12J on the upper side and the lower side of the side wall of the bottom chassis 6.

Next, in the case where the optical sheet packaged body 1 in which the opening 20A is provided in at least a corner of the diffusion plate 12 is inserted from the vertical lower face into a slot, for example as shown in FIG. 76, it is possible that while the supported portion 12L is provided in the side face in the vertical direction of the exposed portion 12A provided in one corner on the upper side of the diffusion plate 12, the supported portion 12K is provided adjacently thereto, the supported portion 12K is provided in the exposed portion 12A provided in the other corner on the upper side of the diffusion plate 12, each supported portion 12E is respectively provided on the side face in the vertical direction of each exposed portion 12A provided in the two corners on the lower side of the diffusion plate 12, the supporting portion 6L is provided correspondingly to the supported portion 12K on the upper side of the bottom face of the bottom chassis 6, a convex-shaped guide portion 6Y is provided correspondingly to the supported portion 12L on the upper side of the side wall of the bottom chassis 6, and a convex-shaped supporting portion (not shown) is provided correspondingly to the supported portion 12K on the cover 60 of the bottom chassis 6.

Further, for example, as shown in FIG. 77, it is possible that each supported portion 12L is respectively provided in the both side faces in the vertical direction and the horizontal direction of the exposed portion 12A provided in one corner on the upper side of the diffusion plate 12, the supported portion 12K composed of a hole having a cross section extending in the horizontal direction is provided in the exposed portion 12A provided in the other corner on the upper side of the diffusion plate 12, each supported portion 12E is respectively provided on the side face in the vertical direction of each exposed portion 12A provided in the two corners on the lower side of the diffusion plate 12, while the supporting portion 6L is provided correspondingly to the supported portion 12L provided in the side face in the horizontal direction of the exposed portion 12A, the supporting portion 6L is provided correspondingly to the supported portion 12K on the upper side of the bottom chassis 6, a supporting portion 6Y is provided correspondingly to the supported portion 12L provided in the side face in the vertical direction of the exposed portion 12A on the upper side of the side wall of the bottom chassis 6, and a convex-shaped supporting portion (not shown) is provided correspondingly to the supported portion 12K on the cover 60 of the bottom chassis 6.

Further, for example, as shown in FIG. 78, in the case where the two exposed portions 12A on the upper side of the diffusion plate 12 are in the shape of a three-dimensional figure in which the end portion where adjacent faces out of the top face 12B, the bottom face 12C, and the side face 12D are orthogonal to each other is projected outward than the side face of the laminated body 10, it is possible that while the supported portion 12L is provided in the upper side face in the vertical direction of the exposed portion 12A provided in one corner on the upper side of the diffusion plate 12, the supported portion 12E is provided in the lower side face in the vertical direction of the exposed portion 12A, each supported portion 12E is respectively provided in the side face in the vertical direction of each exposed portion 12A in the two corners on the lower side of the diffusion plate 12, while the supporting portion 6R is provided correspondingly to the supported portion 12E on the upper side of the bottom face of the bottom chassis 6, the supporting portion 6Y is provided correspondingly to the supported portion 12L, and a convex-shaped supporting portion (not shown) is provided correspondingly to the supported portion 12K on the cover 60 of the bottom chassis 6.

Further, in the case where the exposed portions 12A in the four corners of the diffusion plate 12 are in the shape of a three-dimensional figure in which the end portion where adjacent faces out of the top face 12B, the bottom face 12C, and the side face 12D are orthogonal to each other is projected outward than the side face of the laminated body 10, each exposed portion 12A is able to be supported by dropping each exposed portion 12A into a dent provided in the side wall of the bottom chassis 6.

For example, as shown in FIGS. 79(A) and 79(B) (FIG. 79(A) is a cross section view in the case where the bottom chassis 6 of FIG. 79(B) is cut in the vertical direction), a dent having a shape corresponding to the shape of each exposed portion 12A is provided in the side wall of the bottom chassis 6, the supporting portion 6L is provided on the bottom face of two dents on the lower side of each dent, each supported portion 12K corresponding to the supporting portion 6L is respectively provided in the two exposed portions 12A provided on the lower side of the diffusion plate 12, and thereby enabling the dropping of each exposed portion 12A into the dent.

Further, for example, as shown in FIGS. 80(A) and 80(B) (FIG. 80(A) is a cross section view in the case where the bottom chassis 6 of FIG. 80(B) is cut in the vertical direction), a dent having a shape corresponding to the shape of each exposed portion 12A is provided in the side wall of the bottom chassis 6, the supporting portion 6K is provided on the upper side of the bottom face of each dent, and each supported portion 12E corresponding to the supporting portion 6K is respectively provided on the side face on the vertical upper face side of each exposed portion 12A, and thereby enabling the dropping of each exposed portion 12A into the dent.

In the display unit 200 of this embodiment, the flexible film 20 wraps around each optical sheet such as the light source image segmentation sheet 11, the diffusion plate 12, the diffusion sheet 13, and the luminance enhancement film 14, and has one or a plurality of openings 20A, 20B, or 20C to expose at least part of the outer edge of the diffusion plate 12. Further, the shape for positioning to the chassis (bottom chassis 6) that supports the optical sheet packaged body 1, 2, or 3 is provided in the exposed portion 12A exposed from at least one opening 20A, 20B, or 20C of the diffusion plate 12. Thereby, in positioning the laminated body 10 to the chassis, it is possible that only the diffusion plate 12 of the laminated body 10 is supported by the chassis and each optical sheet is supported by the flexible film 20. As a result, each optical sheet in the laminated body 10 is able to be individually stretched and shrunk to the lamination in-plane direction. Accordingly, it is possible to eliminate generation of wrinkles.

### Sixth Embodiment

FIG. 81 shows an example of a cross sectional configuration of a display unit 300 according to a sixth embodiment. The display unit 300 is in common with the configuration in the fourth embodiment in that the display unit 300 includes the liquid crystal display panel 5, the light source 4 arranged behind the liquid crystal display panel 5, the middle chassis 7, and the top chassis 8. However, the display unit 300 differs from the fourth embodiment in that the display unit 300 includes a buffer portion 61 provided for the bottom chassis 6 in the fourth embodiment and an optical sheet packaged body 9 is able to be arranged between the liquid crystal display panel 5 and the light source 4 in addition to the optical sheet packaged body 1, 2, or 3. Therefore, a description for configuration, operations, and effects of the fourth embodiment will be omitted as appropriate, and a description will be hereinafter given in detail of the differences from the fourth embodiment (the buffer portion 61 and the optical sheet packaged body 9).

The buffer portion 61 is provided on a face opposed to the optical sheet packaged body 1, 2, 3, or 4 of each beam of the bottom chassis 6 and the middle chassis 7 (that is, a region capable of being contacted with the optical sheet packaged body 1, 2, 3, or 4). For example, the buffer portion 61 is bonded to the surface of the beam, or the buffer portion 61 is formed from a given material of the beam.

The buffer portion 61 contains, for example, a thermoplastic resin, a thermosetting resin, a skid and the like, and has surface characteristics that the buffer portion 61 easily slides in the direction orthogonal to the lamination direction of the optical sheet packaged body 1, 2, 3, or 4. The buffer portion 61 may be a structure in which surface concave and convex are provided by using, for example, the thermoplastic resin or the thermosetting resin. Further, the buffer portion 61 may have a structure in which a skid is directly provided on the surface of the beam, a structure in which the thermoplastic resin or the thermosetting resin including the skid is provided on the surface of the beam, or a structure in which the thermoplastic resin or the thermosetting resin and the skid are layered in this order on the surface of the beam.

As the surface concave and convex structure, for example, a hollow structure, a low-density structural body such as a honeycomb structure, matting such as sandblasting on the outermost surface, a structure in which adjacent or a great number of structures having a polygonal cross sections such as a hemisphere, a prism, and a trapezoid are arranged in a state of array and the like are cited.

As the thermoplastic resin, an ester-based resin typified by polycarbonate, polyetylene terephthalate, and polyethylene naphthalate; an acryl-based resin, a styrene-based resin, an acrylonitrile resin, a vinyl-based resin such as a vinyl chloride resin, a rubber-based resin composed of butadiene or chloroprene, a crystalline resin composed of polyethylene or polypropylene, a resin composed of cellulose or polyvinyl alcohol, a urethane resin composed of urea bond and the like are cited.

As the thermosetting resin, a resin system capable of providing a surface shape such as an epoxy resin, a silicon resin, and a thiol-based resin is able to be used.

As the skid, fluorine system, silicon system, a chain low molecular substance, an inorganic filler, an organic filler and the like are able to be used.

Further, as shown in FIG. 82, in the optical sheet packaged body 9, the flexible film 20 totally wraps around each optical sheet such as the light source image segmentation sheet 11, the diffusion plate 12, the diffusion sheet 13, and the luminance enhancement film 14. That is, the optical sheet packaged body 9 is not provided with an opening to expose the diffusion plate 12.

In the display unit 300 of this embodiment, the surface of the flexible film 20 of the optical sheet packaged body 1, 2, 3, or 4 is contacted with the buffer portion 61 provided on each beam of the bottom chassis 6 and the middle chassis 7. Thereby, the optical sheet packaged body 1, 2, 3, or 9 is supported by the bottom chassis 6 and the middle chassis 7 from the lamination direction. Accordingly, each optical sheet in the laminated body 10 is able to be individually stretched and shrunk in the lamination in-plane direction, and thus a possibility of generating wrinkles is able to be eliminated.

### Seventh Embodiment

FIG. 83(A) shows an example of a cross sectional structure of an optical sheet packaged body 30 according to a seventh embodiment. The optical sheet packaged body 30 is arranged, for example, between a liquid crystal display panel and a light source, and is suitably used to improve the optical characteristics of the light source. The optical sheet packaged body 30 includes the laminated body 10 and a flexible film 40 as shown in FIG. 83(A).

[The laminated body 10 is formed by layering, for example, the light source image segmentation sheet 11, the diffusion plate 12 as a support plate, the diffusion sheet 13, and the luminance enhancement film 14 in this order.

The light source image segmentation sheet 11 is, as exemplified in FIG. 83(B), a thin optical sheet in which the plurality of columnar prisms 11A (linear convex portions) extending along a plane parallel to the bottom face on the top face thereof are arranged in line sequentially in a direction crossing the extending direction of the prisms 11A. In the case where a plurality of linear light sources are arranged in parallel directly under the laminated body 10, each prism 11A is preferably arranged in parallel so that the extending direction of each prism 11A is in parallel with the extending direction of the linear light sources (for example, horizontal direction). However, each prism 11A may be arranged to cross the extending direction of each linear light source within an allowable range based on optical characteristics. Further, each prism 11A preferably extends almost in parallel with one side of the diffusion plate 12. Thereby, for example, in the case where a chassis of the lighting device has an internal space surrounded by the inner wall in a state of a rectangle and the plurality of linear light sources are arranged in parallel so that one arrangement direction is in parallel with one face of the inner wall (side wall) in the internal space, it is possible that the extending direction of the prism 11A is almost in parallel with the extending direction of the linear light source only by arranging the optical sheet packaged body 30 in the chassis thereof.

The luminance enhancement film 14 is, as exemplified in FIG. 83(C), a thin optical sheet in which the plurality of columnar prisms 14A (linear convex portions) extending along a plane parallel to the bottom face on the top face thereof are arranged in line sequentially in a direction crossing the extending direction of the prisms 14A. In the case where the plurality of linear light sources are arranged in parallel directly under the laminated body 10, each prism 14A is preferably arranged in parallel so that the extending direction of each prism 14A is in parallel with the extending direction of the linear light sources (for example, horizontal direction). However, each prism 14A may be arranged to cross the extending direction of each linear light source within an allowable range based on optical characteristics. Further, the extending direction of each prism 14A is, as exemplified in FIGS. 83(B) and 83(C), preferably in parallel or almost in parallel with the extending direction of the prism 11A. In this case, by setting the both extending directions of the prisms 11A and 14A to a direction in parallel or almost in parallel with the horizontal direction, the view angle in the horizontal direction is able to be widened.

The flexible film 40 is, for example, composed of a single layer or a plurality of layers having transparency in a state of a film, a sheet, a plate, or a pouch, and wraps around the laminated body 10. In addition, the flexible film 40 may have or may not have an opening in a given portion as in the flexible film 20 in the foregoing embodiments. Further, the flexible film 40 is made of a material similar to that of the flexible film 20 in the foregoing embodiments, and has optical characteristics similar to those of the flexible film 20 in the foregoing embodiments.

In the optical sheet packaged body 30 of this embodiment, when the light source is arranged on the light source image segmentation portion 23 side of the optical sheet packaged body 30 and non-polarized light is irradiated from the light source toward the optical sheet packaged body 30, the light from the light source passes through the film (light incidence face) on the light source side (light incidence side) out of the flexible film 40, and then is segmented into minute light beams by the light source image segmentation sheet 11, and a light source image obtained by the segmentation is diffused by the diffusion plate 12 and the diffusion sheet 13. Thereby, the in-plane luminance distribution becomes uniform. The diffusion light having uniform luminance is collected by the luminance enhancement film 14. The light having increased front luminance passes through the film (light emitting face) on the other side (light emitting side) of the light source, and then is emitted outside. Accordingly, the light from the light source is adjusted to light having desired front luminance, desired in-plane luminance distribution, a desired view angle and the like.

By the way, in this embodiment, the flexible film 40 wraps around the light source image segmentation sheet 11, the diffusion plate 12, the diffusion sheet 13, and the luminance enhancement film 14 together with the diffusion plate 12 as the support plate to obtain the integrated structure. Thus, contact to limit the movement in the in-plane direction of each optical sheet such as the light source image segmentation sheet 11, the diffusion sheet 13, and the luminance enhancement film 14 is not generated, and thus generation of a wrinkle is able to be prevented. Further, since each optical sheet is integrated, handling is easier than in a case of using single optical sheets, and dust is less likely to enter into a clearance between each optical sheet. Further, it is not necessary to attach a protective film to each optical sheet in order to prevent damage during transport or the like. Thus, it is not necessary to peel off the protective film incorporating the integrated structure composed of each optical sheet (optical sheet packaged body) into the chassis. As a result, the throughput is improved.

### Modified Example of Seventh Embodiment

In the foregoing seventh embodiment, the diffusion plate 12 is used as a support plate. However, for example, as shown in FIGS. 84(A) and 84(B), the light source image segmentation sheet 11 having the same thickness and the same rigidity as those of the diffusion plate 12 may be used as a support plate. In addition, in this case, for example, as shown in FIGS. 84(A) and 84(B), the diffusion plate 12 is able to be eliminated from the laminated body 10 in the foregoing embodiments.

Further, in the foregoing seventh embodiment, the flexible film 40 includes only one light source image segmentation sheet 11, but the flexible film 40 may include two light source image segmentation sheets 11. For example, as shown in FIGS. 85(A) and 85(B), in the laminated body 10 in the foregoing embodiments, it is possible to add another light source image segmentation sheet 11 having the prism 11 A extending in the direction crossing (orthogonal to) the extending direction (for example, horizontal direction) of the prism 11 A of the light source image segmentation sheet 11 closest to the light incidence face between the light source image segmentation sheet 11 closest to the light incidence face and the diffusion plate 12. At this time, the prism 11A of the light source image segmentation sheet 11 closest to the light incidence face extends almost in parallel with one side of the diffusion plate 12 and the prism 11A of the added light source image segmentation sheet 11 extends almost in parallel with other side crossing the one side of the diffusion plate 12. In this case, for example, in the case where the chassis of the lighting device has an internal space surrounded by the inner wall in a state of a rectangle and a plurality of point light sources are arranged in a state of matrix so that the arrangement direction crosses the inner wall (side wall) (for example, refer to after-mentioned FIGS. 101(A) and 100(C)), it is possible that the extending directions of the prisms 11A of the both light source image segmentation sheets 11 cross the arrangement direction of the point light sources only by arranging the optical sheet packaged body 30 in the chassis thereof. As a result, overlap of each light source image segmented by the two light source image segmentation sheets 11 is able to be decreased, and thus luminance non-uniformity is able to be reduced. In addition, as described above, the case where the prisms 11A of the both light source image segmentation sheets 11 are formed to extend almost in parallel with the side of the diffusion plate 12 is preferable to the case where the prisms 11A of the both light source image segmentation sheets 11 are formed to extend in the direction crossing the side of the diffusion plate 12 (case of FIGS. 88(A) and 88(B) described later), since thereby higher production efficiency is able to be obtained. Further, for example, as shown in FIGS. 86(A) and 86(B) or FIGS. 87(A) and 87(B), one of the two light source image segmentation sheets 11 having the same thickness and the same rigidity as those of the diffusion plate 12 may be used as a support plate. In this case, however, for example, as shown in FIG. 86(A) or 87(A), the diffusion plate 12 may be eliminated from the laminated body 10 in the foregoing embodiments.

Furthermore, in the foregoing modified example of the seventh embodiment, when two light source image segmentation sheets 11 are provided in the flexible film 40, the prism 11A of the light source image segmentation sheet 11 closest to the light incidence face extends almost in parallel with one side of the diffusion plate 12, and the prism 11A of the added light source image segmentation sheet 11 extends almost in parallel with other side crossing the one side of the diffusion plate 12. However, as shown in FIGS. 88(A) and 88(B), the prisms 11A of the both light source image segmentation sheets 11 may extend in a direction crossing the one side of the diffusion plate 12. In this case, for example, in the case where the chassis of the lighting device has an internal space surrounded by the inner wall in a state of a rectangle and a plurality of point light sources are arranged so that one arrangement direction is in parallel with one face of the inner wall (side wall) and the other arrangement direction is in parallel with other face (side wall) crossing the one face of the inner wall (side wall) (for example, refer to after-mentioned FIGS. 105(A) and 105(C)), it is possible that the extending directions of the prisms 11A of the both light source image segmentation sheets 11 cross the arrangement direction of the point light sources only by arranging the optical sheet packaged body 30 in the chassis thereof. As a result, overlap of each light source image segmented by the two light source image segmentation sheets 11 is able to be decreased, and thus luminance non-uniformity is able to be reduced. In addition, in this case, one of the two light source image segmentation sheets 11 having the same thickness and the same rigidity as those of the diffusion plate 12 may be used as a support plate.

In this case, the arrangement direction in the point light sources represents the following two directions. One thereof is a direction (referred to as direction A for descriptive purposes) of a line segment joining other point light source closest to one point light source out of a plurality of other point light sources arranged around the one point light source (in the case where a plurality of point light sources closest to the one point light source exist, one thereof is selected) and the one point light source in the shortest distance. The other thereof is a direction of a line segment joining other point light source closest to one point light source out of a plurality of other point light sources in a direction crossing direction A viewed from the one point light source and the one point light source in the shortest distance.

Meanwhile, in the case where each point light source is composed of a single LED emitting red (R) light, green (G) light, or blue (B) light, or in the case where each point light source is composed of a plurality of LEDs individually emitting three primary colors of RGB, the arrangement direction is determined according to the foregoing rule for every color.

Further, the pitch of each point light source in one arrangement direction of the point light source is preferably equal to the pitch of each point light source in the other arrangement direction of the point light source. However, the respective pitches may be different from each other.

In this case, the pitch of each point light source represents an interval (distance) between each point light source in the arrangement direction. Meanwhile, in the case where each point light source is composed of a single LED emitting red (R) light, green (G) light, or blue (B) light, or in the case where each point light source is composed of a plurality of LEDs individually emitting three primary colors of RGB, the pitch is determined according to the foregoing rule for every color.

Further, in the foregoing seventh embodiment, the light source image segmentation sheet 11 having a three dimensional figure in which the plurality of prisms 11A extending in one direction are arranged in parallel is provided in the flexible film 40. However, as shown in FIGS. 89(A) and 89(B), a light source image segmentation sheet 21 having a three dimensional figure in which a convex portion 13A having a pair of tilted faces S1 provided with a ridge R1 (first ridge) in between and a convex portion 13B having a pair of tilted faces S2 provided with a ridge R2 (second ridge) in between are superposed on each other on the top face (face on the light emitting side) may be provided in the flexible film 40.

In this case, the ridge R₁ extends in a direction that is almost in parallel with the bottom face of the light source image segmentation sheet 21 (face on the light incidence side) and that is in parallel with one side of the diffusion plate 12. Meanwhile, the ridge R₂ extends in a direction that is almost in parallel with the bottom face of the diffusion sheet 13 and that is in parallel with other side crossing the one side of the diffusion plate 12. Thereby, for example, in the case where the chassis of the lighting device has an internal space surrounded by the inner wall in a state of a rectangle and a plurality of point light sources are arranged in a state of matrix so that the arrangement direction crosses other face (side wall) crossing one face in addition to the one face of the inner wall (side wall) (for example, refer to after-mentioned FIGS. 102(A) and 102(C)), it is possible that the ridges R₁ and R₂ of the light source image segmentation sheet 21 cross arrangement directions L₁ and L₂ of the point light sources as shown in FIG. 111 only by arranging the optical sheet packaged body 30 in the chassis thereof. As a result, overlap of each light source image segmented by the light source image segmentation sheet 21 is able to be decreased, and thus luminance non-uniformity is able to be reduced. In addition, in this case, as shown in FIGS. 90(A) and 90(B), the light source image segmentation sheet 21 having the same thickness and the same rigidity as those of the diffusion plate 12 may be used as a support plate. In this case, however, for example, as shown in FIG. 90(A), the diffusion plate 12 may be eliminated from the laminated body 10 in the foregoing embodiments.

In addition, where the direction of the ridge R₁ is x axis, the direction of the ridge R₂ is y axis, a function expressing the surface shape of the convex portion 21A is f(y), and a function expressing the surface shape of the convex portion 21B is f(x), the light source image segmentation sheet 21 has a surface shape satisfying Max[f(x), f(y)]. In this case, Max[f(x), f(y)] is a function in which f(x) is selected in the case of f(x)≧f(y) and f(y) is selected in the case of f(x)<f(y).

By the way, the light source image segmentation sheet 21 forms X-shaped (crucial) light source images I₁ to I₄ by segmenting the light source image created by the point light source into a plurality of light source images as exemplified in FIG. 112, FIG. 113, and FIG. 114. The shape of the light source images I₁ to I₄ and width D₃ of an arm thereof are not changed according to the in-plane arrangement manner of the point light sources, but are determined based on the three dimensional figure of the light source image segmentation sheet 21.

Therefore, for example, even in the case where the ridge R₁ of the light source image segmentation sheet 21 extends in a direction in parallel with one arrangement direction of the point light sources and the ridge R₂ of the light source image segmentation sheet 21 extends in a direction in parallel with the other arrangement direction of the point light sources, the X-shaped (crucial) light source image is formed.

However, in the case where each point light source is two-dimensionally arranged to the ridges R₁ and R₂ of the light source image segmentation sheet 21 as above, arms of adjacent light source images I are overlapped with each other. Therefore, the overlapped portion is significantly brighter than the other portions, and thus luminance non-uniformity are not able to be reduced efficiently.

On the other hand, in the case where the ridge R₁ of the light source image segmentation sheet 21 extends in the direction crossing one arrangement direction L₁ of the point light source at a given angle θ₁, and the ridge R₂ of the light source image segmentation sheet 21 extends in the direction crossing the other arrangement direction L₂ of the point light source at a given angle θ₂ as shown in FIG. 112, overlap of each light source image after segmentation is able to be reduced or eliminated, compared to a case where the ridges R₁ and R₂ of the light source image segmentation sheet 21 are arranged in the direction in parallel with the arrangement directions L₁ and L₂ of the point light source. As a result, luminance non-uniformity is able to be reduced.

By the way, the ridge R₁ may extend in a direction crossing three directions in total, which are the two arrangement directions of each point light source (directions L₁ and L₂) and the extending direction of the ridge R2. Further, the ridge R₂ may extend in a direction crossing three directions in total, which are the two arrangement directions of each point light source (directions L₁ and L₂) and the extending direction of the ridge R₁. Therefore, where an angle made by the ridge R₁ and the direction L₁ is θ₁ and an angle made by the ridge R₂ and the direction L₂ is θ₂, the ridges R₁ and R₂ of the light source image segmentation sheet 21 are preferably set so that θ₁ and θ₂ respectively and concurrently satisfy the following two formulas.

10°<θ₁<40°

10°<θ₂<40°

Further, in the case where the directions L₁ and L₂ are orthogonal to or almost orthogonal to each other, the rotational angles θ₁ and θ₂ preferably satisfy the following formula, respectively.

θ₁=θ₂=25°

In the case where the ridges R₁ and R₂ of the light source image segmentation sheet 21 are set so that θ₁ and θ₂ are 25°, as shown in FIG. 112, distances (D₄, D₅, D₆, D₇, and D₈) between the light source images I1 to I4 are almost equal to each other. Thereby, the in-plane distribution in a clearance between the light source images I₁ to I₄ (dark clearance) is able to be uniformized, and luminance non-uniformity is able to be significantly reduced.

In addition, D₄ represents a distance between side faces of both arms of the light source image I₁ and the light source image I₃ in the extending direction of the ridge R₁. D₅ represents a distance between an end of an arm of the light source image I₄ and a side face of an arm of the light source image I₃ in the extending direction of the ridge R1. Further, D₆ represents a distance between side faces of both arms of the light source image I1 and the light source image I₂ in the extending direction of the ridge R₂. D₇ represents a distance between an end of an arm of the light source image I₃ and a side face of an arm of the light source image I₁ in the extending direction of the ridge R₂.

Further, in the case where the ridges R₁ and R₂ of the light source image segmentation sheet 21 are set so that θ₁ and θ₂ are larger than 10° as the lower limit and smaller than 40° as the upper limit, as shown in FIG. 113 (θ₁ and θ₂ are in the vicinity of 10° as the lower limit), FIG. 114 (θ₁ and θ₂ are in the vicinity of 40° as the upper limit), overlap of the light source images I₁ to I₄ is able to be eliminated. Thereby, luminance non-uniformity is able to be reduced.

Further, in the foregoing modified example of the seventh embodiment, the ridge R₁ extends in parallel with one side of the diffusion plate 12, and the ridge R₂ extends in parallel with other side crossing the one side of the diffusion plate 12. However, as shown in FIGS. 91(A) and 91(B), the both ridges R₁ and R₂ may extend in the direction crossing the extending directions of the all sides of the diffusion plate 12. In this case, for example, in the case where the chassis of the lighting device has an internal space surrounded by the inner wall in a state of a rectangle, when a plurality of point light sources are arranged so that one arrangement direction is in parallel with one face of the inner wall (side wall) and the other arrangement direction is in parallel with other face (side wall) crossing the one face of the inner wall (side wall) (for example, refer to after-mentioned FIGS. 106(A) and 106(C)), it is possible that the extending directions of the ridges R₁ and R₂ cross the arrangement direction of the point light sources only by arranging the optical sheet packaged body 30 in the chassis thereof. As a result, overlap of each light source image segmented by the light source image segmentation sheet 21 is able to be decreased, and thus luminance non-uniformity is able to be reduced. In addition, in this case, as shown in FIGS. 92(A) and 92(B), the light source image segmentation sheet 21 having the same thickness and the same rigidity as those of the diffusion plate 12 may be used as a support plate. In this case, however, for example, as shown in FIG. 92(A), the diffusion plate 12 may be eliminated from the laminated body 10 in the foregoing embodiments.

By the way, in the foregoing modified example, as shown in FIG. 115, where an angle made by the ridge R₁ and one arrangement direction L₁ of the point light source is θ₁ and an angle made by the ridge R₂ and the other arrangement direction L₂ of the point light source is θ₂, the ridges R₁ and R₂ are preferably set so that θ₁ and θ₂ respectively and concurrently satisfy the following two formulas.

10°<θ1<40°

10°<θ2<40°

Further, in the case where the ridges R₁ and R₂ are orthogonal to or almost orthogonal to each other, θ₁ and θ₂ preferably satisfy the following formula, respectively.

θ₁=θ₂=25°

In this case, in the case where the directions of the ridges R₁ and R₂ are set so that θ₁ and θ₂ are 25°, as shown in FIG. 116, distances (D4, D5, D6, and D7) between the light source images I1 to I4 are almost equal to each other. Thereby, the in-plane distribution in a clearance between the light source images I1 to I4 (dark clearance) is able to be uniformized, and luminance non-uniformity is able to be significantly reduced.

Further, in the case where the directions of the ridges R₁ and R₂ are set so that θ₁ and θ₂ are larger than 10° as the lower limit and smaller than 40° as the upper limit, as shown in FIG. 117 (θ₁ and θ₂ are in the vicinity of 10° as the lower limit) and FIG. 118 (θ₁ and θ₂ are in the vicinity of 40° as the upper limit), overlap of the light source images I1 to I4 is able to be eliminated. Thereby, luminance non-uniformity is able to be reduced.

### Eighth Embodiment

FIG. 93(A) shows an example of a cross sectional structure of an optical sheet packaged body 50 according to an eighth embodiment. The optical sheet packaged body 50 is arranged, for example, between a liquid crystal display panel and a light source, and is suitably used to improve the optical characteristics of the light source. The optical sheet packaged body 50 includes the laminated body 10 and a flexible film 60 as shown in FIG. 93(A).

The laminated body 10 is formed by, for example, layering the diffusion plate 12 as a support plate, the diffusion sheet 13, and the luminance enhancement film 14 in this order.

The flexible film 60 is, for example, composed of a single layer or a plurality of layers having transparency in a state of a film, a sheet, a plate, or a pouch, and wraps around the laminated body 10. In addition, the flexible film 60 may have or may not have an opening in a given region as in the flexible film 20 in the foregoing embodiments. Further, the flexible film 60 is made of a material similar to that of the flexible film 20 in the foregoing embodiments, and has optical characteristics similar to those of the flexible film 20 in the foregoing embodiments.

By the way, of the flexible film 60, in the film corresponding to the light incidence side (diffusion plate 12 side) of the laminated body 10, as shown in FIGS. 93(A) and 93(B), a light source image segmentation portion 22 including a plurality of prisms 22A (convex portions) is provided. The plurality of prisms 22A extend in one direction in the lamination plane of the laminated body 10, and are arranged in line sequentially in the direction crossing the one direction in the lamination plane. In the case where a plurality of linear light sources are arranged in parallel directly under the laminated body 10, each prism 22A is preferably arranged in parallel so that the extending direction of each prism 22A is in parallel with the extending direction of the linear light sources (for example, horizontal direction). However, each prism 22A may be arranged to cross the extending direction of each linear light source within an allowable range based on optical characteristics. Further, each prism 22A preferably extends almost in parallel with one side of the diffusion plate 12. Thereby, for example, in the case where a chassis of the lighting device has an internal space surrounded by the inner wall in a state of a rectangle, when the plurality of linear light sources are arranged in parallel so that one arrangement direction is in parallel with one face of the inner wall (side wall) in the internal space, it is possible that the extending direction of the prism 22A is almost in parallel with the extending direction of the linear light source only by arranging the optical sheet packaged body 50 in the chassis thereof.

In the optical sheet packaged body 50 of this embodiment, when the light source is arranged on the light source image segmentation portion 22 side of the optical sheet packaged body 50 and non-polarized light is emitted from the light source toward the optical sheet packaged body 50, the light from the light source is segmented into minute light beams by the light source image segmentation portion 22 provided in the film (light incidence face) on the light source side (light incidence side) of the optical sheet packaged body 50, and a light source image obtained by the segmentation is diffused by the diffusion plate 12 and the diffusion sheet 13. Thereby, the in-plane luminance distribution is uniformized. The diffusion light having uniform luminance is collected by the luminance enhancement film 14. The light having increased front luminance passes through the film (light emitting face) on the other side (light emitting side) of the light source out of the flexible film 60, and then is emitted outside. Accordingly, the light from the light source is adjusted to light having desired front luminance, desired in-plane luminance distribution, a desired view angle and the like.

By the way, in this embodiment, the flexible film 60 wraps around the diffusion plate 12, the diffusion sheet 13, and the luminance enhancement film 14 together with the diffusion plate 12 as the support plate to obtain the integrated structure. Thus, contact to limit the movement in the in-plane direction of each optical sheet such as the diffusion sheet 13 and the luminance enhancement film 14 is not generated, and thus generation of a wrinkle is able to be prevented. Further, since each optical sheet is integrated, handling is easier than in a case of using single optical sheets, and dust is less likely to enter into a clearance between each optical sheet. Further, it is not necessary to attach a protective film to each optical sheet in order to prevent damage during transport or the like. Thus, it is not necessary to peel off the protective film incorporating the integrated structure composed of each optical sheet (optical sheet packaged body) into the chassis. As a result, the throughput is improved.

Further, in this embodiment, of the flexible film 60, in the film corresponding to the light incidence side (diffusion plate 12 side) of the laminated body 10, the light source image segmentation portion 22 is provided. Thus, compared to the case where the flexible film 40 wraps around the light source image segmentation sheet 11 as in the cases of the foregoing embodiments, the thickness of the entire optical sheet packaged body 50 is able to be reduced by the portion of the light source image segmentation sheet 11.

### Modified Example of Eighth Embodiment

In the foregoing eighth embodiment, the light source image segmentation portion 22 is provided in the flexile film 60 instead of wrapping the light source image segmentation sheet 11 with the flexile film 60. However, for example, as shown in FIGS. 94(A) and 94(B), it is possible that the light source image segmentation sheet 11 is provided between the film corresponding to the light incidence side (diffusion plate 12 side) of the laminated body 10 of the flexible film 60 and the diffusion plate 12, and the light source image segmentation portion 22 is provided in the film corresponding to the light incidence side (diffusion plate 12 side) of the laminated body 10 of the flexible film 60. At this time, the prism 22A of the light source image segmentation portion 22 extends almost in parallel with one side of the diffusion plate 12. The prism 11A of the light source image segmentation sheet 11 extends almost in parallel with other side crossing the one side of the diffusion plate 12. In this case, for example, in the case where the chassis of the lighting device has an internal space surrounded by the inner wall in a state of a rectangle and a plurality of point light sources are arranged in a state of matrix so that the arrangement direction crosses the inner wall (side wall) (for example, refer to after-mentioned FIGS. 103(A) and 103(C)), it is possible that the extending directions of the prisms 11A and 22A cross the arrangement direction of the point light sources only by arranging the optical sheet packaged body 60 in the chassis thereof. As a result, overlap of each light source image segmented by the prisms 11A and 22A is able to be decreased, and thus luminance non-uniformity is able to be reduced. In addition, as described above, the case where the prisms 11A and 22A are formed to extend almost in parallel with the side of the diffusion plate 12 is preferable to the case where the prisms 11A and 22A are formed to extend in the direction crossing the side of the diffusion plate 12 (case of FIGS. 96(A) and 96(B) described later), since higher production efficiency is able to be obtained in the former case. Further, for example, as shown in FIGS. 95(A) and 95(B), the light source image segmentation sheet II having the same thickness and the same rigidity as those of the diffusion plate 12 is able to be used as a support plate. In this case, however, for example, as shown in FIG. 95(A), the diffusion plate 12 may be eliminated from the laminated body 10 in the foregoing embodiments.

Further, in the foregoing modified example of the eighth embodiment, when the light source image segmentation sheet 11 is provided in the flexible film 60, the prism 22A of the light source image segmentation portion 22 extends almost in parallel with one side of the diffusion plate 12, and the prism 11A of the light source image segmentation sheet 11 extends almost in parallel with other side crossing the one side of the diffusion plate 12. However, as shown in FIGS. 96(A) and 96(B), the prisms 11A and 22A may extend in a direction crossing the one side of the diffusion plate 12. In this case, for example, in the case where the chassis of the lighting device has an internal space surrounded by the inner wall in a state of a rectangle, when a plurality of point light sources are arranged so that one arrangement direction is in parallel with one face of the inner wall (side wall) and the other arrangement direction is in parallel with other face (side wall) crossing the one face of the inner wall (side wall) (for example, refer to after-mentioned FIGS. 107(A) and 107(C)), it is possible that the extending directions of the prisms 11A and prisms 22A cross the arrangement direction of the point light sources only by arranging the optical sheet packaged body 50 in the chassis thereof. As a result, overlap of each light source image segmented by the prisms 11A and prisms 22A is able to be decreased, and thus luminance non-uniformity is able to be reduced. In addition, in this case, the light source image segmentation sheet 11 having the same thickness and the same rigidity as those of the diffusion plate 12 may be used as a support plate.

Further, in the foregoing eighth embodiment, the light source image segmentation portion 22 having the three dimensional figure in which the plurality of prisms 22A extending in one direction are arranged in parallel is provided in the film corresponding to the light incidence side (diffusion plate 12 side) of the laminated body 10 of the flexible film 60. However, for example, as shown in FIGS. 97(A) and 97(B), a light source image segmentation portion 23 having a three dimensional figure in which a convex portion 23A having a pair of tilted faces S1 provided with ridge R1 (first ridge) in between and a convex portion 23B having a pair of tilted faces S2 provided with ridge R2 (second ridge) in between are superposed on each other may be provided in the film corresponding to the light incidence side (diffusion plate 12 side) of the laminated body 10 of the flexible film 60.

In this case, the ridge R₁ extends in a direction that is almost in parallel with the bottom face (light incidence side face) of the film corresponding to the light incidence side (diffusion plate 12 side) of the laminated body 10 of the flexible film 60 and that is in parallel with one side of the diffusion plate 12. Meanwhile, the ridge R₂ extends in a direction that is almost in parallel with the bottom face of the film (light incidence side face) corresponding to the light incidence side (diffusion plate 12 side) of the laminated body 10 of the flexible film 60 and that is in parallel with other side crossing the one side of the diffusion plate 12. Thereby, for example, in the case where the chassis of the lighting device has an internal space surrounded by the inner wall in a state of a rectangle, when a plurality of point light sources are arranged in a state of matrix so that the arrangement direction crosses other face (side wall) crossing one face in addition to the one face of the inner wall (side wall) (for example, refer to after-mentioned FIGS. 104(A) and 104(C)), it is possible that the ridges R₁ and R₂ of the light source image segmentation portion 23 cross the arrangement directions of the point light sources only by arranging the optical sheet packaged body 50 in the chassis thereof. As a result, overlap of each light source image segmented by the light source image segmentation portion 23 is able to be decreased, and thus luminance non-uniformity is able to be reduced.

In addition, where the direction of the ridge R₁ is x axis, the direction of the ridge R₂ is y axis, a function expressing the surface shape of the convex portion 21A is f(y), and a function expressing the surface shape of the convex portion 21B is f(x), the light source image segmentation sheet 21 has a surface shape satisfying Max[f(x), f(y)]. In this case, Max[f(x), f(y)] is a function in which f(x) is selected in the case of f(x)≧f(y) and f(y) is selected in the case of f(x)<f(y).

Further, in the foregoing modified example of the eighth embodiment, the ridge R₁ extends in parallel with one side of the diffusion plate 12, and the ridge R₂ extends in parallel with other side crossing the one side of the diffusion plate 12. However, as shown in FIGS. 98(A) and 98(B), the both ridges R₁ and R₂ may extend in a direction crossing the extending directions of the all sides of the diffusion plate 12. In this case, for example, in the case where the chassis of the lighting device has an internal space surrounded by the inner wall in a state of a rectangle, when a plurality of point light sources are arranged in the internal space so that one arrangement direction is in parallel with one face of the inner wall (side wall) and the other arrangement direction is in parallel with other face (side wall) crossing the one face of the inner wall (side wall) (for example, refer to after-mentioned FIGS. 108(A) and 108(C)), it is possible that the extending directions of the ridges R₁ and R₂ cross the arrangement direction of the point light sources only by arranging the optical sheet packaged body 50 in the chassis thereof. As a result, overlap of each light source image segmented by the light source image segmentation portion 23 is able to be decreased, and thus luminance non-uniformity is able to be reduced.

### Ninth Embodiment

FIG. 99A shows an example of a cross sectional configuration of a display unit 400 according to a ninth embodiment. The display unit 400 includes the liquid crystal display panel 5, a light source 24 arranged behind the liquid crystal display panel 5, an optical sheet packaged body 30 arranged between the liquid crystal display panel 5 and the light source 24, and a chassis 25 supporting the liquid crystal display panel 5, the light source 24, and the optical sheet packaged body 30. The front face of the liquid crystal display panel 5 is oriented to a viewer (not shown) side. In addition, in this embodiment, for the purpose of convenience, the liquid crystal display panel 5 is arranged so that the front face thereof is orthogonal to the horizontal plane.

In the light source 24, as exemplified in FIGS. 99(A) and 99(C), a plurality of linear light sources are arranged in parallel at equal intervals (for example, at the intervals of 20 μm). The linear light source is typically a Cold Cathode Fluorescent Lamp called CCFL. However, as a light source, point light sources such as Light Emitting Diode (LED) may be linearly arranged. Each linear light source is arranged in a state of matrix so that while one arrangement direction is in parallel with one face of the inner wall (side wall) (for example, horizontal), the other arrangement direction is in parallel with other face (side wall) crossing the one face of the inner wall (side wall) in the internal space surrounded by the inner wall of the chassis 25 in a state of a rectangle.

The optical sheet packaged body 30 has the structure as any of FIGS. 83(A), 83(B) to FIGS. 87(A), 87(B). As exemplified in FIGS. 99(A) and 99(B), respectively, each prism 11A of the light source image segmentation sheet 11 and each prism 14A of the luminance enhancement film 14 in the optical sheet packaged body 30 are arranged in parallel so that the extending directions of each prism 11A and 14A are in parallel with the extending direction of the light source 24 (for example, horizontal direction), and the extending directions of each prism 11A and 14A are almost in parallel with one side of the diffusion plate 12.

In the display unit 400 of this embodiment, light emitted from the light source 24 directly enters the optical sheet packaged body 30 or is reflected by the chassis 25 and then enters the optical sheet packaged body 30. The light entering into the optical sheet packaged body 30 passes through the film (light incidence face) on the light source 24 side (light incidence side) of the flexible film 40, is segmented into minute light beams by the light source image segmentation sheet 11, and a light source image obtained by the segmentation is diffused by the diffusion plate 12 and the diffusion sheet 13. Thereby, the in-plane luminance distribution is uniformized. The diffusion light having uniform luminance is collected by the luminance enhancement film 14, and the front luminance is increased.

When the uniform light having high luminance passing through the optical sleet packaged body 30 as above enters the liquid crystal display panel 5, a polarization component crossing the polarizing axis of the polarization plate on the other side of a viewer is absorbed into the polarization plate, and a polarization component in parallel with the polarizing axis of the polarization plate passes through the polarization plate. The straight polarized light passing through the polarization plate enters each pixel electrode, is modulated in the liquid crystal layer according to a voltage applied between each pixel electrode and the opposed electrode, is provided with color separation by the color filter, and enters the polarization plate on the viewer side. Among the light entering the polarization plate, a polarization component crossing the polarizing axis of the polarization plate is absorbed into the polarization plate, a polarization component in parallel with the polarizing axis of the polarization plate passes through the polarization plate to form an image on the front face of the panel. Accordingly, the image is displayed in the display unit 400.

Incidentally, in this embodiment, the flexible film 40 wraps around the plurality of optical sheets together with the support plate, and the integrated optical sheet packaged body 30 is used. Thus, a wrinkle is not generated in the content (the plurality of optical sheets) in the optical sheet packaged body 30, and luminance non-uniformity caused by a wrinkle is able to be eliminated.

Meanwhile, instead of the optical sheet packaged body 30 having the structure shown in FIGS. 83(A), 83(B) to 87(A), 87(B), the optical sheet packaged body 50 having the structure shown in FIGS. 93(A), 93(B) to 95(A), 95(B) is able to be used (refer to FIGS. 100(A) to 100(C)). In this case, luminance non-uniformity caused by a wrinkle is able to be eliminated as well.

### Tenth Embodiment

FIG. 101(A) shows an example of a cross sectional configuration of a display unit 500 according to a tenth embodiment. The display unit 500 includes the liquid crystal display panel 5, a light source 26 arranged behind the liquid crystal display panel 5, a reflection plate 27 supporting the light source 26, the optical sheet packaged body 30 arranged between the liquid crystal display panel 5 and the light source 26, and the chassis 25 supporting the liquid crystal display panel 5, the light source 26, the reflection plate 27, and the optical sheet packaged body 30. The front face of the liquid crystal display panel 5 is oriented to a viewer (not shown) side. In this embodiment, for the purpose of convenience, the liquid crystal display panel 5 is arranged so that the front face thereof is orthogonal to the horizontal plane.

In the light source 26, a plurality of point light sources are arranged in a state of matrix at equal intervals. The plurality of point light sources are composed of, for example, a Light Emitting Diode (LED). The plurality of point light sources are arranged so that the arrangement direction crosses not only one face of the inner wall (side wall) but also other face (side wall) crossing the one face in the internal space surrounded by the inner wall of the chassis 25 in a state of a rectangle as shown in FIG. 100(C). Further, the plurality of point light sources are arranged so that the arrangement direction crosses the extending directions of the all sides of the diffusion plate 12.

The optical sheet packaged body 30 has the structure as any of FIGS. 85(A), 85(B), FIGS. 86(A), 86(B), or FIGS. 87(A), 87(B). FIGS. 100(A) and 100(B) show a case where the optical sheet packaged body 30 has the structure shown in FIGS. 85(A) and 85(B) as an example. Each prism 11A of the light source image segmentation sheet 11 on the light source 26 side out of the two light source image segmentation sheets 11 in the optical sheet packaged body 30 is arranged in parallel so that the extending direction of each prism 11A is the direction crossing the arrangement direction of the light source 26 (for example, horizontal direction) and almost in parallel with the extending direction of one side of the diffusion plate 12. Further, each prism 11A of the light source image segmentation sheet 11 that is farther from the light source 26 out of the two light source image segmentation sheets 11 in the optical sheet packaged body 30 is arranged in parallel so that the extending direction of each prism 11 is the direction crossing the extending direction of each prism 11 of the light source image segmentation sheet 11 on the light source 26 side and the arrangement direction of the light source 26 (for example, vertical direction) and almost in parallel with the extending direction of other side crossing the one side of the diffusion plate 12.

In the display unit 500 of this embodiment, light emitted from the light source 26 directly enters the optical sheet packaged body 30 or is reflected by the chassis 25 and the reflection plate 27 and then enters the optical sheet packaged body 30. The light entering into the optical sheet packaged body 30 passes through the film (light incidence face) on the light source 26 side (light incidence side) of the flexible film 40, is segmented into minute light beams by the light source image segmentation sheet 11, and a light source image obtained by the segmentation is diffused by the diffusion plate 12 and the diffusion sheet 13. Thereby, the in-plane luminance distribution is uniformized. The diffusion light having uniform luminance is collected by the luminance enhancement film 14, and the front luminance is increased.

When the uniform light having high luminance passing through the optical sheet packaged body 30 as above enters the liquid crystal display panel 5, a polarization component crossing the polarizing axis of the polarization plate on the other side of a viewer is absorbed into the polarization plate, and a polarization component in parallel with the polarizing axis of the polarization plate passes through the polarization plate. The straight polarized light passing through the polarization plate enters each pixel electrode, is modulated in the liquid crystal layer according to a voltage applied between each pixel electrode and the opposed electrode, is further provided with color separation by the color filter, and enters the polarization plate on the viewer side. Among the light entering the polarization plate, a polarization component crossing the polarizing axis of the polarization plate is absorbed into the polarization plate, a polarization component in parallel with the polarizing axis of the polarization plate passes through the polarization plate to form an image on the front face of the panel. Accordingly, the image is displayed in the display unit 500.

By the way, in this embodiment, the flexible film 40 wraps around the plurality of optical sheets together with the support plate, and the integrated optical sheet packaged body 30 is used. Thus, a wrinkle is not generated in the content (the plurality of optical sheets) in the optical sheet packaged body 30, and luminance non-uniformity caused by a wrinkle is able to be eliminated.

Meanwhile, instead of the optical sheet packaged body 30 having the structure shown in FIGS. 85(A), 85(B) to 87(A), 87(B), the optical sheet packaged body 30 having the structure shown in FIGS. 89(A), 89(B) or FIGS. 90(A), 90(B) is able to be used (for example, refer to FIGS. 102(A) to 102(C)), or the optical sheet packaged body 50 having the structure shown in FIGS. 94(A), 94(B), FIG. 95(A), 95(B), or 97(A), 97(B) is able to be used (for example, refer to FIGS. 103(A) to 103(C) or FIGS. 104(A) to 104(C)). In this case, luminance non-uniformity caused by a wrinkle is able to be eliminated as well.

### Eleventh Embodiment

FIG. 105A shows an example of a cross sectional configuration of a display unit 600 according to an eleventh embodiment. The display unit 600 includes the liquid crystal display panel 5, a light source 28 arranged behind the liquid crystal display panel 5, a reflection plate 27 supporting the light source 28, the optical sheet packaged body 30 arranged between the liquid crystal display panel 5 and the light source 28, and the chassis 25 supporting the liquid crystal display panel 5, the light source 28, the reflection plate 27, and the optical sheet packaged body 30. The front face of the liquid crystal display panel 5 is oriented to a viewer (not shown) side. In addition, in this embodiment, for the purpose of convenience, the liquid crystal display panel 5 is arranged so that the front face thereof is orthogonal to the horizontal plane.

In the light source 28, a plurality of point light sources are arranged in a state of matrix at equal intervals. The plurality of point light sources are composed of, for example, a light emitting diode. The plurality of point light sources are arranged so that while one arrangement direction is almost in parallel with one face of the inner wall (side wall), the other arrangement direction is almost in parallel with other face (side wall) crossing the one face of the inner wall (side wall) in the internal space surrounded by the inner wall of the chassis 25 in a state of a rectangle as shown in FIG. 105(C). Further, the plurality of point light sources are arranged so that while one arrangement direction is almost in parallel with the extending direction of one side of the diffusion plate 12, the other arrangement direction is almost in parallel with the extending direction of other side crossing the one side of the diffusion plate 12.

The optical sheet packaged body 30 has the structure shown in FIGS. 88(A) and 88(B) as shown in FIGS. 105(A) and 105(B). Each prism 11A of the light source image segmentation sheet 11 on the light source 28 side out of the two light source image segmentation sheets 11 in the optical sheet packaged body 30 is arranged in parallel so that the extending direction of each prism 11A is the direction that crosses the arrangement direction of the light source 28 and that crosses the extending directions of the all sides of the diffusion plate 12. Further, each prism 11A of the light source image segmentation sheet 11 that is farther from the light source 28 out of the two light source image segmentation sheets 11 in the optical sheet packaged body 30 is arranged in parallel so that the extending direction of each prism 11A is the direction that crosses the extending direction of each prism 111 of the light source image segmentation sheet 11 on the light source 28 side and the arrangement direction of the light source 28 and that crosses the extending directions of the all sides of the diffusion plate 12.

In the display unit 600 of this embodiment, light emitted from the light source 28 directly enters the optical sheet packaged body 30 or is reflected by the chassis 25 and the reflection plate 27 and then enters the optical sheet packaged body 30. The light entering into the optical sheet packaged body 30 passes through the film (light incidence face) on the light source 28 side (light incidence side) of the flexible film 40, is segmented into minute light beams by the light source image segmentation sheet 11, and a light source image obtained by the segmentation is diffused by the diffusion plate 12 and the diffusion sheet 13. Thereby, the in-plane luminance distribution is uniformized. The diffusion light having uniform luminance is collected by the luminance enhancement film 14, and the front luminance is increased.

When the uniform light having high luminance passing through the optical sheet packaged body 30 as above enters the liquid crystal display panel 5, a polarization component crossing the polarizing axis of the polarization plate on the other side of a viewer is absorbed into the polarization plate, and a polarization component in parallel with the polarizing axis of the polarization plate passes through the polarization plate. The straight polarized light passing through the polarization plate enters each pixel electrode, is modulated in the liquid crystal layer according to a voltage applied between each pixel electrode and the opposed electrode, is further provided with color separation by the color filter, and enters the polarization plate on the viewer side. Among the light entering the polarization plate, a polarization component crossing the polarizing axis of the polarization plate is absorbed into the polarization plate, a polarization component in parallel with the polarizing axis of the polarization plate passes through the polarization plate to form an image on the front face of the panel. Accordingly, the image is displayed in the display unit 600.

By the way, in this embodiment, the flexible film 40 wraps around the plurality of optical sheets together with the support plate, and the integrated optical sheet packaged body 30 is used. Thus, a wrinkle is not generated in the content (the plurality of optical sheets) in the optical sheet packaged body 30, and luminance non-uniformity caused by a wrinkle is able to be eliminated.

Meanwhile, instead of the optical sheet packaged body 30 having the structure shown in FIGS. 105(A) and 105(B), the optical sheet packaged body 30 having the structure shown in FIG. 91(A), 91(B) or 92(A), 92(B) is able to be used (refer to FIGS. 106(A) to 106(B)), or the optical sheet packaged body 50 having the structure shown in FIG. 96(A), 96(B) or 98(A), 98(B) is able to be used (refer to FIGS. 107(A), 107(B) or FIGS. 108(A), 108(B)). In these cases, luminance non-uniformity caused by a wrinkle is able to be eliminated as well.

While embodiments and the modified examples have been described, the present application is not limited to the embodiments and the like, and various modified examples may be made.

For example, in the foregoing respective embodiments and the like, the structures of the optical sheet packaged bodies 1, 2, 3, 4, 30, and 50 have been illustratively described. However, it is not necessary to provide all the illustrated respective optical sheets. In addition, other layer (for example, a reflective polarization sheet) may be provided. That is, according to the uses and purposes, various selections are enabled. Instead of the diffusion plate 12, a transparent support plate that does not work optically may be used.

Further, in the foregoing respective embodiments and the like, nothing is particularly provided between the optical sheet packaged body 30/50 and the liquid crystal display panel 5. However one or a plurality of optical sheets may be provided between the optical sheet packaged body 30/50 and the liquid crystal display panel 5. For example, as shown in FIG. 109, a reflective polarization sheet 15 is able to be provided between the optical sheet packaged body 30 including the light source image segmentation sheet 11, the diffusion plate 12, the diffusion sheet 13, and the luminance enhancement film 14 and the liquid crystal display panel 5. Further, for example, as exemplified in FIG. 110, the diffusion sheet 13, the luminance enhancement film 14, and the reflective polarization sheet 15 are able to be provided sequentially from the optical sheet packaged body 50 side between the optical sheet packaged body 50 in which the diffusion plate 12 is wrapped with the flexible film 60 provided with the light source image segmentation portion 22 in the film on the light source 4 side and the liquid crystal display panel 5.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. An optical sheet packaged body comprising:
a laminated body in which a rectangular support plate having a top face, a bottom face, and side faces and one or a plurality of optical sheets are layered; and
a flexible film wrapping around the laminated body, the flexible film having one or a plurality of openings to expose at least part of an outer edge of the support plate.

2. The optical sheet packaged body according to claim 1, wherein at least one of the openings is provided correspondingly to a corner of the support plate.

3. The optical sheet packaged body according to claim 1, wherein at least one of the openings is provided correspondingly to a whole or a part of one side of the support plate.

4. The optical sheet packaged body according to claim 1, wherein each pail of the top face, the bottom face, and the side faces of the support plate is exposed from at least one of the openings.

5. The optical sheet packaged body according to claim 1, wherein only part of the side face of the support plate is exposed from at least one of the openings.

6. The optical sheet packaged body according to claim 1, wherein an exposed portion that is exposed from at least one of the openings of the support plate is provided with a shape for positioning to a chassis that supports the optical sheet packaged body.

7. An optical sheet unit comprising an optical sheet packaged body, and a chassis supporting the optical sheet packaged body, wherein:
the optical sheet packaged body includes
a laminated body in which a rectangular support plate having a top face, a bottom face, and side faces and one or a plurality of optical sheets are layered, and
a flexible film that wraps around the laminated body and has one or a plurality of openings to expose at least part of an outer edge of the support plate; and
the chassis has a supporting portion that supports the optical sheet packaged body correspondingly to an exposed portion that is exposed from at least one of the openings out of the support plate.

8. An optical sheet unit comprising an optical sheet packaged body, and
a chassis supporting the optical sheet packaged body, wherein:
the optical sheet packaged body includes
a laminated body in which a rectangular support plate having a top face, a bottom face, and side faces and one or a plurality of optical sheets are layered, and
a flexible film that wraps around the laminated body; and
the chassis has a supporting portion that sandwiches the flexible film in a lamination direction of the laminated body and has surface characteristics to easily slide in a direction in which the film is orthogonal to the lamination direction of the laminated body in a portion contacted with the flexible film.

9. A lighting device comprising:
a light source emitting light;
an optical device packaged body into which light emitted from the light source enters; and
one or a plurality of first optical devices into which light emitted from the optical device packaged body enters,
wherein the optical device packaged body has
one or a plurality of second optical devices, and
a packaging member that wraps around the one or the plurality of optical devices.

10. A lighting device comprising:
an optical sheet packaged body;
a light source emitting light toward the optical sheet packaged body; and
a chassis supporting the light source and the optical sheet packaged body,
wherein the optical sheet packaged body has a laminated body in which a rectangular support plate having a top face, a bottom face, and side faces and one or a plurality of optical sheets are layered, and a flexible film wrapping around the laminated body and having one or a plurality of openings to expose at least part of an outer edge of the support plate, and
the chassis has a supporting portion supporting the optical sheet packaged body correspondingly to an exposed portion that is exposed from at least one of the openings of the support plate.

11. The lighting device according to claim 10, wherein the flexible film is formed at least in a region through which the light from the light source passes.

12. A display unit comprising:
a panel driven based on an image signal;
a light source emitting light for illuminating the panel;
an optical sheet packaged body provided between the panel and the light source; and
a chassis supporting the panel, the light source, and the optical sheet packaged body,
wherein the optical sheet packaged body has a laminated body in which a rectangular support plate having a top face, a bottom face, and side faces and one or a plurality of optical sheets are layered, and a flexible film wrapping around the laminated body and having one or a plurality of openings to expose at least part of an outer edge of the support plate, and
the chassis has a supporting portion supporting the optical sheet packaged body correspondingly to an exposed portion that is exposed from at least one of the openings of the support plate.

13. A display unit comprising:
a light source emitting light;
an optical device packaged body into which light emitted from the light source enters;
one or a plurality of first optical devices into which light emitted from the optical device packaged body enters; and
a panel into which light emitted from the one or the plurality of first optical devices enters and which is driven based on an image signal,
wherein the optical device packaged body has
one or a plurality of second optical devices, and
a packaging member that wraps around the one or the plurality of optical devices.

14. An optical sheet packaged body comprising:
a laminated body layering a rectangle support plate and one or a plurality of optical sheets; and
a flexible film wrapping around the laminated body,
wherein while one face in a lamination direction of the laminated body of the laminated body corresponds to a light incidence face, the other face of the laminated body of the laminated body corresponds to a light emitting face, and
a sheet closest to the light incidence face out of the support plate and the one or the plurality of optical sheets has a plurality of first convex portions that extend in one direction and are arranged in parallel in a direction crossing the one direction.

15. The optical sheet packaged body according to claim 14, wherein the respective first convex portions extend almost in parallel with one side of the support plate.

16. The optical sheet packaged body according to claim 14, wherein the respective first convex portions extend in a direction crossing one side of the support plate.

17. The optical sheet packaged body according to claim 14, wherein a sheet secondly closest to the light incidence face out of the support plate and the one or the plurality of optical sheets has a plurality of second convex portions that extend in a direction crossing the extending direction of the first convex portion and are arranged in parallel in the extending direction of the first convex portion.

18. An optical sheet packaged body comprising:
a laminated body layering a rectangle support plate and one or a plurality of optical sheets; and
a flexible film wrapping around the laminated body,
wherein one film in a lamination direction of the laminated body of the flexible film corresponds to a light incidence face, and the other face in the lamination direction of the laminated body of the flexible film corresponds to a light emitting face,
the film corresponding to the light incidence face of the flexible film has a plurality of first convex portions that extend in one direction and are arranged in parallel in a direction crossing the one direction.

19. The optical sheet packaged body according to claim 18, wherein the respective first convex portions extend almost in parallel with one side of the support plate.

20. The optical sheet packaged body according to claim 18, wherein the respective first convex portions extend in a direction crossing the one side of the support plate.

21. The optical sheet packaged body according to claim 18, wherein a sheet secondly closest to the light incidence face out of the support plate and the one or the plurality of optical sheets has a plurality of second convex portions that extend in a direction crossing the extending direction of the first convex portion and are arranged in parallel in the extending direction of the first convex portion.

22. A lighting device comprising an optical sheet packaged body, and a light source emitting light to the optical sheet packaged body, wherein:
the optical sheet packaged body has
a laminated body layering a rectangle support plate and one or a plurality of optical sheets, and
a flexible film that wraps around the laminated body; and
a sheet closest to the light source out of the support plate and the plurality of optical sheets has a plurality of convex portions that extend in one direction and are arranged in parallel in a direction crossing the one direction.

23. The lighting device according to claim 22, wherein the light source is a plurality of point light sources arranged in a matrix, and
the respective convex portions extend in a direction crossing an arrangement direction of the point light sources.

24. The lighting device according to claim 23, wherein one arrangement direction of the plurality of point light sources extends almost in parallel with one side of the support plate, and
the other arrangement direction of the plurality of point light sources extends in parallel with other side crossing the one side of the support plate.

25. The lighting device according to claim 23, wherein one arrangement direction of the plurality of point light sources and the other arrangement direction of the plurality of point light sources extend in directions crossing extending directions of all sides of the support plate.

26. A lighting device comprising an optical sheet packaged body, and a light source emitting light to the optical sheet packaged body, wherein:
the optical sheet packaged body has
a laminated body layering a rectangle support plate and one or a plurality of optical sheets, and
a flexible film wrapping around the laminated body; and
a film closest to the light source of the flexible film has a plurality of convex portions that extend in one direction and are arranged in parallel in a direction crossing the one direction.

27. A display unit comprising a panel driven based on an image signal, a light source emitting light for illuminating the panel, and an optical sheet packaged body provided between the panel and the light source, wherein:
the optical sheet packaged body has
a laminated body layering a rectangle support plate and one or a plurality of optical sheet, and
a flexible film wrapping around the laminated body; and
a sheet closest to the light source out of the support plate and the plurality of optical sheets has a plurality of convex portions that extend in one direction and are arranged in parallel in a direction crossing the one direction.

28. A lighting device comprising:
a panel driven based on an image signal;
a light source emitting light for illuminating the panel; and
an optical sheet packaged body provided between the panel and the light source,
wherein the optical sheet packaged body has
a laminated body layering a rectangle support plate and one or a plurality of optical sheets, and
a flexible film wrapping around the laminated body, and
a film closest to the light source of the flexible film has a plurality of convex portions that extend in one direction and are arranged in parallel in a direction crossing the one direction.
